(19) United States
(12) Patent Application Publication
(10) Pub. No.: US 2007/0165697 A1
(43) Pub. Date: Jul. 19, 2007

(54) Digital radio system

(76) Inventor: Richard L. Anglin JR., Del Mar, CA (US)

Correspondence Address: Giaccherini, Post Office Box 1146, Carmel Valley, CA, 93924, US

(21) Appl. No.: 11/335,913

(22) Filed: Jan. 18, 2006

(51) Int. Cl. H04B 1/00

(52) U.S. Cl. 375/139

(57) ABSTRACT

Methods and apparatus for digital communications are disclosed. In one embodiment of the invention, chirp waveforms (10) are used to convey meanings of “one” and “zero.”

### INTRODUCTION

The title of this Non-Provisional Patent Application is Digital Radio System. The Applicant is Richard L. Anglin, Jr., 2115 Heather Lane, Del Mar, Calif. 92014. The Applicant is a Citizen of the United States of America.

### FIELD OF THE INVENTION

The present invention pertains to methods and apparatus for radio communications. More particularly, one preferred embodiment of the invention uses digital chirps for high-speed, two-way mobile communications.

### FEDERALLY SPONSORED RESEARCH OR DEVELOPMENT

None.

### BACKGROUND OF THE INVENTION

I. Radio Communications

The father of modern wireless communications was Guglielmo Marconi, born at Bologna, Italy, on Apr. 25, 1874. On a historic day in December 1901 he transmitted the first wireless signals across the Atlantic between Poldhu, Cornwall, United Kingdom, and St. John's, Newfoundland, a distance of 2,100 miles. Marconi's feat was accomplished with a spark gap transmitter. A typical high-power spark gap was a rotating commutator with six to twelve contacts per wheel, nine inches to a foot wide, driven by about 2,000 volts of direct current (DC). As the gaps made and broke contact, the radio wave was audible as a tone in a crystal set.

The basics of a spark gap can be easily replicated today as shown in FIG. 1. Taking a quarter V and rubbing it across the contacts of a nine volt battery B produces static S that is audible via the speaker Z of an inexpensive amplitude modulated (AM) radio R.

Creating static proved that the concept of wireless communications worked, but it was not very useful. In the wired world, telegraphy was in regular use. Wires were strung along railroad lines to enable communications between stations. A telegraph operator O used a telegraph key K to make and break battery B pulses that were sent along the wires W as shown in FIG. 2. Messages were sent via Morse Code, a method for transmitting information using standardized sequences of short and long marks or pulses, commonly known as “dots and dashes,” for the letters, numerals and special characters of a message. See FIG. 3.

Marconi used a telegraph key K to directly make and brake the 2,000 volt supply to generate Morse Code. One side of the spark gap G was directly connected to the antenna A as shown in FIG. 4. Making and breaking the power supply P enabled Marconi to create the dots DOT and dashes DASH for Morse Code.

The famous “dot” and “dash” message transmitted by the ocean liner Titanic after she hit an iceberg was “S” “O” “S”, an abbreviation for “save our ship,” is shown in FIG. 5.

Although these simple bursts of “on” and “off” static may be employed to transmit signals in code, this way of communicating only works when one transmitter is being used at any one time. FIG. 6 offers a simple example that illustrates this problem. Two transmitters Aa, Ab send different messages at the same time. At transmitter Aa, the operator Oa sends the message “NEW YORK TRAIN ON TIME” which is dispatched as a radio signal. At transmitter Ab operator Ob sends the message “BOSTON TRAIN LATE” which is also conveyed as a radio signal. A receiver at a distant location Ac receives both signals at the same time, resulting in the message “NEW YORK TRAIN BOSTON ON TIME LATE”. The operator Oc at the receiver is unable to decipher this mixed message.

The problem with the two messages that arrive at the receiver at the same time is caused by the fact that both radio transmissions use the same part of the “radio spectrum.” When light is viewed as it passes through a prism Y, the light is split into the colors of a rainbow, which extend from red to orange, yellow, green, blue and violet as shown in FIG. 7. The different colors appear because each color has a different frequency that is refracted differently by the prism. Refraction is caused by the change in speed experienced by a wave of light when it changes the medium through which it travels. An ocean with waves that are ten meters apart, their wavelength, crash on the shore five times per minute are classified as having a frequency of five, whereas an ocean of waves ten meters apart that crash on the shore ten times per minute are classed as having a frequency of ten. The more frequent the waves, the higher the frequency. Waves in the ocean travel at approximately the same speed. Therefore, waves that are more widely spaced, their wavelength, would crash on the beach less frequently while those that are more narrowly spaced would crash on the beach more frequently.

It is this difference in frequencies that causes the different colors of light to separate and become visible when passing through a prism. Radio waves act the same way. They have different frequencies and wavelengths, and a receiver that is capable of filtering out all but a particular frequency or wavelength can isolate a particular signal that exists at a particular frequency or wavelength to the exclusion of all others. The radio spectrum comprises a wide range of different radio waves, beginning with waves of very low frequency (VLF) at one end and progressing to waves of extremely high frequency (EHF) at the other end of the spectrum as shown in FIG. 8. Wavelength and frequency are inversely related.

FIG. 9 shows a sine wave. The period Ta is the time it takes the wave to make one complete oscillation, that is, starting from zero and rising to a maximum then descending back through zero to a minimum and then back to zero. The instant sine wave has a frequency Fa. FIG. 10 shows two complete oscillations. In FIG. 10, the period of each oscillation Tb is one half of period Ta, therefore, the frequency Fb is twice the frequency Fa. Similarly, FIG. 11 shows four complete oscillations. In FIG. 11, the period of each oscillation Td is one quarter of period Ta, therefore, the frequency Fc is four times the frequency Fa.

A wave with constant height, amplitude, and frequency carries no information. However, information can be superimposed on a give wave by varying either amplitude or frequency or both. Varying a wave in this manner is called “modulation,” and recovering the information encoded in this manner is called “demodulation.”

When a singer sings his pitch is obtained by varying frequency and his loudness, or vibrato, is obtained by varying his volume. FIG. 12 shows a singer I singing into a microphone M. The music tones D are shown on an oscilloscope J. Examination of the wave Q on the oscilloscope reveals that the wave oscillations have are of varying “height” reflecting the volume of the singer's song. When the singer sings into the microphone the wave he produces is used to vary the height of the waveform, of the constant frequency carrier produced by the transmitter. This phenomenon is called an “amplitude modulated wave” Q, a more detailed view of which is presented in FIG. 13. Note the symmetrical envelope UU of the amplitude modulated wave in FIG. 13.

The amplitude modulated wave Q is comprised of two waves, a carrier wave C with a period Tc and a modulating wave U as shown in FIG. 14. The peaks of the modulated wave Q follow the contour of the original, modulating wave U. The waveform envelope UU in FIG. 13 is the modulating wave U. The process of superimposing a modulating wave U, the music tones D, on a carrier wave C is called “modulation” and the device for so doing is called a “modulator,” in the instant case “amplitude modulation” because the signal strength varies in proportion to the strength of the modulating wave U.

FIG. 15 shows a block diagram of an AM transmitter. The music tones D are converted to a low-level modulating wave U by the microphone M and amplified by preamplifier X. Amplifier X produces an electrical signal of sufficient strength to be fed into a modulator R where it modulates, that is, changes the characteristics of, the carrier wave C generated by a local oscillator LO. The modulated wave Q is fed to into power amplifier E and then to the antenna A.

A radio signal that is received in a typical passenger car on an AM radio is an amplitude modulated wave Q, as shown in FIG. 16. The program heard by the listener is the music D. Therefore, the music tones D must be extracted from the amplitude modulated wave Q. This is accomplished by subtracting the carrier wave C from the amplitude modulated wave Q, leaving only the modulating wave U that gives us the music tones D as shown in FIG. 17. The process of extracting a carrier wave C and a modulating wave U from an amplitude modulated wave Q is called “demodulation,” and the device for doing so is called a “demodulator” L.

Each communications service requires a certain amount of radio frequency spectrum to deliver the service at an appropriate level. “Appropriateness” depends upon the application. For voice services, “appropriate” means the spoken word is intelligible. For music, “appropriate” means being able to hear the music at a level of fidelity. The minimum amount of radio frequency spectrum, that required to deliver the service, comprises a “channel.”

A car radio offers a variety of stations offering different kinds of audio programming. When the radio dial is turned, with a knob or digitally, different stations are selected. Each station operates on a different channel, as shown in FIG. 18. Antenna Ad in San Diego, Calif., broadcasts radio station KSON on 1240 kHz Fd. Antenna Ae in Los Angeles, Calif., broadcasts radio station KOGO on 600 kHz Fe. Antenna Af, also in Los Angeles, broadcasts radio station KNX on 1070 kHz. When the radio is tuned by turning the dial, the center frequency of the channel is chosen, as shown in FIG. 19.

The previous text describes a communication method called Amplitude Modulation (AM), a technique evolved from Marconi's spark gap transmissions. Frequency Modulation (FM) is a form of modulation which represents information as variations in the instantaneous frequency of a carrier wave C. Contrast this with AM, in which the amplitude of the carrier is varied while its frequency remains constant as has been shown above. In analog applications, the carrier wave C is varied in direct proportion to changes in the amplitude of an input signal, the modulating wave U. Taking the same carrier wave C and modulating wave U from FIG. 14, we can “mix” or “modulate” them to create a “frequency modulated wave” N as shown in FIG. 20. Note that the amplitude is constant but the period T varies with time.

Frequency modulation requires a wider bandwidth channel than amplitude modulation for a given modulating signal, but this also makes the signal more robust against interference. Frequency modulation is also more robust against simple signal amplitude fading phenomena. As a result, FM was chosen as the modulation standard for high frequency, high fidelity radio transmission: hence the term “FM radio.”

FIG. 15, a block diagram of an AM transmitter, becomes FIG. 21, a block diagram of an FM transmitter. The modulator R in FIG. 15 is replaced by a mixer AA in FIG. 21. A “mixer” is a device that varies the frequency of a carrier C according to the signal input from preamplifier X that is filtered and amplified to a power level needed for transmission by amplifier E. The transmitted wave N is a frequency modulated wave. Similarly, FIG. 17, a block diagram of an AM receiver, becomes FIG. 22, a block diagram of an FM receiver. The AM demodulator L in FIG. 17 is replaced by an FM demodulator AB in FIG. 22.

In addition to AM and FM described above, a third method for modulating is known as Phase Modulation (PM). Here the amplitude and frequency of the wave is unchanged; the modulator varies the phase angle of the wave. The phase angle of a given sine wave is the offset or delay with respect to a reference sine wave, as shown in FIG. 23. FIG. 23 shows reference sine wave AI, a phase offset of ninety degrees AJ, and a phase offset of one hundred eighty degrees AK.

Phase offset can be changed over time as shown in FIG. 24. The cycle AL starts upward from zero, peaks, falls back through zero, peaks in the negative direction and then returns to zero. This sequence AL is treated as the reference or zero phase offset. The cycle AM has the opposite progression; it starts in the negative direction, reaches a minimum, rises through zero to a maximum and then returns to zero. This sequence AM is referred to as the “opposite phase.” Note that the two cycles AL and AM have the same frequency and the same amplitude, they only differ in the sequence of negative, positive and zero values.

Signals may be encoded on a carrier wave by modulating the amplitude AM, frequency FM, phase PM or combinations thereof. The amplitude modulated wave Q, the frequency modulated wave N and a phase modulated wave are all termed “waveforms.”

Digital data, that is, information that shifts between ones and zeros at discrete points in time, can be represented by shifting the amplitude among a discrete set of values, amplitude shift keying (ASK), shifting the carrier frequency C among a set of discrete frequency values, frequency-shift keying (FSK), or shifting among a discrete set of phase values, phase shift keying (PSK). In FSK the instantaneous frequency is shifted between two discrete values termed the “mark” frequency and the “space” frequency as shown in FIG. 25. This technique may be used to represent the digital binary states of “0s” and “1s.” FIG. 26 shows a comparable representation of digital data as shifts in phase. Phase Modulation has proven particularly effective for encoding digital data and is presently the most commonly used means.

For all of the benefits they deliver, modern wireless communications systems comprise inherent limitations. Traditional duplex communications systems, that is, systems that enable simultaneous communications between two terminals AC typically use two independent communications channels ADa,ADb as shown in FIG. 27. Communications transmitted from a first terminal ACa to a second terminal ACb use a first channel ADa while communications transmitted from a second terminal ACb to a first terminal ACa use a second channel ADb.

The independent channels ADa and ADb are typically separated within a frequency band AE to prevent communications in a first channel ADa from interfering with communications in a second channel ADb. The channel separation AF is termed “frequency offset,” and is shown in FIG. 28. Furthermore, in traditional communications systems the duplex channel widths are equal, that is, a first channel ADa is the same width as a second channel ADb.

In traditional communications systems that do not use some form of multiple access technologies both channels ADa,ADb are completely dedicated to the communications session for the duration of the session. Thus, in a cellular telephone system a first channel ADa is solely dedicated to communications from a base station AG to a mobile terminal AC, a cell phone, and a second channel ADb is solely dedicated to communications from a mobile terminal AC, a cell phone, to a base station AG, as shown in FIG. 29. Thus, even when no one is talking, the channels ADa,ADb remain completely dedicated to the communications session between AG and AC. Similarly, in a data communications session, even if the data communications do not utilize the full bandwidth available in a channel, the channel remains fully dedicated to the communications session for its full duration, an inefficient utilization of scarce spectrum resources.

Wireless communications systems like the early push-to-talk (PTT) simplex dispatch systems, often used to dispatch taxis, cellular, personal communications system (PCS) and even satellite systems like Iridium® were designed for voice communications, a narrowband application. “Narrowband” in this context means that the channels ADa,ADb are only wide enough to enable voice communications at some level of quality as well as to provide a buffer between adjacent channels, a “guard band.” The economics of communications systems is to maximize the number of available channels within an allocated frequency band. Therefore the objective is to minimize the channel width while maintaining acceptable voice quality. With the increase of data communications requirements spawned by the Internet and other factors, voice-based channelization has become a major constraint to the delivery of applications with bandwidth requirements higher than voice via wireless communications systems.

Traditional wireless communications systems are deployed in a variety of frequency bands, as shown in FIG. 30.

When the Federal Communications Commission (FCC) first established cellular service rules, cellular spectrum was allocated into forty megahertz of spectrum: a twenty megahertz block, 825 to 845 MHZ, was designated for transmissions ADb made by mobile units AC, and a separate twenty megahertz block, from 870 to 890 MHZ, was allocated for base station AG transmissions ADa. The forty megahertz allocation accommodated 666 channel pairs, a channel pair consisting of a mobile frequency ADb and a corresponding base frequency ADa. Due to the growth in demand for cellular service, the FCC reevaluated the cellular band plan in 1986 and allocated an additional ten megahertz of spectrum to each cellular system, increasing the spectrum designated for cellular telephone systems to fifty megahertz. The additional spectrum increased the number of channel pairs to 832 channel pairs. The frequency allocation for mobile transmissions now ranges from 824 to 849 MHZ, and from 869 to 894 MHZ for base station transmissions. Cellular and Broadband PCS channels are typically thirty kilohertz wide.

Broadband PCS operates in the 1850-1910 MHZ and 1930-1990 MHZ bands. The one hundred twenty megahertz of spectrum was divided into six frequency blocks A through F. Blocks A, B, and C are thirty megahertz each and blocks D, E, and F are ten megahertz each.

Two distinct sets of frequencies are available for Specialized Mobile Radio (SMR) operation: 800 MHZ and 900 MHZ. A total of approximately nineteen megahertz of spectrum is available for use by SMR carriers, fourteen megahertz in the 800 MHZ band and five megahertz in the 900 MHZ band. The 800 MHZ SMR systems operate on two twenty-five kilohertz channels paired, while the 900 MHZ systems operate on two 12.5 kHz channels paired.

Cellular, PCS and SMR are all licensed services, that is, a carrier wishing to provide services in those bands must obtain a license from the FCC. There are also allocations for unlicensed wireless communications in the Industrial, Scientific and Medical Bands (ISM) at 902-928 MHZ and 2400-2483.5 MHZ, in the Unlicensed-National Information Infrastructure (U-NII) Band, and the 3650-3700 MHZ band.

Within the licensed bands there is usually a band plan that defines and assigns channels within each band. An example of a band plan is shown in FIG. 31 for cellular telephone systems. Channels within the 824 to 849 MHZ band are used for communications from mobile terminals AC to a base station AG, and in the 869 to 894 MHZ band for communications from a base station AG to a mobile terminal AC. Each channel in both directions is thirty kilohertz wide.

Transmissions in different portions of the radio frequency (RF) spectrum have different propagation characteristics. Some frequency bands are more desirable for long distance communications; others for short distances. Some frequency bands require clear line-of-sight; others go through trees. Traditional wireless communications systems are typically implemented within a single frequency band. They therefore experience the propagation characteristics associated with that frequency band, which may affect the integrity and reliability of the communications.

Propagation effects are manifest in the dreaded dropped call phenomenon. Cellular systems are implemented in a honeycomb configurations as shown in FIG. 32. Base station AGa supports communications throughout its coverage area AHa, AGb throughout AHb, and so forth. The radius of the coverage area AH is determined by the propagation characteristics of the deployed frequency band. As a general rule the lower the frequency the longer the propagation distance.

Cellular systems are designed so that as a mobile terminal AC reaches the edge of coverage of a first coverage area AHa, control of the communications is automatically and seamlessly transferred from base station AGa to base station AGb. The wireless user should not experience any interruption in service in transiting from AHa to AHb, and so forth. Economics dictate that wireless system operators deploy the fewest number of base stations possible to provide acceptable communications coverage. Systems are engineered based on the nominal propagation characteristics of the particular frequency band deployed. Variation in propagation often leads to a dropped call, that is, there is no seamless transfer of communications from one coverage area to another.

The waveforms used by the cellular telephone networks, Advanced Mobile Phone Service (AMPS), Time Division Multiple Access (TDMA) and its derivative Global System for Mobile (GSM), Code Division Multiple Access (CDMA) are not efficient in terms of bandwidth. They require significant guard bands between channels and a 20 MHZ unused “buffer zone,” the frequency offset AF between the block of frequencies used for the forward channels (also known as downlink channels) ADa, base station AG to cell phone AC, and the block of channels used for the reverse channels (also known as uplink channels) ADb, cell phone AC to base station AG.

The cellular telephone waveforms are not particularly good in urban mobile environments. In particular, they are significantly negatively impacted by multipath.

The development of a telecommunication system waveform that surpasses the limited performance of conventional cellular telephone and other wireless communications networks would constitute a major technological advance, and would satisfy long felt needs and aspirations in the telecommunications and electronics industries.

### SUMMARY OF THE INVENTION

The Digital Radio System comprises methods and apparatus for a telecommunications system that utilizes “chirp” waveforms for high-speed, wireless communications. In the most basic embodiment of the invention, chirp waveforms comprising line segments are used to convey a digital message of “one” or “zero.” The invention also encompasses more complex combinations of chirps, as well as more complex types of pairs of chirps.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIGS. 1 through 32 depict the prior art.

FIG. 1 shows a how to create a spark gap with a battery and a quarter (prior art).

FIG. 2 shows a telegraph operator sending Morse Code over wires (prior art).

FIG. 3 shows Morse Code (prior art).

FIG. 4 shows sending Morse Code wirelessly using a spark gap transmitter (prior art).

FIG. 5 shows the S.S. Titanic sending an “SOS” signal (prior art).

FIG. 6 shows the interference from two transmitters being received at the same time (prior art).

FIG. 7 shows sunlight being refracted through a prism (prior art).

FIG. 8 shows a portion of the radio frequency spectrum (prior art).

FIG. 9 shows a single oscillation sine wave (prior art).

FIG. 10 shows two sine wave oscillations (prior art).

FIG. 11 shows four sine wave oscillations (prior art).

FIG. 12 shows music tones displayed on an oscilloscope (prior art).

FIG. 13 shows an amplitude modulated wave (prior art).

FIG. 14 shows a demodulated wave comprising a carrier wave and a modulating wave (prior art).

FIG. 15 shows a block diagram of an amplitude modulation radio transmitter (prior art).

FIG. 16 shows listening to music in a car with an amplitude modulated signal (prior art).

FIG. 17 shows a block diagram of an amplitude modulation radio receiver (prior art).

FIG. 18 shows tuning radios to different radio stations operating on different frequencies (prior art).

FIG. 19 shows tuning to the center frequency of a channel (prior art).

FIG. 20 shows a frequency modulated wave (prior art).

FIG. 21 shows a block diagram of a frequency modulation radio transmitter (prior art).

FIG. 22 shows a block diagram of a frequency modulation radio receiver (prior art).

FIG. 23 shows Phase Modulation (prior art).

FIG. 24 shows changes in phase with time (prior art).

FIG. 25 shows frequency shift keying (prior art).

FIG. 26 shows phase shift keying (prior art).

FIG. 27 shows a traditional duplex communications system (prior art).

FIG. 28 shows the channel separation in a traditional duplex communications system (prior art).

FIG. 29 shows a traditional duplex wireless communications system (prior art).

FIG. 30 shows frequency bands in which traditional wireless duplex communications systems are deployed (prior art).

FIG. 31 shows a cellular telephone system band plan (prior art).

FIG. 32 shows a cellular telephone system honeycomb deployment architecture (prior art).

FIG. 33 provides a view of a basic chirp waveform. “Modulation Variable” refers to the particular characteristic of a wave being varied during the chirp, amplitude, frequency, etc.

FIG. 34 reveals alternative waveforms that may be used to implement the invention.

FIGS. 35 through 44 depict two-dimensional chirp waveforms mapped in amplitude versus time for meanings “one” and “zero” for five different families of chirps. FIGS. 35 and 36 are formed from linear line segments. FIGS. 37 and 38 are formed from mononomial line segments. FIGS. 39 and 40 are formed from polynomial line segments. FIGS. 41 and 42 are formed from sinusoidal line segments. FIGS. 43 and 44 are formed from exponential line segments. FIGS. 35, 37, 39, 41 and 43 have meanings of “one.” FIGS. 36, 38, 40, 42 and 44 have meanings of “zero.”

FIGS. 45 through 54 depict two-dimensional chirp waveforms mapped in frequency versus time for meanings “one” and “zero” for five different families of chirps. FIGS. 45 and 46 are formed from linear line segments. FIGS. 47 and 48 are formed from mononomial line segments. FIGS. 49 and 50 are formed from polynomial line segments. FIGS. 51 and 52 are formed from sinusoidal line segments. FIGS. 53 and 54 are formed from exponential line segments. FIGS. 45, 47, 49, 51 and 53 have meanings of “one.” FIGS. 46, 48, 50, 52 and 54 have meanings of “zero.”

FIGS. 55 through 64 depict two-dimensional chirp waveforms mapped in amplitude versus frequency for meanings “one” and “zero” for five different families of chirps. FIGS. 55 and 56 are formed from linear line segments. FIGS. 57 and 58 are formed from mononomial line segments. FIGS. 59 and 60 are formed from polynomial line segments. FIGS. 61 and 62 are formed from sinusoidal line segments. FIGS. 63 and 64 are formed from exponential line segments. FIGS. 55, 57, 59, 61 and 63 have meanings of “one.” FIGS. 56, 58, 60, 62 and 64 have meanings of “zero.”

FIGS. 65 through 74 depict two-dimensional chirp waveforms mapped in frequency versus amplitude for meanings “one” and “zero” for five different families of chirps. FIGS. 65 and 66 are formed from linear line segments. FIGS. 67 and 68 are formed from mononomial line segments. FIGS. 69 and 70 are formed from polynomial line segments. FIGS. 71 and 72 are formed from sinusoidal line segments. FIGS. 73 and 74 are formed from exponential line segments. FIGS. 65, 67, 69, 71 and 73 have meanings of “one.” FIGS. 66, 68, 70, 72 and 74 have meanings of “zero.”

FIGS. 75 through 124 exhibit three dimensional chirp waveforms, which are mapped in amplitude, frequency and time. FIG. 75 utilizes linear line segments and has a meaning of “one.” FIG. 76 utilizes linear line segments and has a meaning of “zero.” FIG. 77 utilizes linear and mononomial line segments and has a meaning of “one.” FIG. 78 utilizes linear and mononomial line segments and has a meaning of “zero.”

FIGS. 79 and 80 utilize polynomial and linear line segments. FIG. 79 shows a waveform that has a meaning of “one,” while FIG. 80 shows a waveform that has a meaning of “zero.”

FIGS. 81 and 82 utilize sinusoidal and linear line segments. FIG. 81 shows a waveform that has a meaning of “one,” while FIG. 82 shows a waveform that has a meaning of “zero.”

FIGS. 83 and 84 utilize exponential and linear line segments. FIG. 83 shows a waveform that has a meaning of “one,” while FIG. 84 shows a waveform that has a meaning of “zero.”

FIGS. 85 and 86 utilize linear and mononomial line segments. FIG. 85 shows a waveform that has a meaning of “one,” while FIG. 86 shows a waveform that has a meaning of “zero.”

FIGS. 87 and 88 utilize mononomial and mononomial line segments. FIG. 87 shows a waveform that has a meaning of “one,” while FIG. 88 shows a waveform that has a meaning of “zero.”

FIGS. 89 and 90 utilize polynomial and mononomial line segments. FIG. 89 shows a waveform that has a meaning of “one,” while FIG. 90 shows a waveform that has a meaning of “zero.”

FIGS. 91 and 92 utilize sinusoidal and mononomial line segments. FIG. 91 shows a waveform that has a meaning of “one,” while FIG. 92 shows a waveform that has a meaning of “zero.”

FIGS. 93 and 94 utilize exponential and mononomial line segments. FIG. 93 shows a waveform that has a meaning of “one,” while FIG. 94 shows a waveform that has a meaning of “zero.”

FIGS. 95 and 96 utilize linear and polynomial line segments. FIG. 95 shows a waveform that has a meaning of “one,” while FIG. 96 shows a waveform that has a meaning of “zero.”

FIGS. 97 and 98 utilize mononomial and polynomial line segments. FIG. 97 shows a waveform that has a meaning of “one,” while FIG. 98 shows a waveform that has a meaning of “zero.”

FIGS. 99 and 100 utilize polynomial and polynomial line segments. FIG. 97 shows a waveform that has a meaning of “one,” while FIG. 98 shows a waveform that has a meaning of “zero.”

FIGS. 101 and 102 utilize sinusoidal and polynomial line segments. FIG. 101 shows a waveform that has a meaning of “one,” while FIG. 102 shows a waveform that has a meaning of “zero.”

FIGS. 103 and 104 utilize exponential and polynomial line segments. FIG. 103 shows a waveform that has a meaning of “one,” while FIG. 104 shows a waveform that has a meaning of “zero.”

FIGS. 105 and 106 utilize linear and sinusoidal line segments. FIG. 105 shows a waveform that has a meaning of “one,” while FIG. 106 shows a waveform that has a meaning of “zero.”

FIGS. 107 and 108 utilize mononomial and sinusoidal line segments. FIG. 107 shows a waveform that has a meaning of “one,” while FIG. 108 shows a waveform that has a meaning of “zero.”

FIGS. 109 and 110 utilize polynomial and sinusoidal line segments. FIG. 109 shows a waveform that has a meaning of “one,” while FIG. 110 shows a waveform that has a meaning of “zero.”

FIGS. 111 and 112 utilize sinusoidal and sinusoidal line segments. FIG. 111 shows a waveform that has a meaning of “one,” while FIG. 112 shows a waveform that has a meaning of “zero.”

FIGS. 113 and 114 utilize exponential and sinusoidal line segments. FIG. 113 shows a waveform that has a meaning of “one,” while FIG. 114 shows a waveform that has a meaning of “zero.”

FIGS. 115 and 116 utilize linear and exponential line segments. FIG. 115 shows a waveform that has a meaning of “one,” while FIG. 116 shows a waveform that has a meaning of “zero.”

FIGS. 117 and 118 utilize mononomial and exponential line segments. FIG. 117 shows a waveform that has a meaning of “one,” while FIG. 118 shows a waveform that has a meaning of “zero.”

FIGS. 119 and 120 utilize polynomial and exponential line segments. FIG. 119 shows a waveform that has a meaning of “one,” while FIG. 120 shows a waveform that has a meaning of “zero.”

FIGS. 121 and 122 utilize sinusoidal and exponential line segments. FIG. 121 shows a waveform that has a meaning of “one,” while FIG. 122 shows a waveform that has a meaning of “zero.”

FIGS. 123 and 124 utilize exponential and exponential line segments. FIG. 123 shows a waveform that has a meaning of “one,” while FIG. 124 shows a waveform that has a meaning of “zero.”

FIGS. 125 and 126 show multiple line segments mapped in amplitude versus time space. FIG. 125 shows two waveforms that both have a meaning of “one,” while FIG. 126 shows two waveforms that both have a meaning of “zero.”FIGS. 127 and 128 show multiple line segments mapped in frequency versus time space. FIG. 127 shows two waveforms that both have a meaning of “one,” while FIG. 128 shows two waveforms that both have a meaning of “zero.”

FIGS. 129 and 130 show “stacked” line segments mapped in amplitude versus time space. FIG. 129 shows two waveforms that both have a meaning of “one,” while FIG. 130 shows two waveforms that both have a meaning of “zero.”

FIGS. 131 and 132 show stacked line segments mapped in frequency versus time space. FIG. 131 shows two waveforms that both have a meaning of “one,” while FIG. 132 shows two waveforms that both have a meaning of “zero.”

FIGS. 133 through 136 show a chirp waveform vector mapped in polar coordinate space (r,φ). FIGS. 133 and 136 show a chirp waveform vector having the meaning of “one,” while FIGS. 134 and 135 show vectors having the meaning of “zero.”

FIG. 137 shows two chirp waveform vectors mapped in polar coordinate space (r,φ) having the same φ but with r₁ having the meaning of “one” and r₂ having the meaning of “zero.”

FIG. 138 shows two chirp waveform vectors mapped in polar coordinate space (r,φ) having the same r but with φ₁ having the meaning of “one” and φ₂ having the meaning of “zero.”

FIGS. 139 and 140 exhibit three dimensional chirp waveforms, which are mapped in spherical polar coordinates. FIG. 139 shows a waveform having a meaning of “one,” and FIG. 140 shows a waveform having a meaning of “zero.”

FIGS. 141 and 142 exhibit three dimensional chirp waveforms, which are mapped in cylindrical polar coordinates. FIG. 141 shows a waveform having a meaning of “one,” and FIG. 142 shows a waveform having a meaning of “zero.”

FIG. 151 exhibits multiple three dimensional chirp waveforms, which are mapped in spherical polar coordinate space.

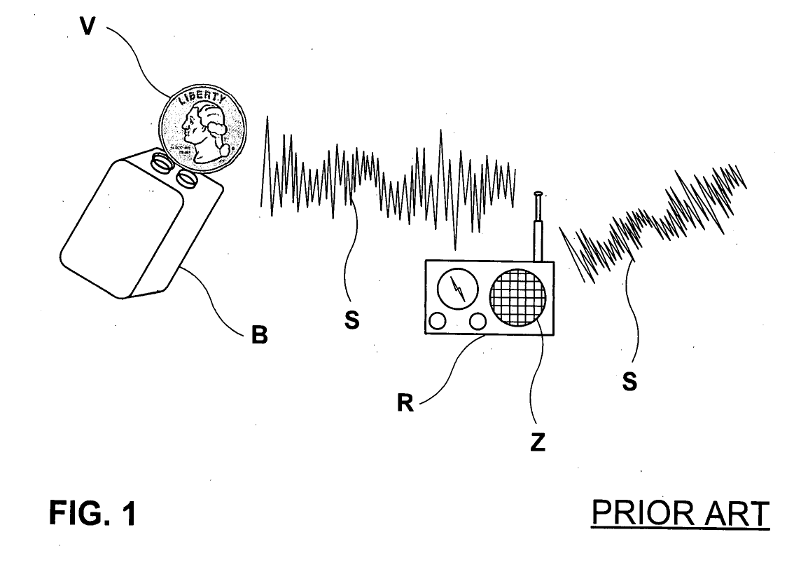

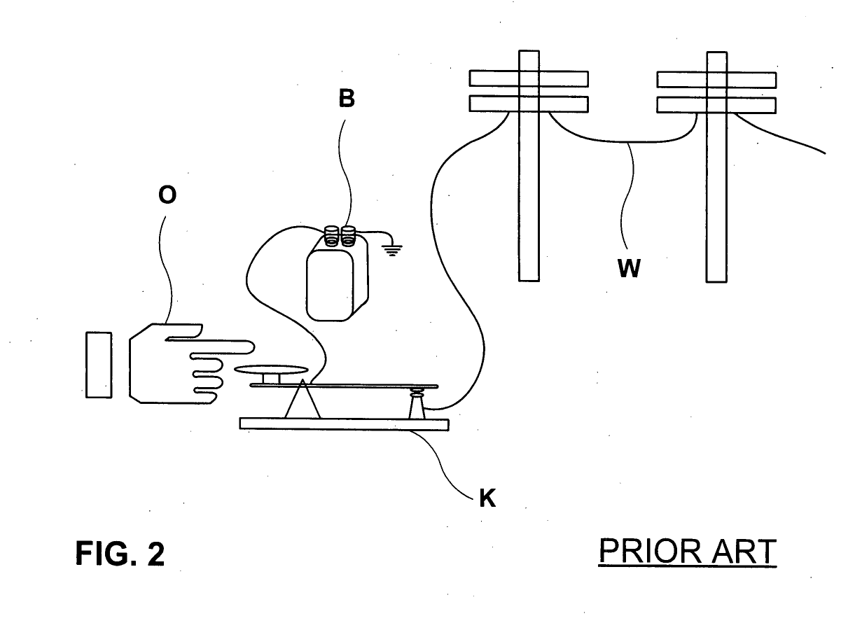

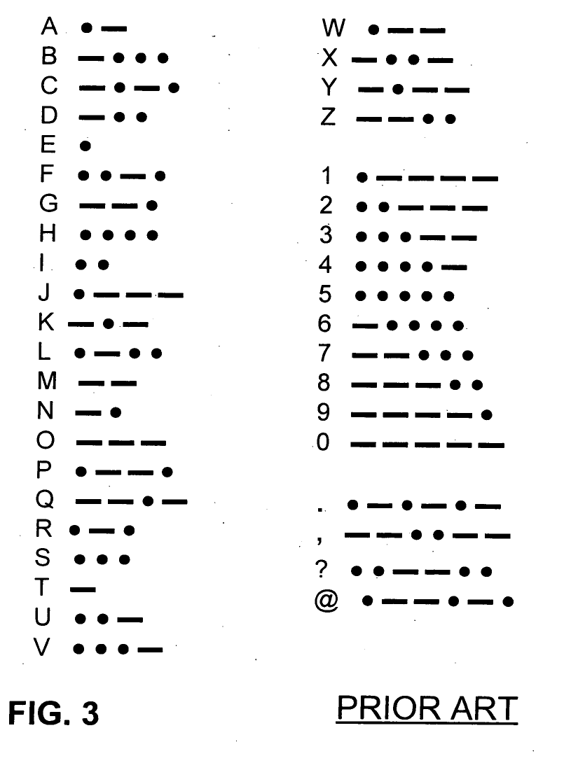

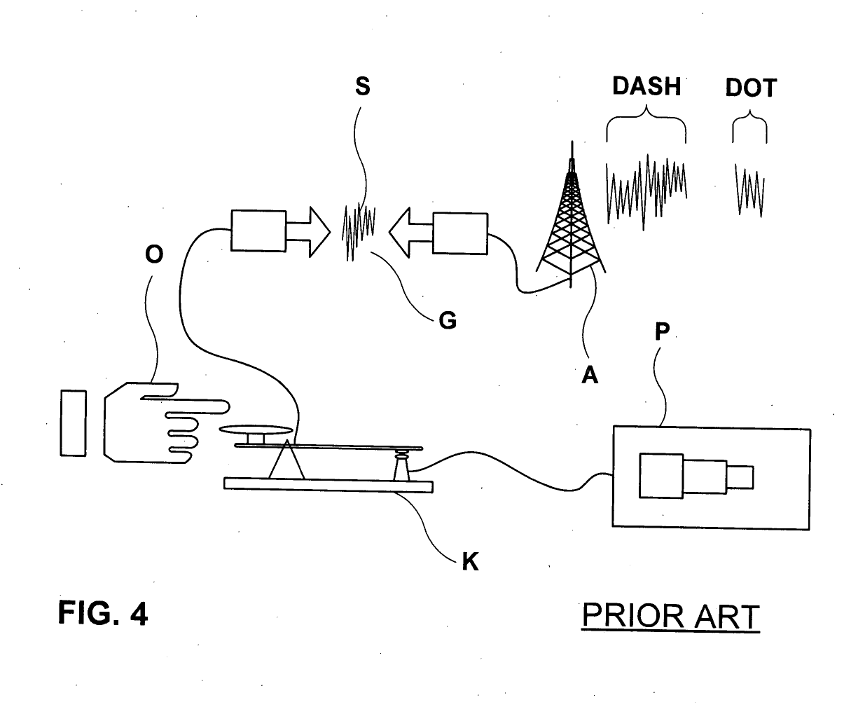

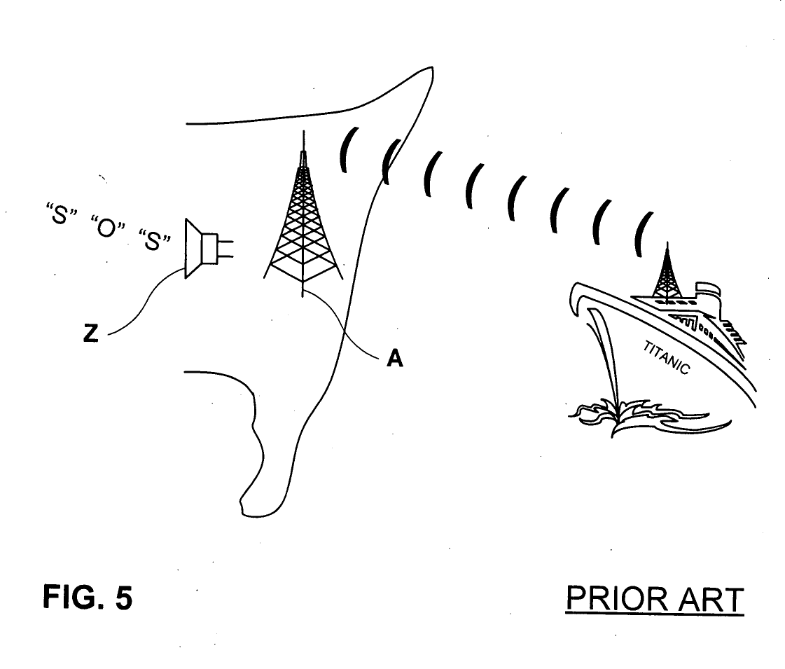

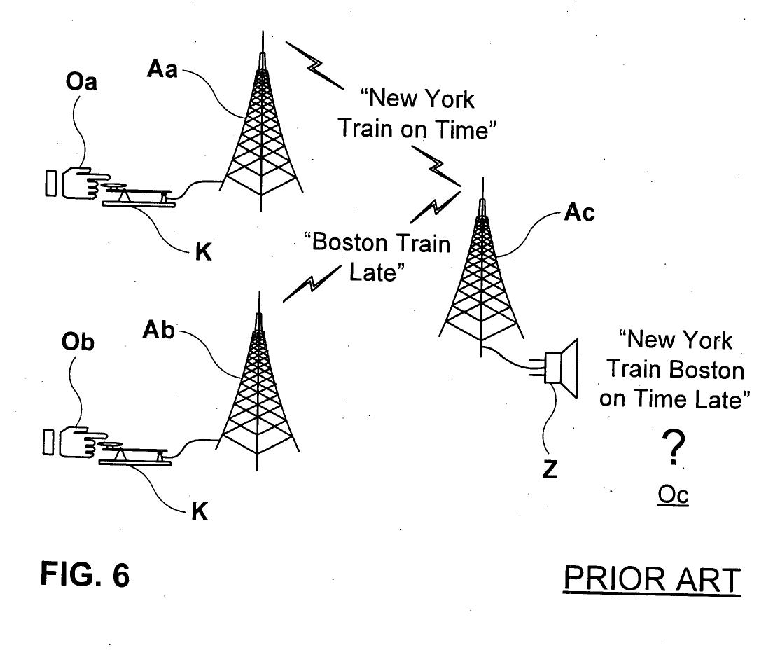

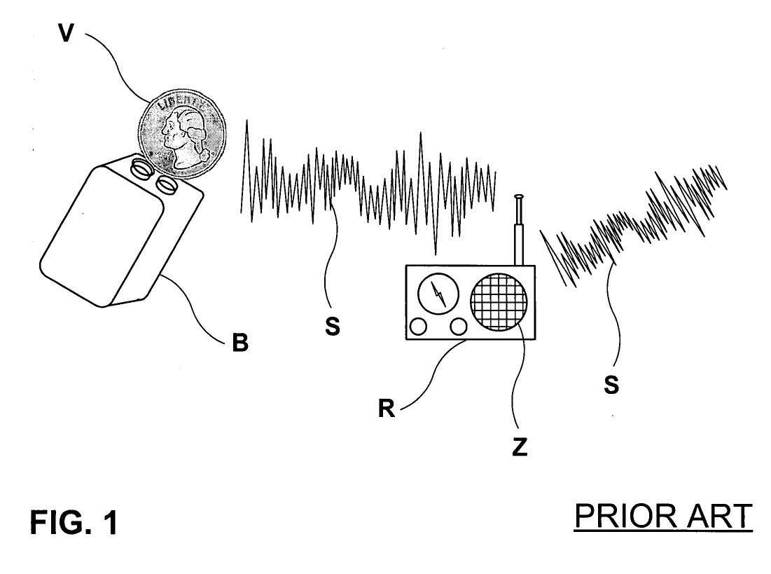

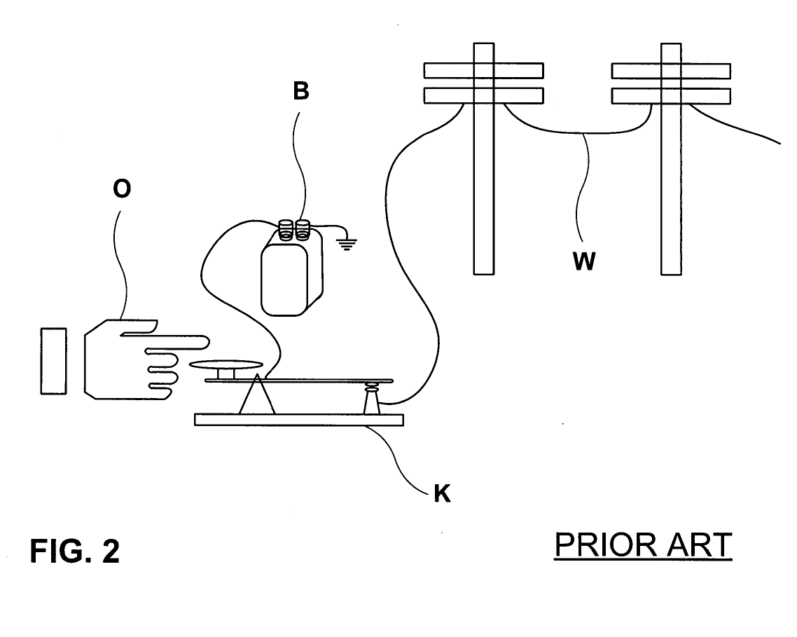

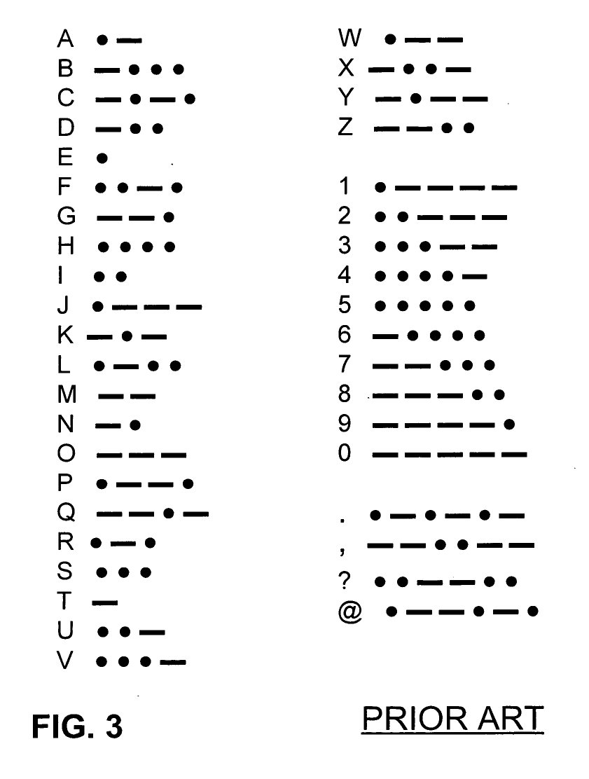

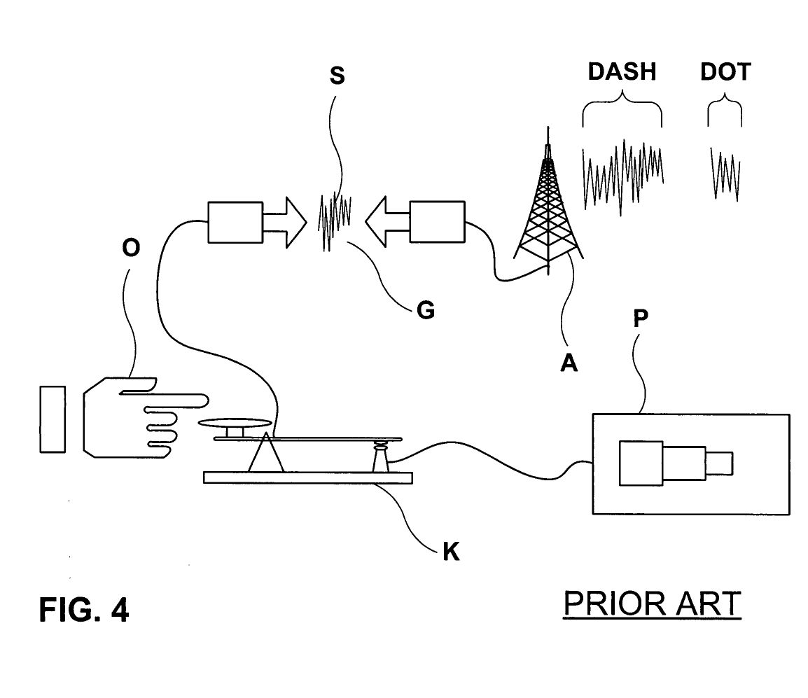

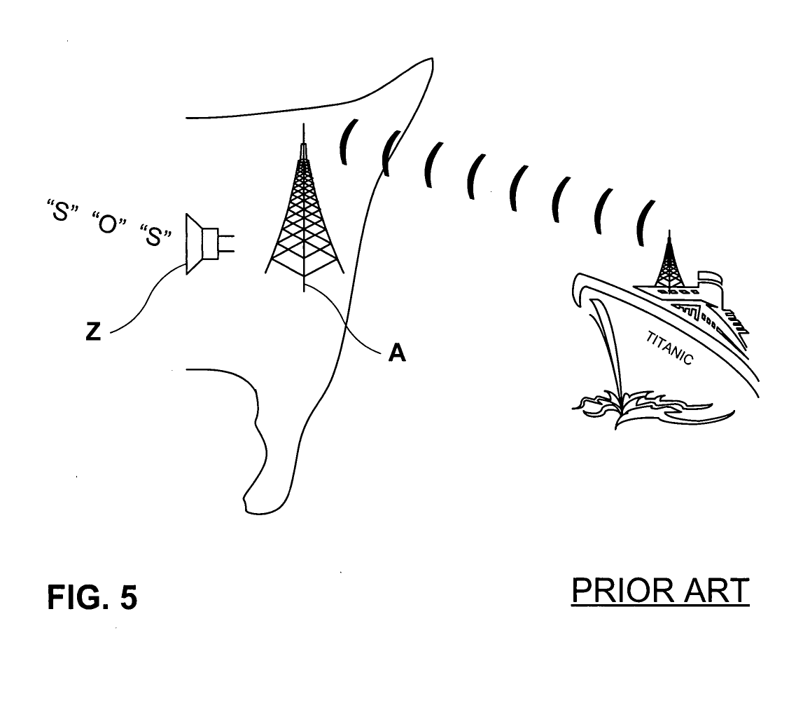

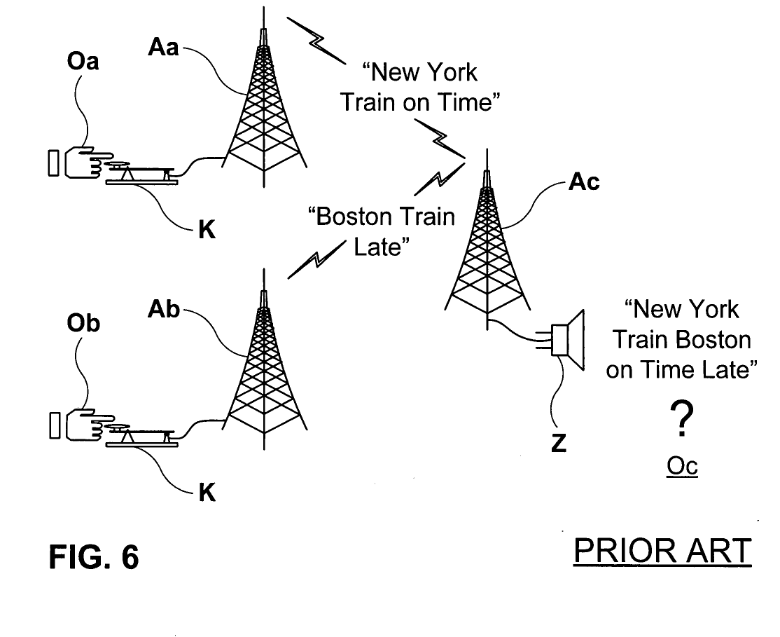

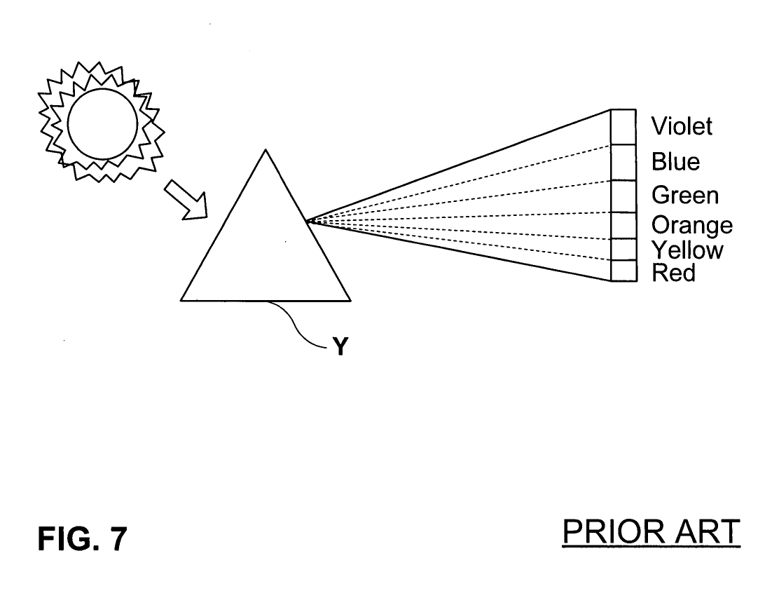

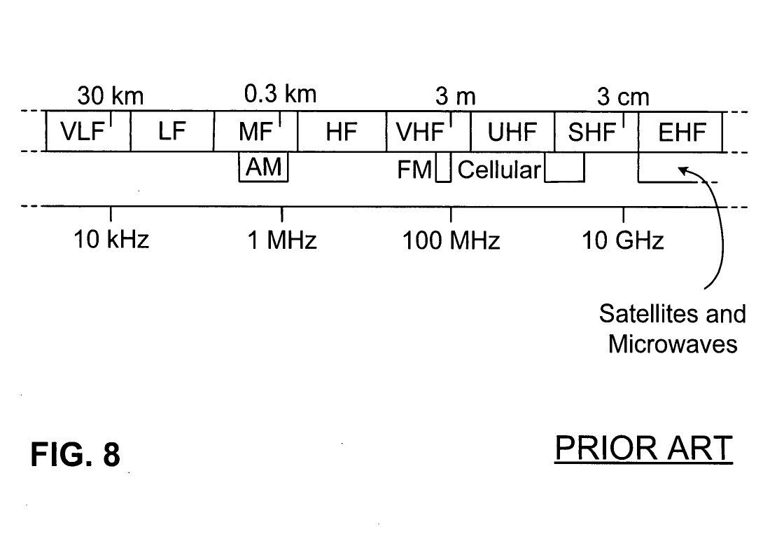

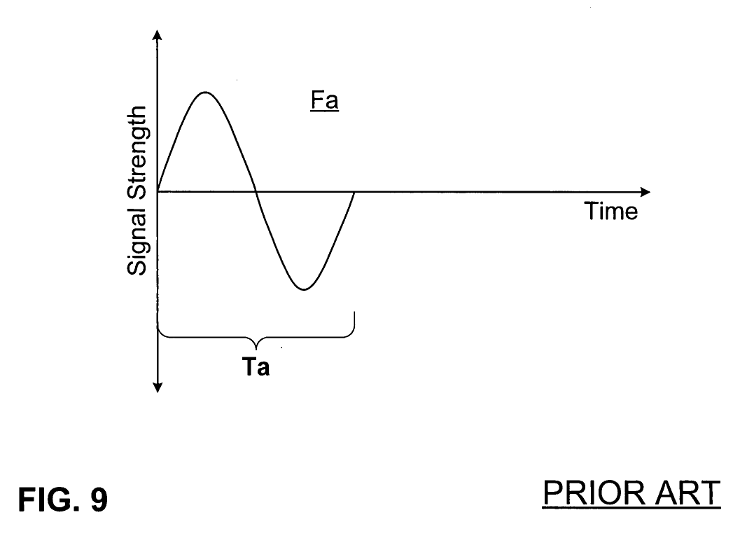

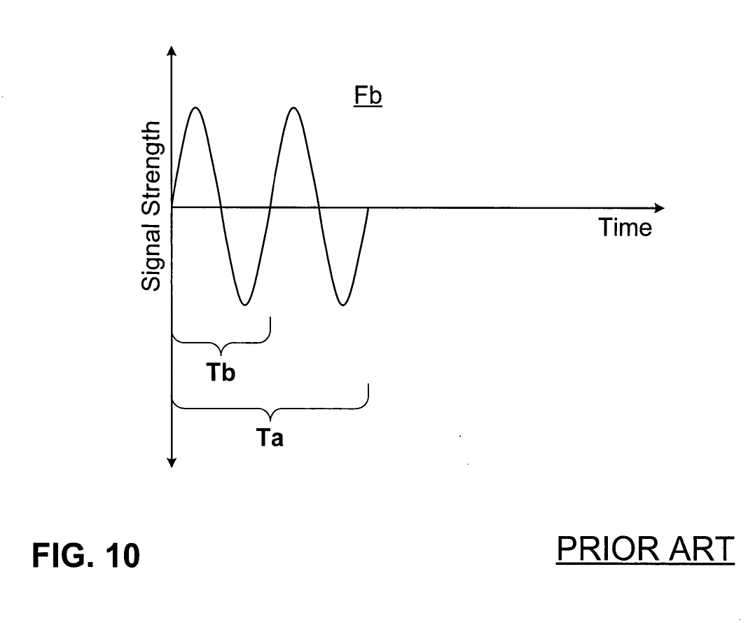

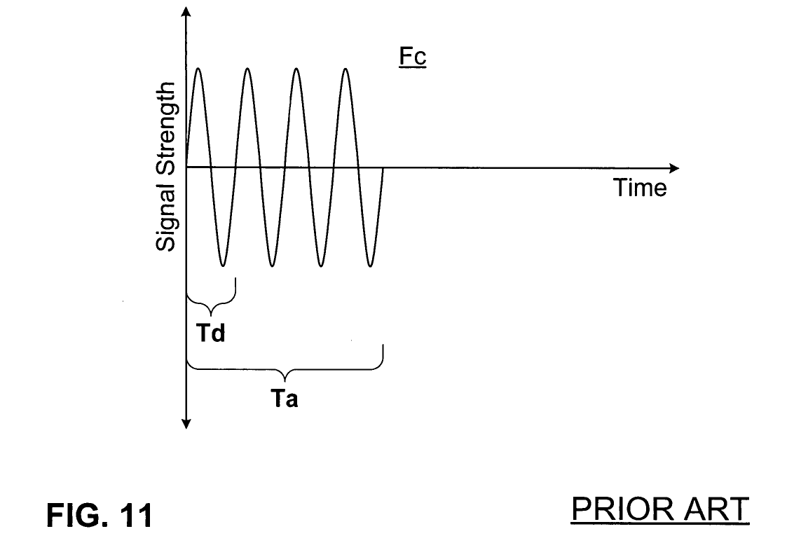

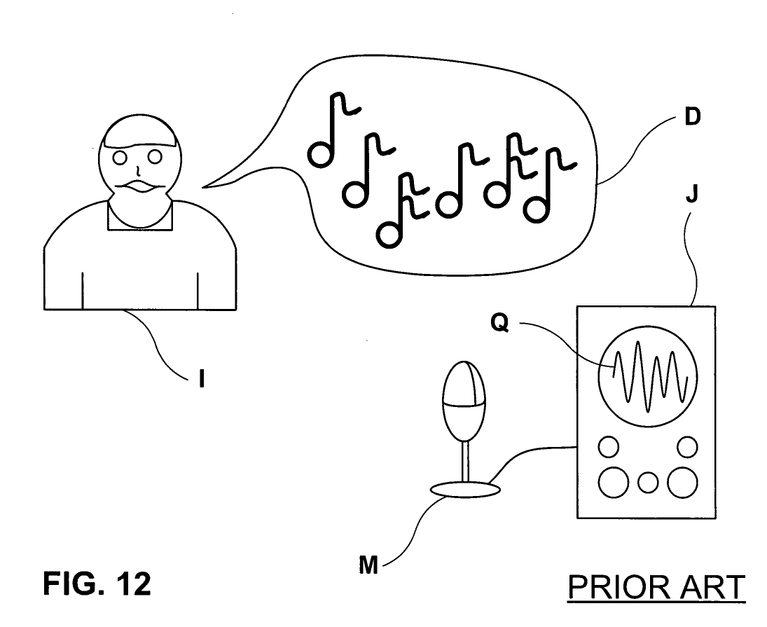

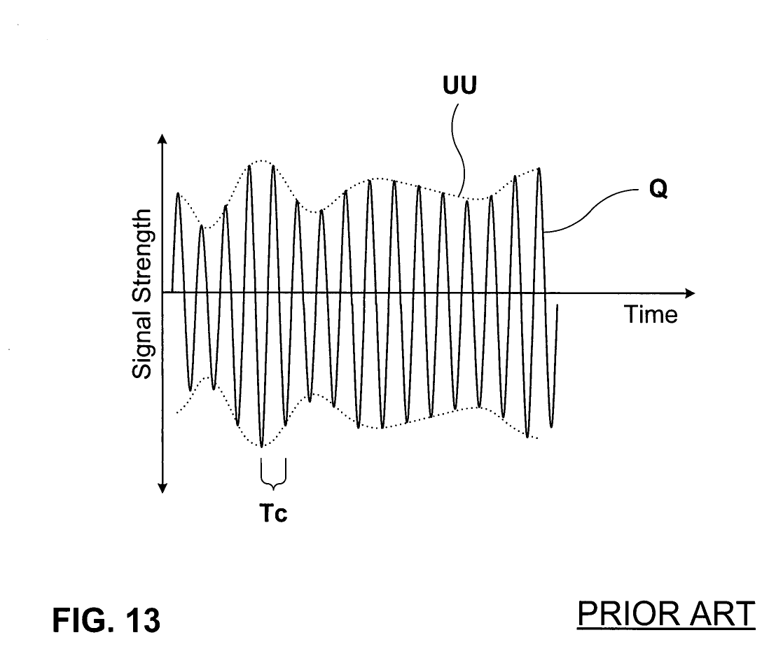

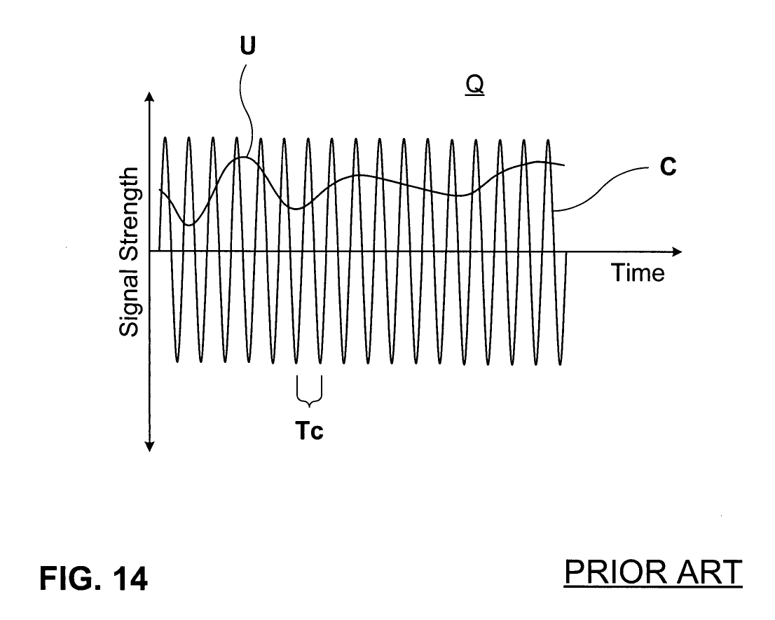

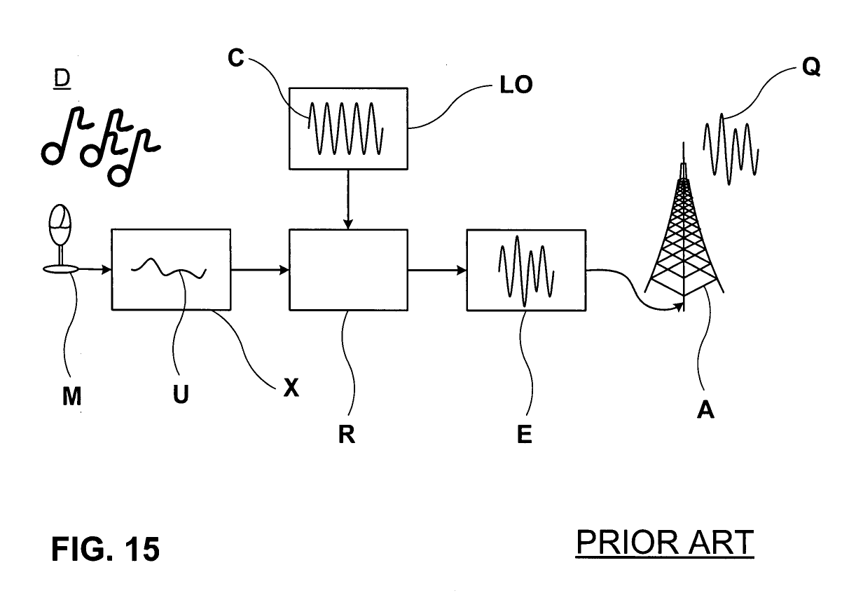

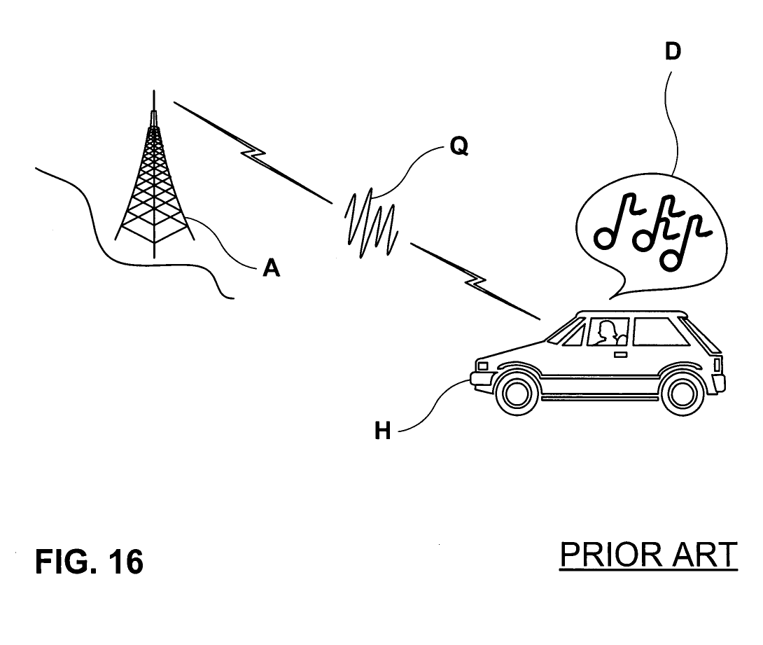

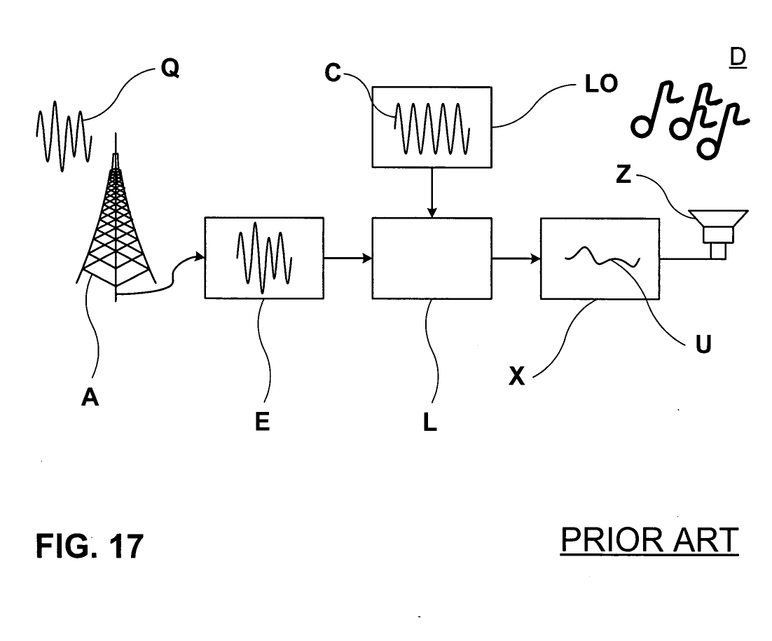

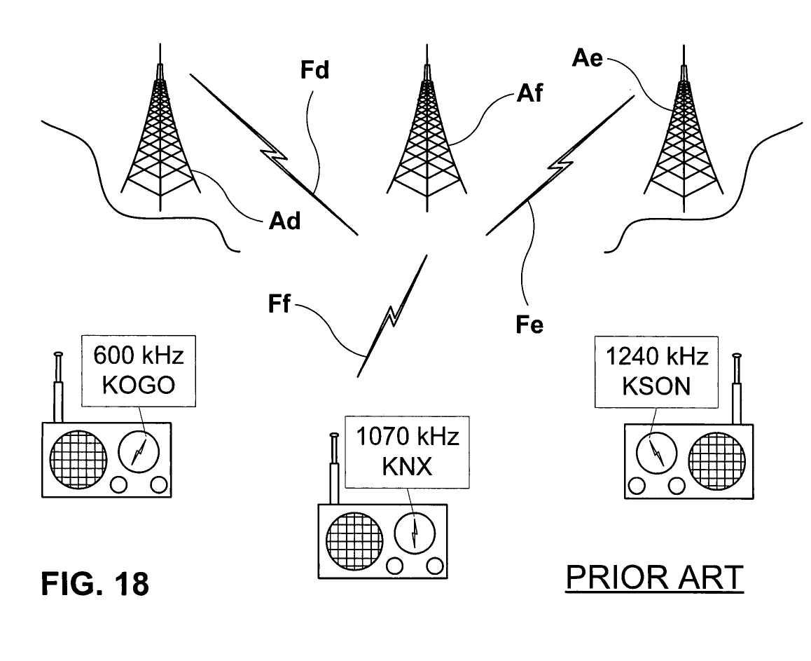

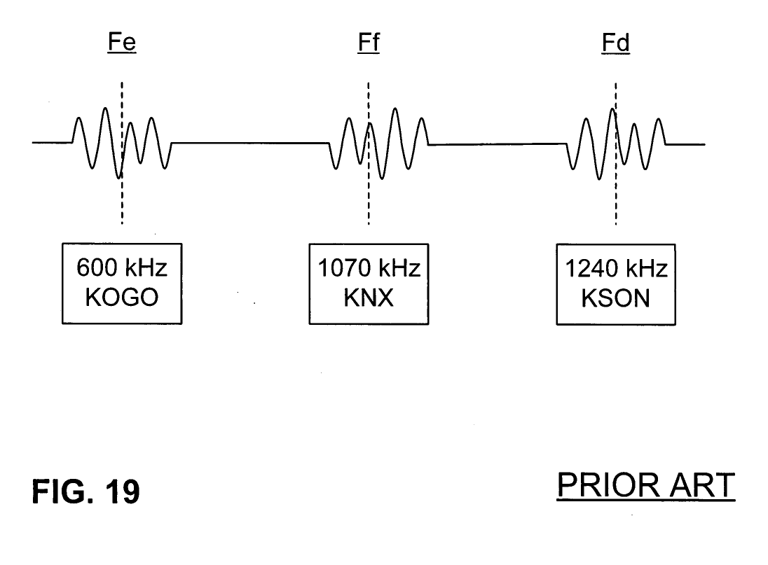

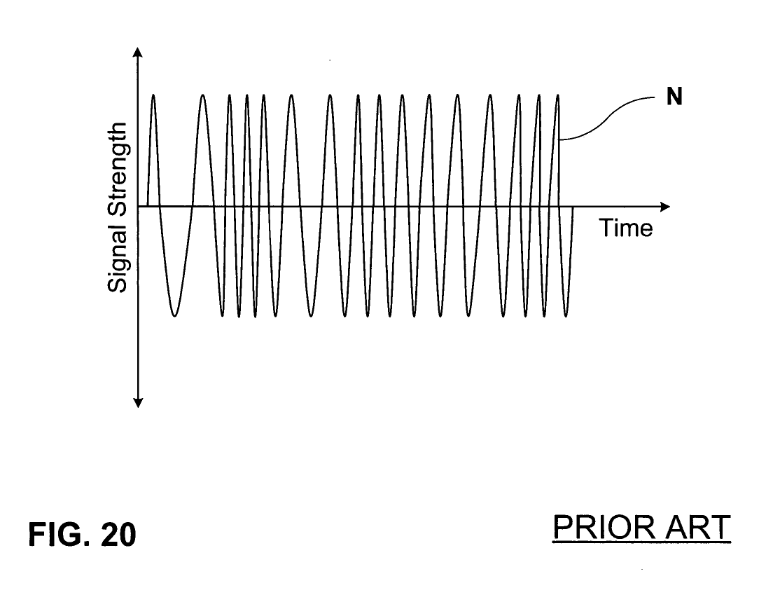

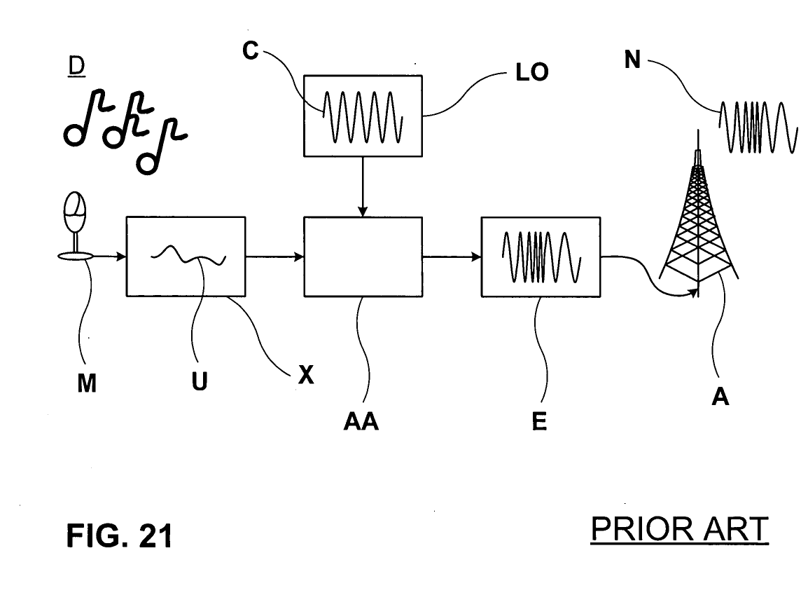

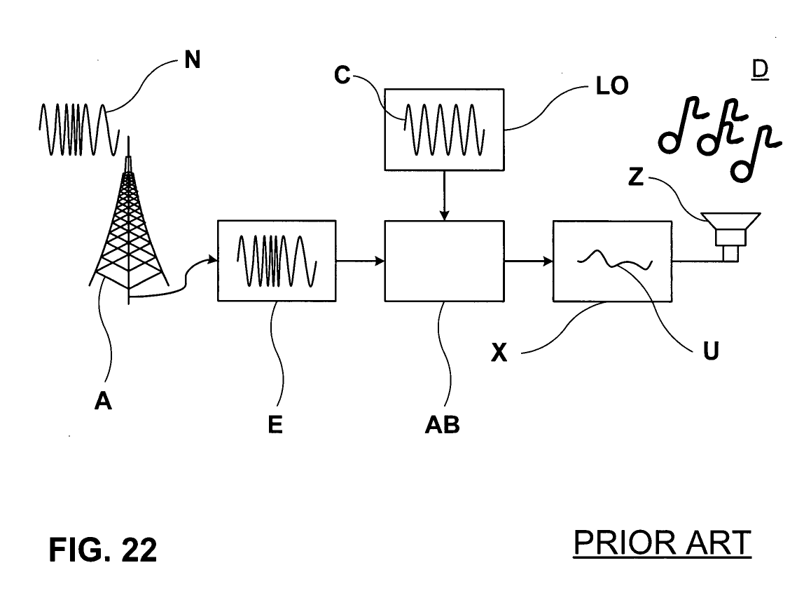

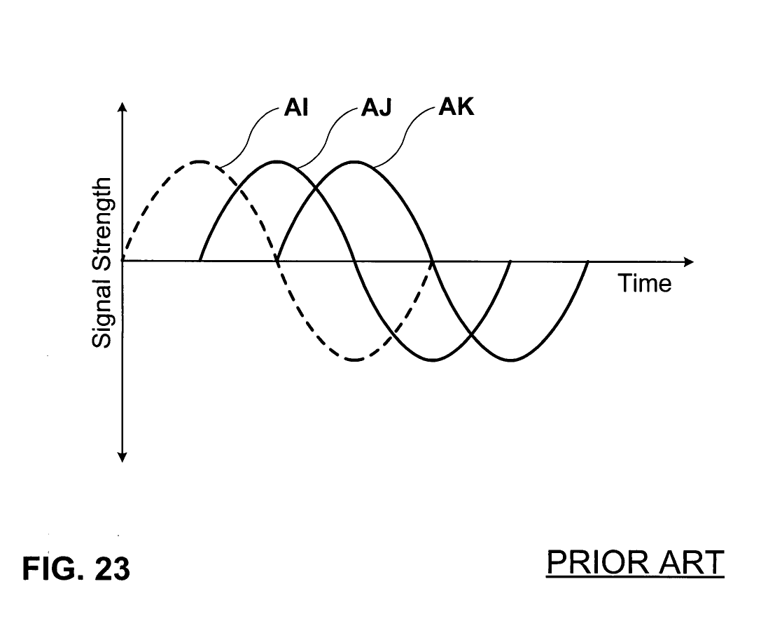

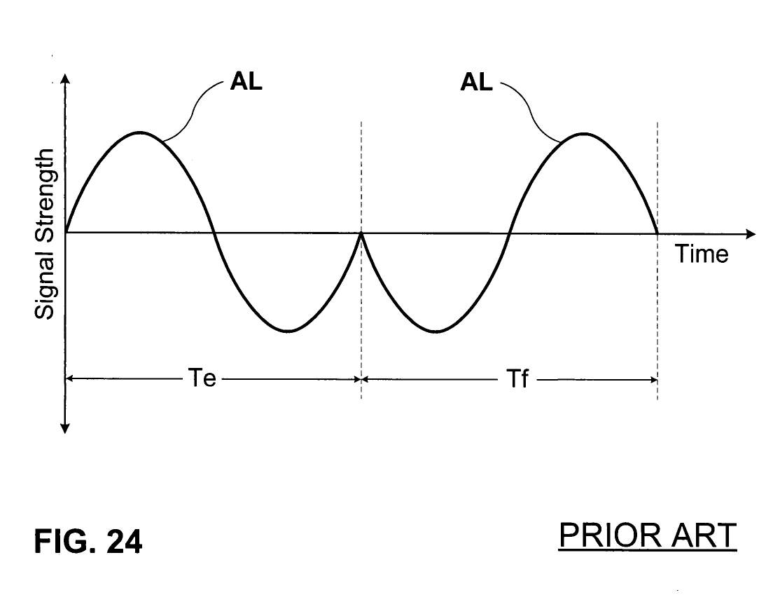

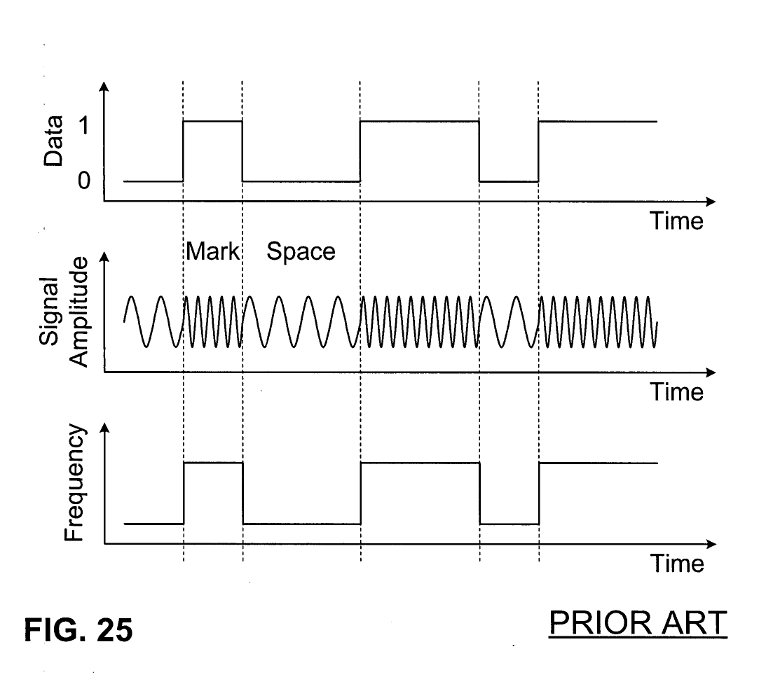

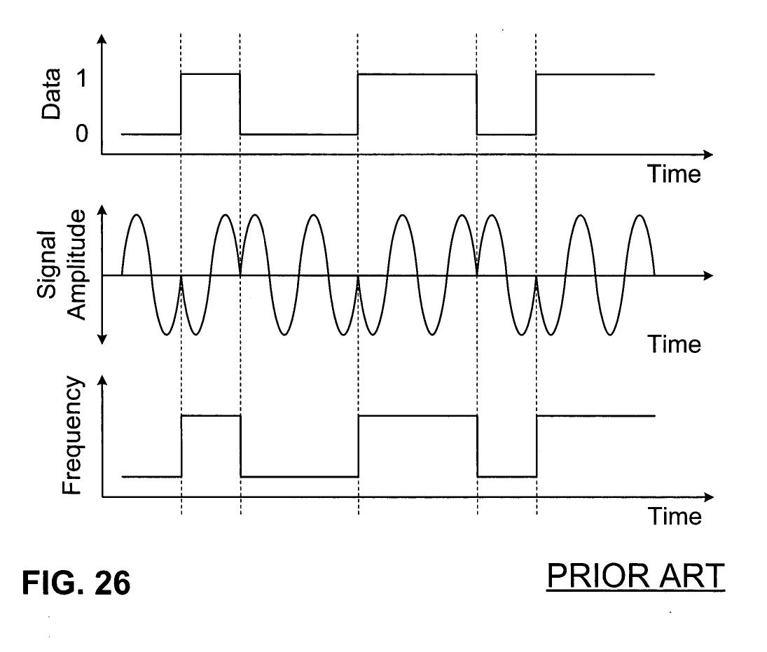

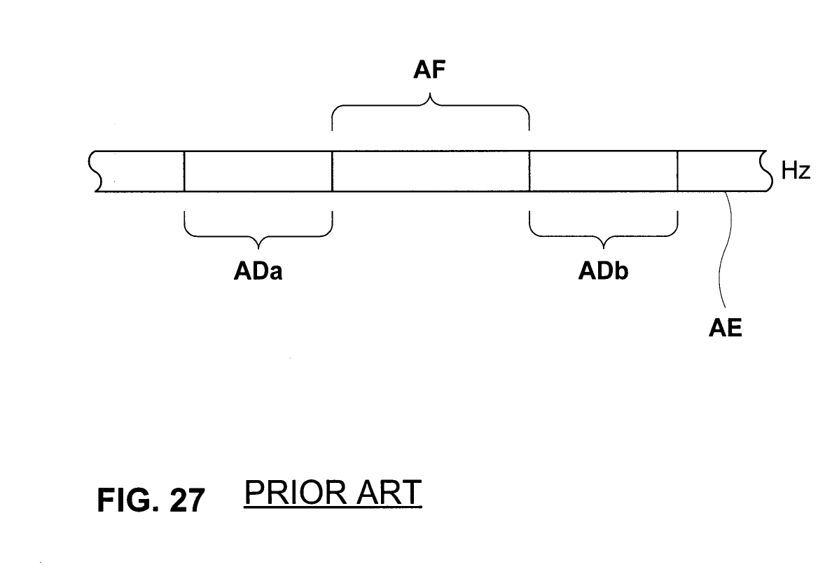

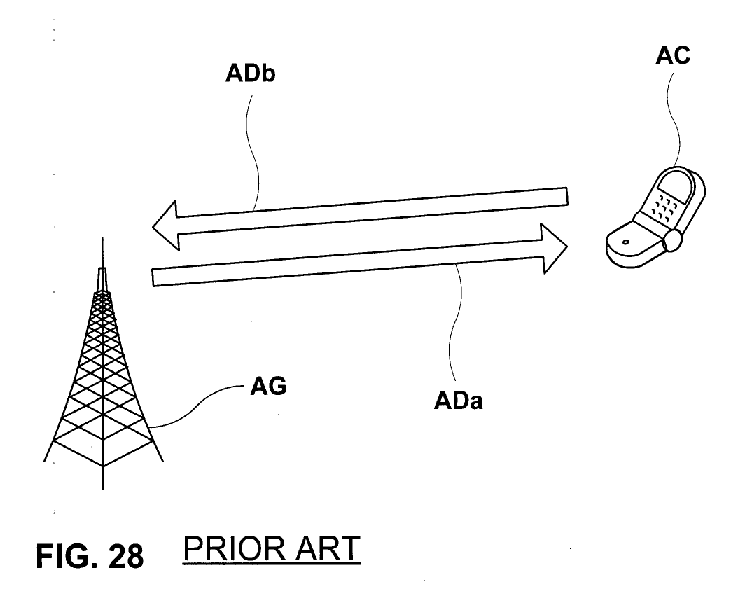

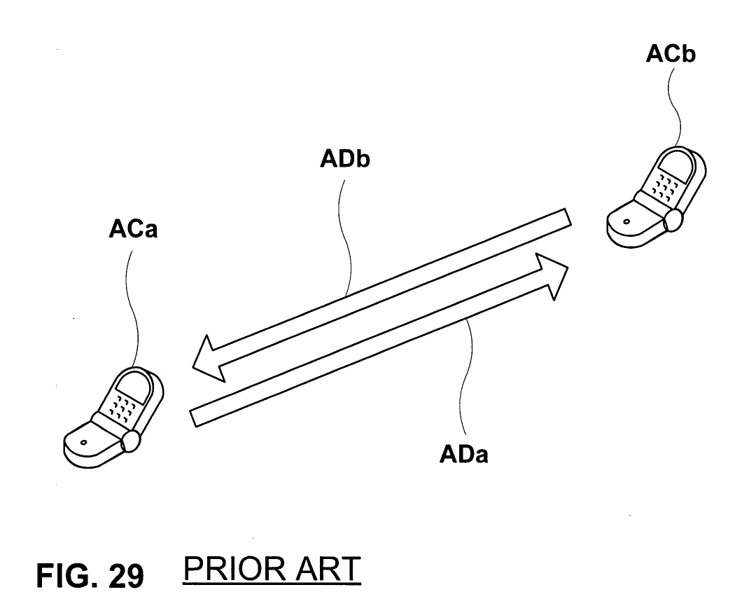

### DETAILED DESCRIPTION OF PREFERRED & ALTERNATIVE EMBODIMENTS

I. Basic Chirp Waveforms.

The Digital Radio System uses “chirp” waveforms to provide high-speed, wireless communications. The use of the term “chirp” is intended only as a distinctive or descriptive term, and is not intended to limit the scope or description of the present invention. In the most basic embodiment of the invention, chirp waveforms 10 are used to convey a digital message of “one ” or “zero. ” In general, a chirp waveform 10 may be described as having the following qualities:
Dimensions
Continuity
Boundaries
Family
Duration
Slope
Meaning
Multiplicity
   Dimension

A dimension is the space into which a chirp is mapped. Dimensions may be represented graphically by a set of Cartesian Coordinate Axes, x and y. The minimum number of dimensions for a chirp is always two. More advanced embodiments of the invention may utilize chirps having three or more dimensions.

Continuity

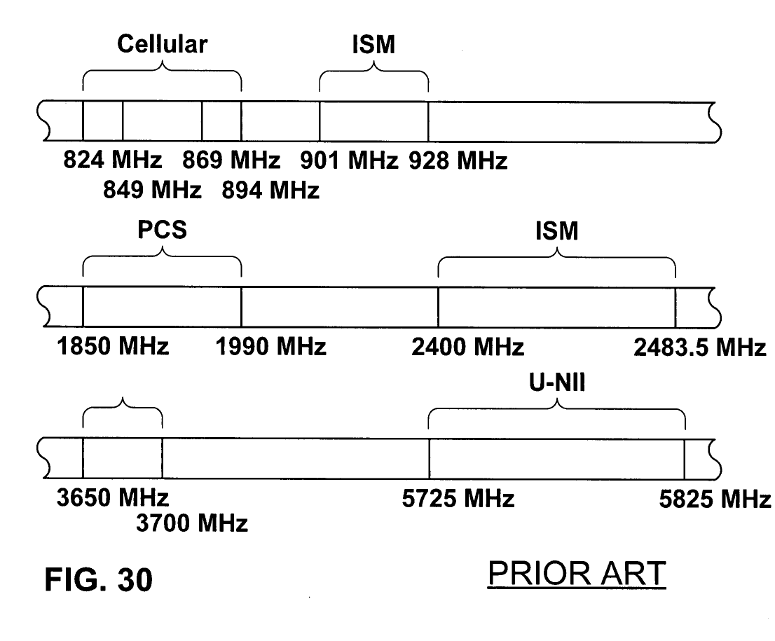

The basic embodiment of a chirp waveform 10 utilizes generally continuous line segments, as shown in FIG. 30. In this Specification and in the Claims that follow, the term “continuous” refers to a function which describes a line that extends between a start point 12S and end point 12E that is smooth and gradual without any breaks or sharp changes in direction. If a line segment can be drawn from a start point 12S to an end point 12E without lifting the pencil from the paper, that segment is generally continuous. A more technical explanation defines “continuous” as a function for which an arbitrarily small change in x causes an arbitrarily small change in y. A rigorous, mathematical definition for continuous follows:

A function is continuous at a point c in its domain D if:
Given any ∈>0 there exists a δ>0 such that: if x ∈ D and |x−c|<δ then |f(x)−f(c)|<∈.

A function is continuous in its domain D if it is continuous at every point of its domain.
See: http://web01.shu.edu/projects/reals/cont/contin.html

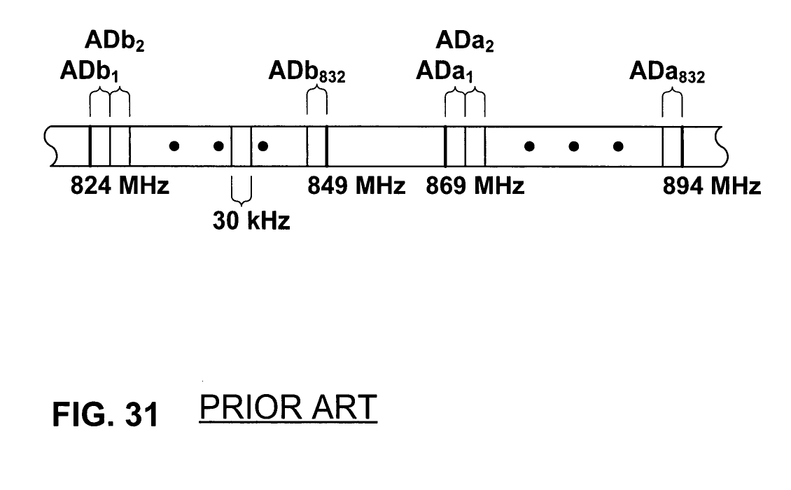

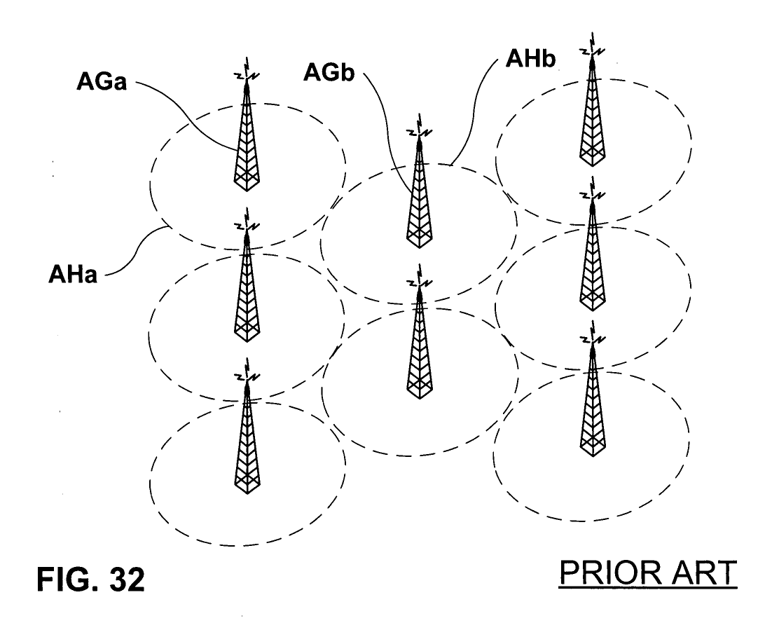

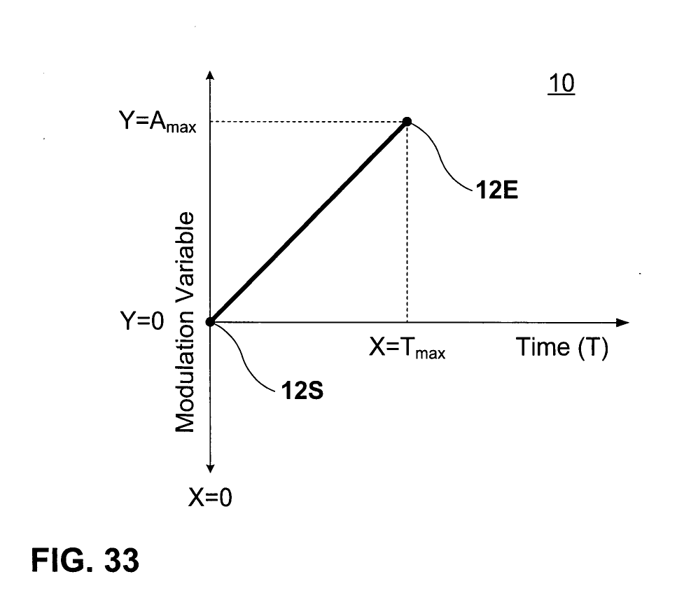

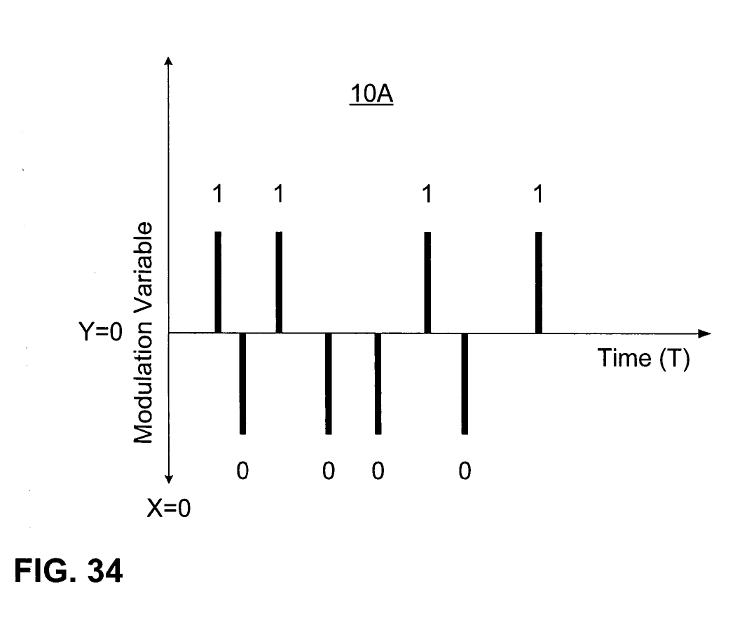

In an alternative embodiment, discontinuous waveforms 10A may be employed to implement the present invention, as shown in FIG. 31.

Boundaries

As shown best in FIG. 30, a boundary 12 is an end point of a single chirp. A start point 12S and an end point 12E are the two boundaries of the most basic form of chirp 10. When boundaries are measured in the time dimension, the end point 12E is always later in time that the start point 12S. For this kind of simple chirp 10, no other boundaries are recognized.

Family

A family is the description of the group to which a particular chirp belongs. The family concerns the type of line segment that is used to form a chirp. The most basic type of chirp is constructed from a linear line segment, and may be described by the equation y=mx+b. In more advanced chirps, the line segment which is employed to build a chirp may be defined by an equation that uses a mononomial expression, a polynomial expression, a trigonometric expression, an exponential expression or any other algebraic expression that defines a generally continuous line segment that extends between a start point and an end point. In this Specification and in the Claims that follow, the term “mononomial” means an expression comprising only one term. The term “polynomial” means an expression comprising of two or more terms.

The term “sinusoidal” generally means an expression of the form:
f(x)=a sin (x)+b cos t (x)

The term “exponential” pertains to a mathematical function that includes a variable in an exponent, and which is characterized by the following form:
f(x)=a^{x}
where x is a variable, and a is a constant, called the base of the function. The most commonly encountered exponential-function base is the transcendental number e, which is equal to approximately 2.71828. Thus, the above expression becomes:
f(x)=e^{x}
Duration & Slope

For the chirp waveform 10 depicted in FIG. 30, the duration of the chirp is the time T that elapses between the end point 12S and the end point 12E:
Duration=Time at End Point−Time at Start Point

Similarly, the slope of the chirp waveform 10 shown in FIG. 30 is the quotient of the end point 12E and the start point 12S:
Slope=(End Point Amplitude−Start Point Amplitude)/Duration
   Meaning

In one embodiment of the invention, a meaning is the digital value that is represented by a chirp. In the most basic embodiment, there are only two meanings for a chirp, “one” and “zero.” No other meanings or values are permitted. In more advanced embodiments, more than two meanings are permitted.

For a two dimensional chirp, one method of determining the meaning of a chirp waveform compares maximum and minimum chirp values. Using this method, a chirp waveform has a value of “one” if the value of the end point 12E as measured along the y-axis is greater than the value of the start point 12S as measured along the y-axis. For a two dimensional chirp, a chirp waveform has a value of “zero” if the value of the end point 12E as measured along the y-axis is less than the value of the start point 12S as measured along the y-axis.

In an alternative embodiment, a chirp waveform has a value of “one” if the slope of the line segment at any point on the line segment between the start point and the end point is positive. Conversely, a chirp waveform has a value of “zero ” if the slope of the line segment at any point on the line segment between the start point and the end point is negative.

Methods for determining the values of three or higher dimensional chirp waveforms are discussed in Section III.

The term “meaning” generally refers to the message, value, condition or state which is propagated by a source, and which then may be detected, decoded or interpreted by a receiver, whether wired or wireless.

Multiplicity

The multiplicity of a chirp refers to the number of waveforms that are propagated or present in a given time interval or over a particular time duration. The waveform 10 shown in FIG. 30 is alone in the duration that spans start point 12S and end point 12E, so the waveform in FIG. 30 has a multiplicity of one. Higher multiplicity chirps are discussed in Section IV of this Specification.

II. Alternative Embodiments of Two Dimensional Chirp Waveforms

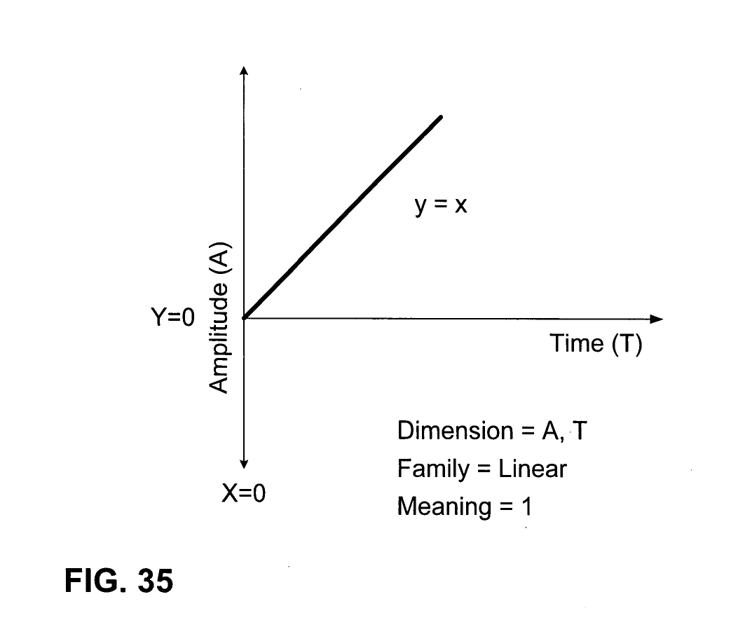

The chirp shown in FIG. 30 may be varied by altering the kind of line segment which is used to span the distance between the start point 12S and the end point 12E. These variations provide a virtually limitless number of alternative embodiments. Some of these alternative embodiments for two dimensional chirps are depicted in FIGS. 35 through 74. These figures are provided as examples and illustrations, and are not intended to exclude many other possible two-dimensional waveforms.

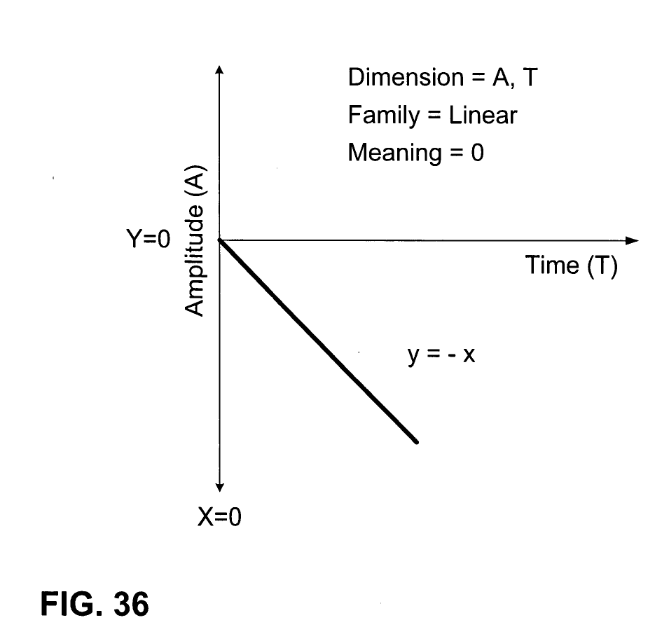

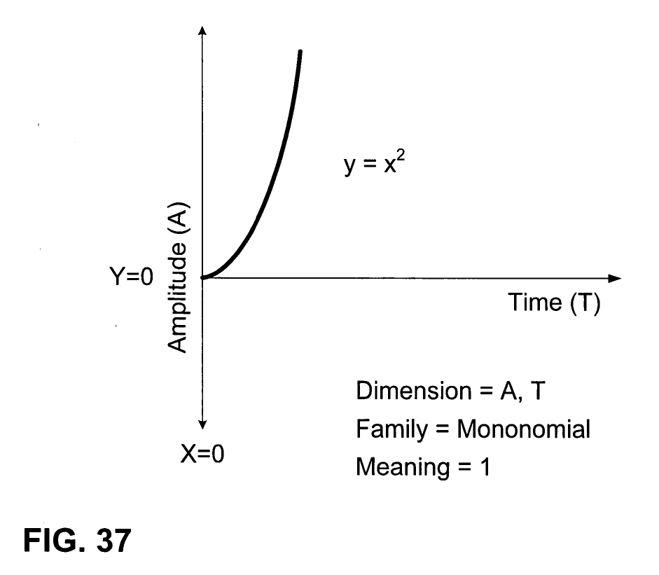

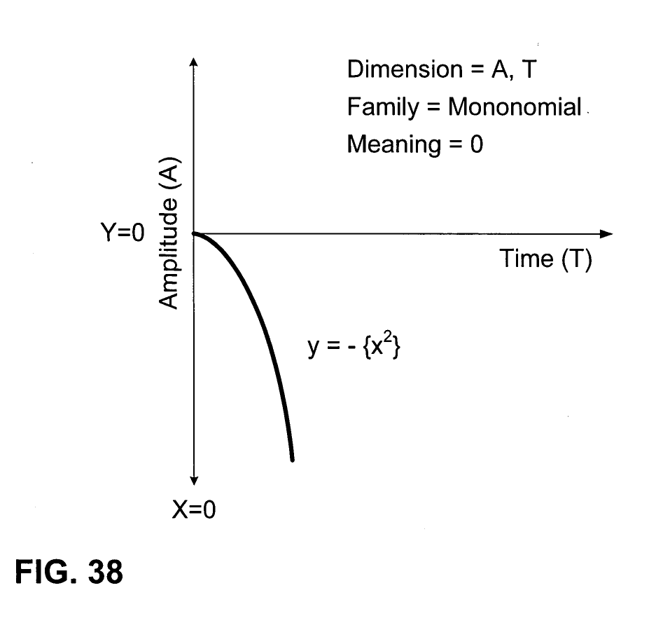

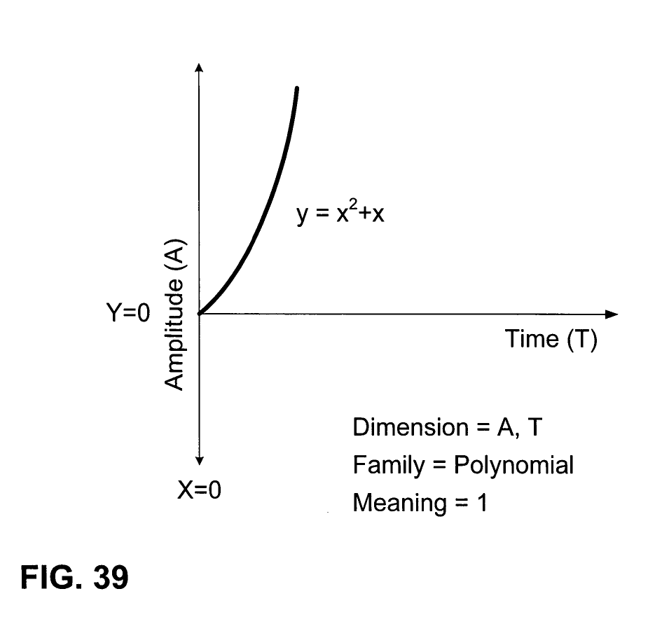

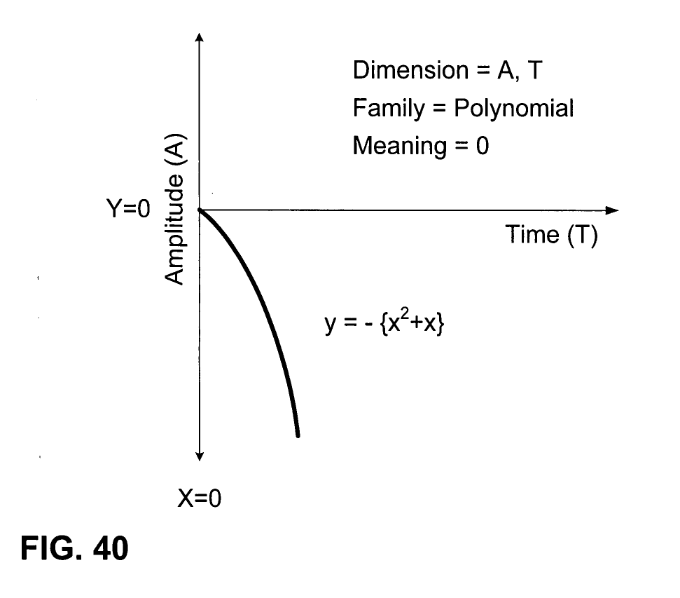

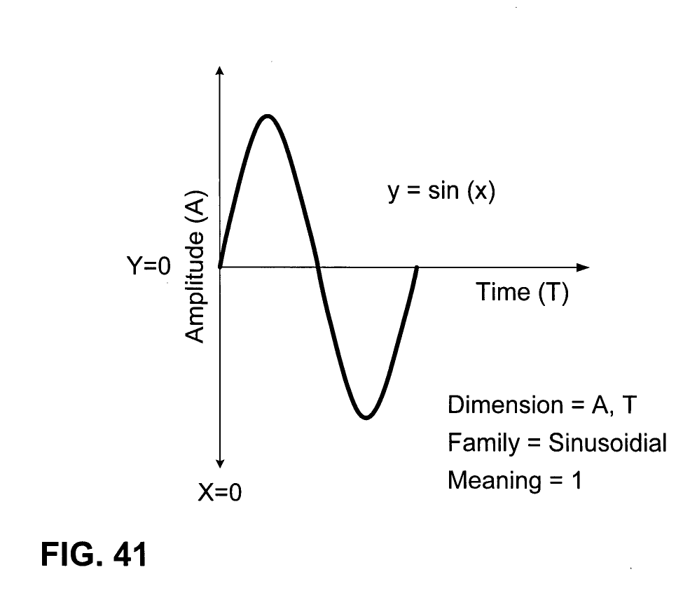

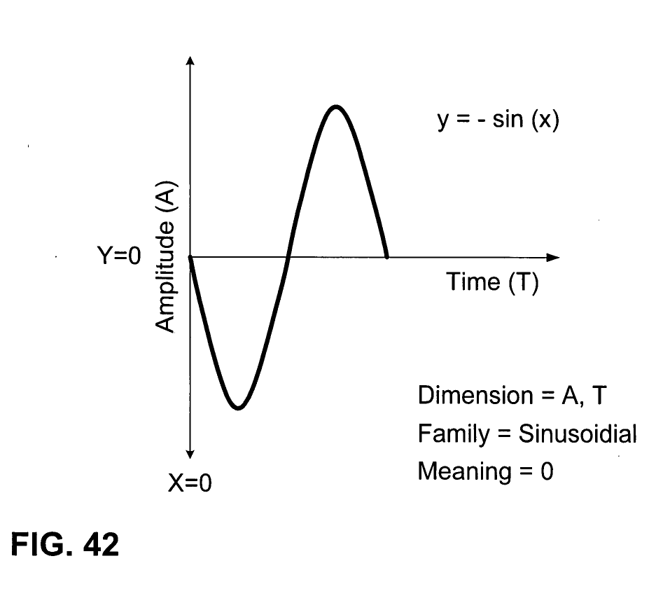

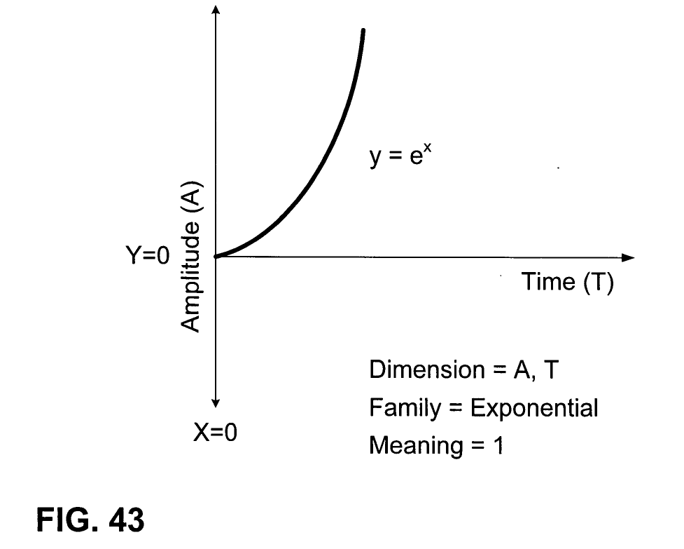

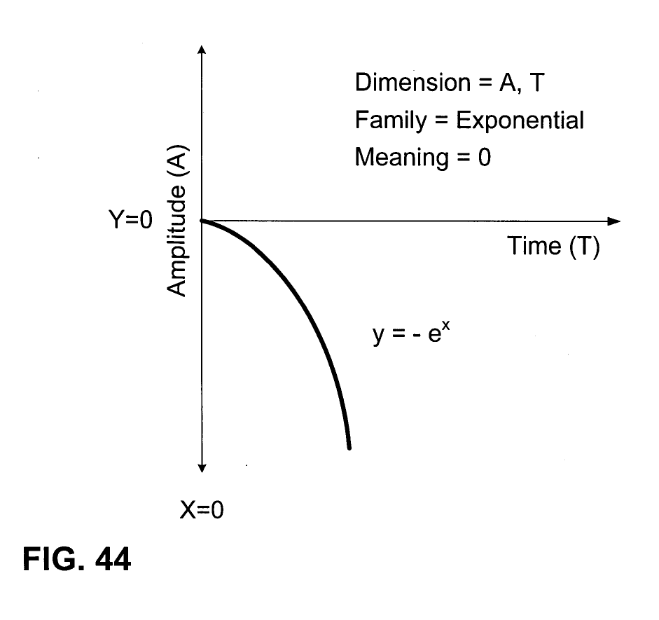

FIGS. 35 and 36 are formed from linear line segments. FIGS. 37 and 38 are formed from mononomial line segments. FIGS. 39 and 40 are formed from polynomial line segments. FIGS. 41 and 42 are formed from sinusoidal line segments. FIGS. 43 and 44 are formed from exponential line segments. FIGS. 35, 37, 39, 41 and 43 have meanings of“one” in amplitude versus time space. FIGS. 36, 38, 40, 42 and 44 have meanings of “zero” in amplitude versus time space.

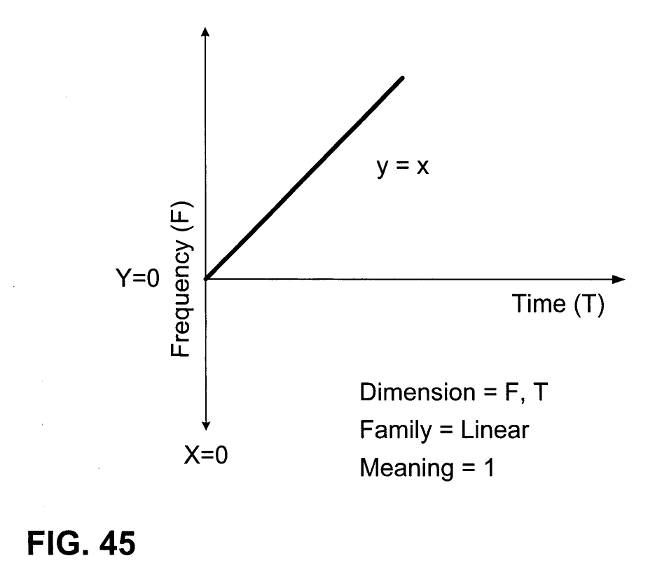

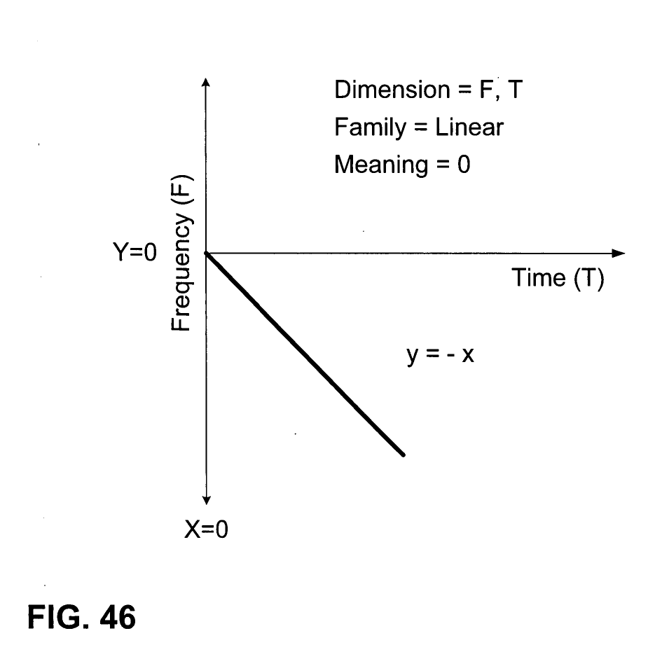

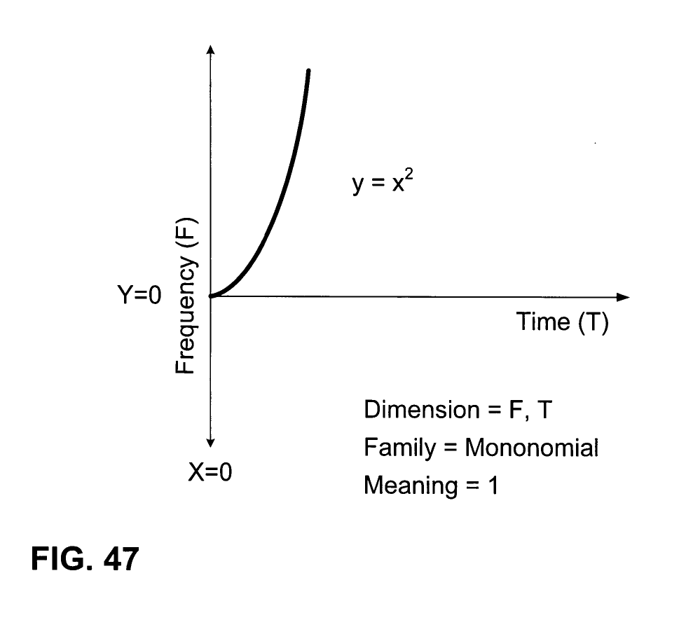

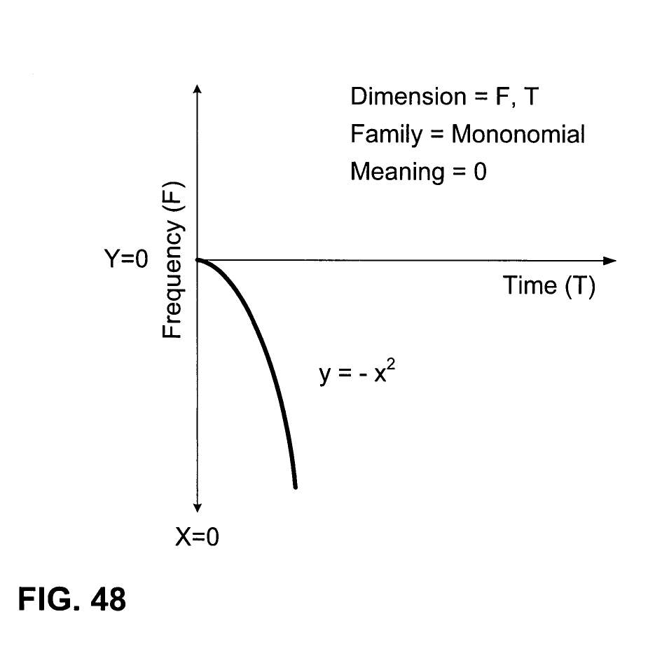

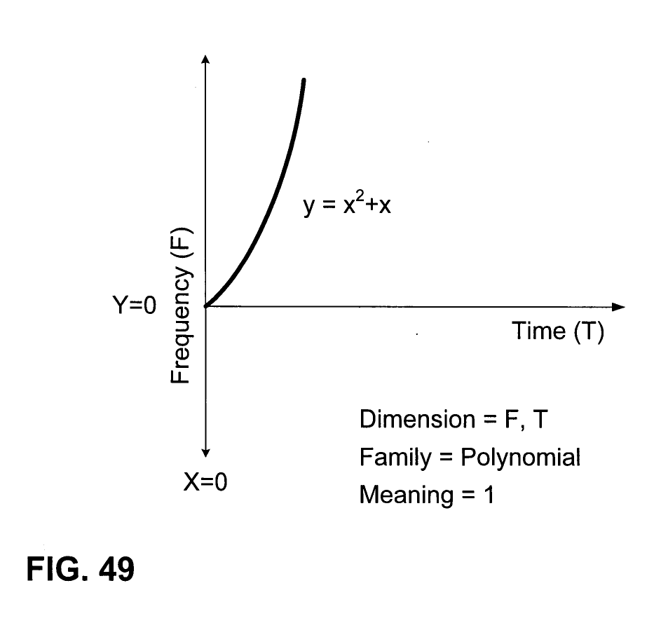

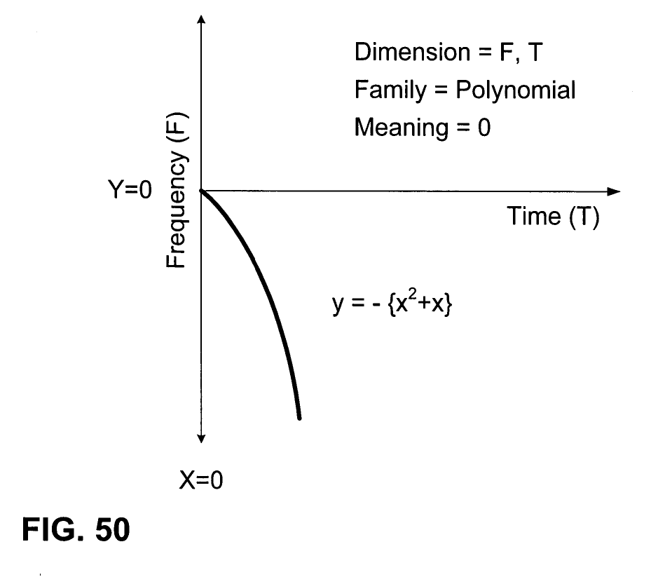

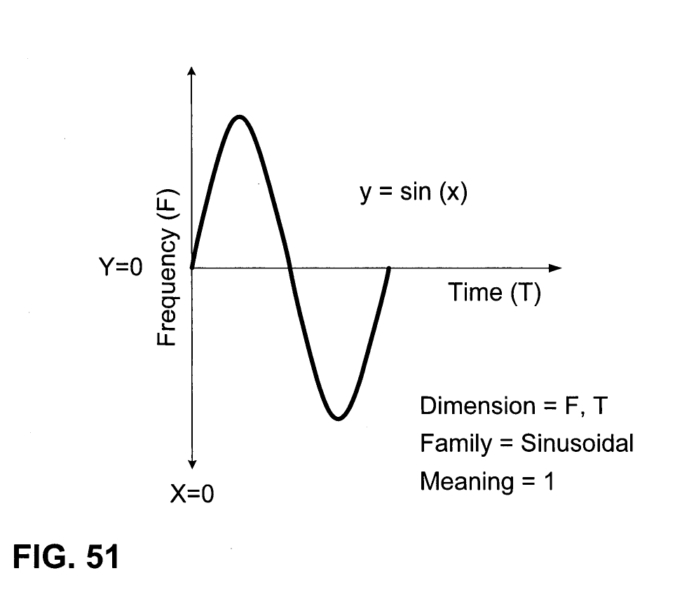

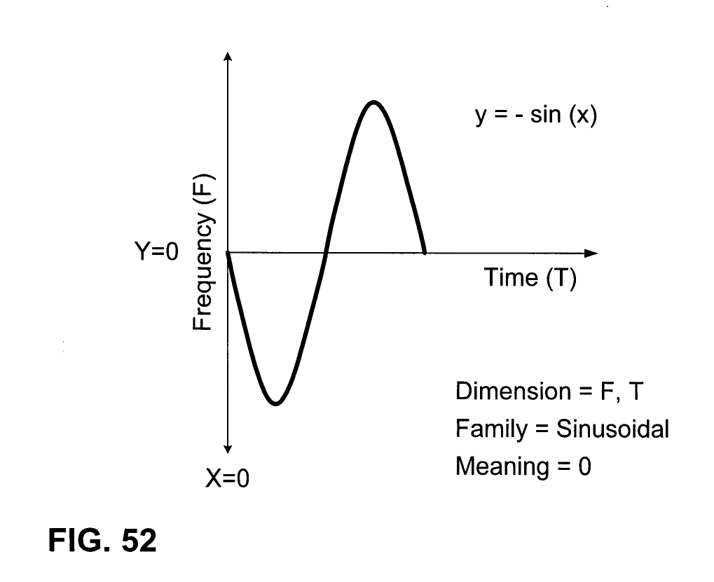

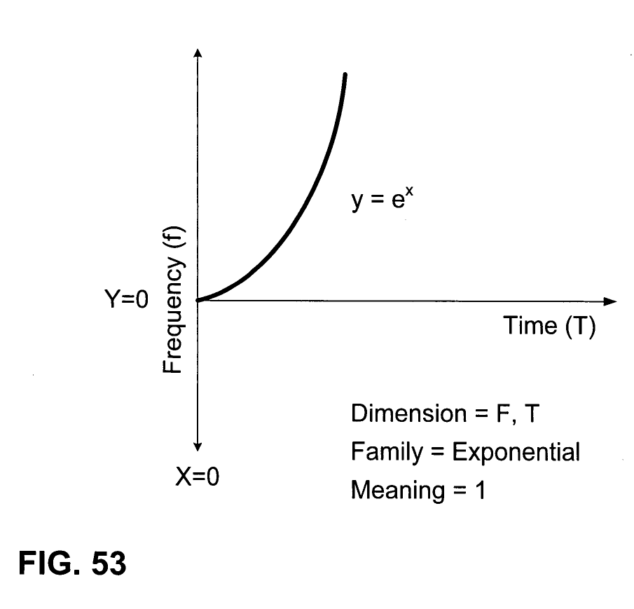

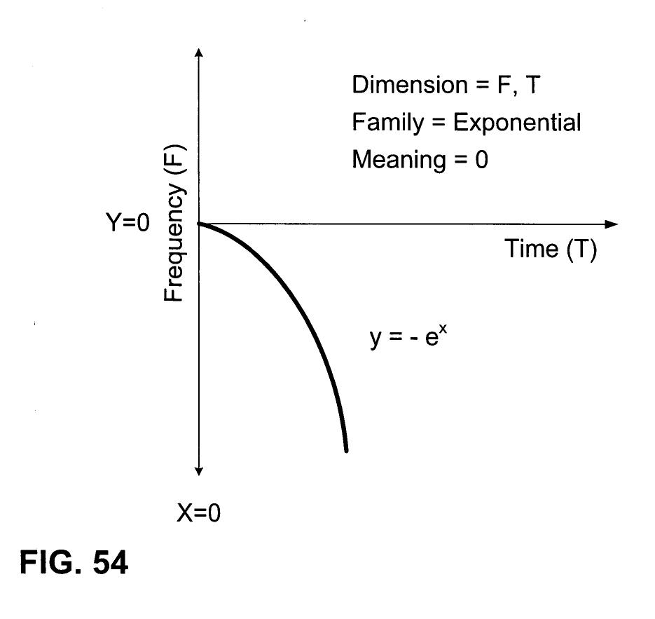

FIGS. 45 through 54 depict two-dimensional chirp waveforms mapped in frequency versus time space for meanings “one” and “zero” for five different families of chirps. FIGS. 45 and 46 are formed from linear line segments. FIGS. 47 and 48 are formed from mononomial line segments. FIGS. 49 and 50 are formed from polynomial line segments. FIGS. 51 and 52 are formed from sinusoidal line segments. FIGS. 53 and 54 are formed from exponential line segments. FIGS. 45, 47, 49, 51 and 53 have meanings of “one.” FIGS. 46, 48, 50, 52 and 54 have meanings of “zero.”

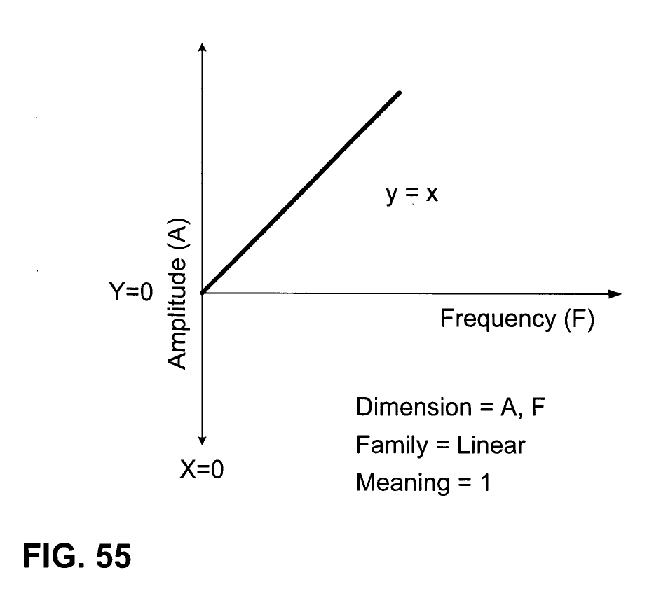

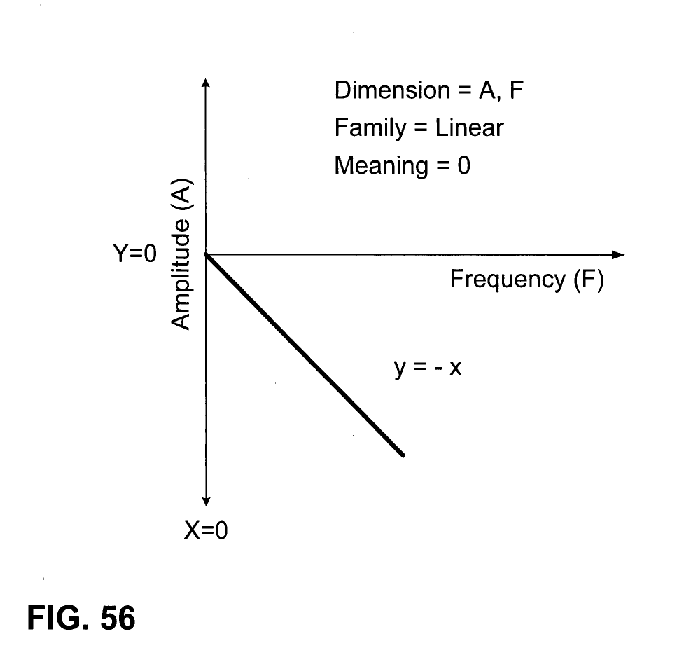

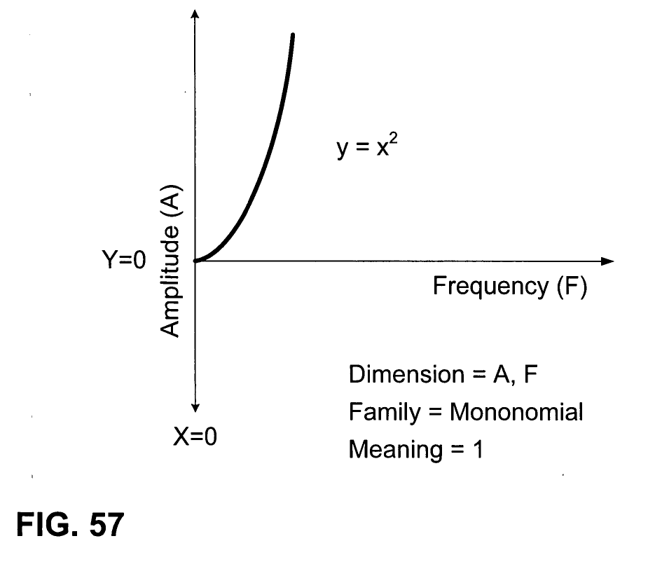

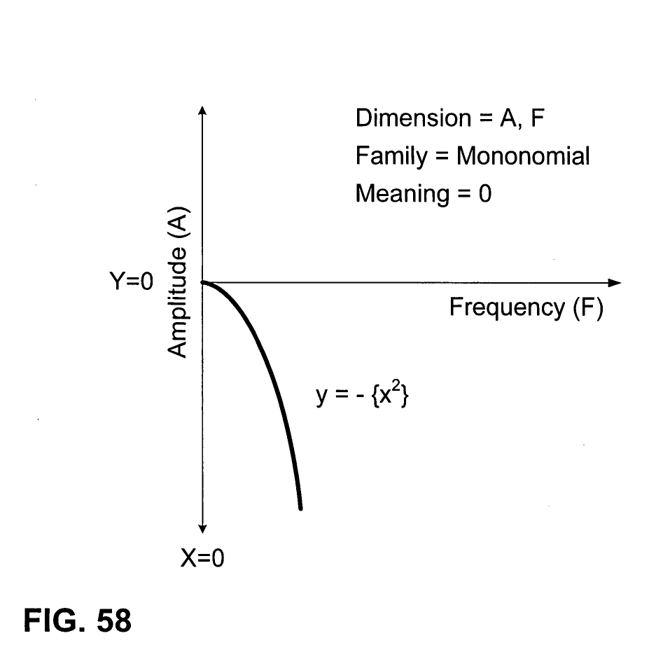

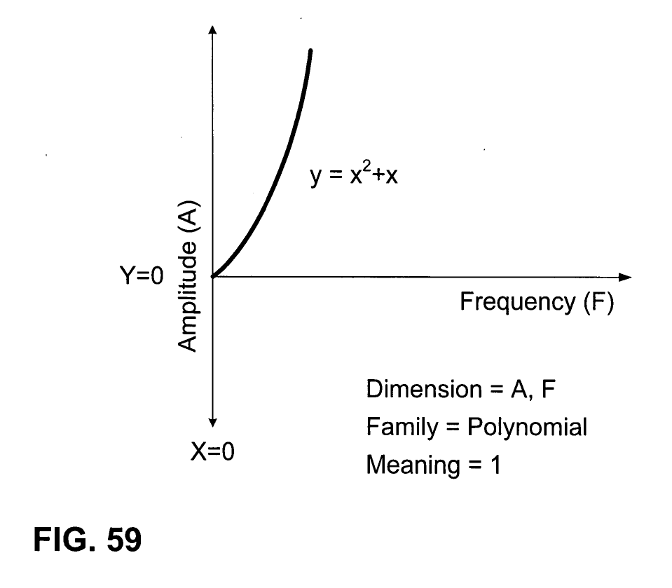

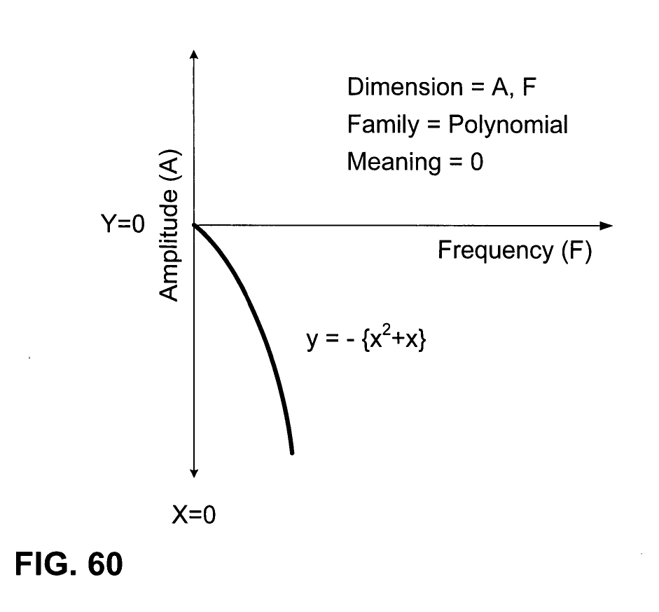

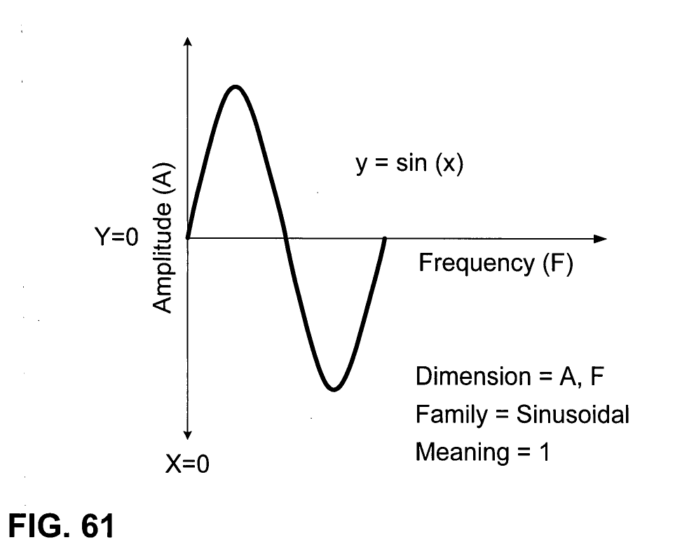

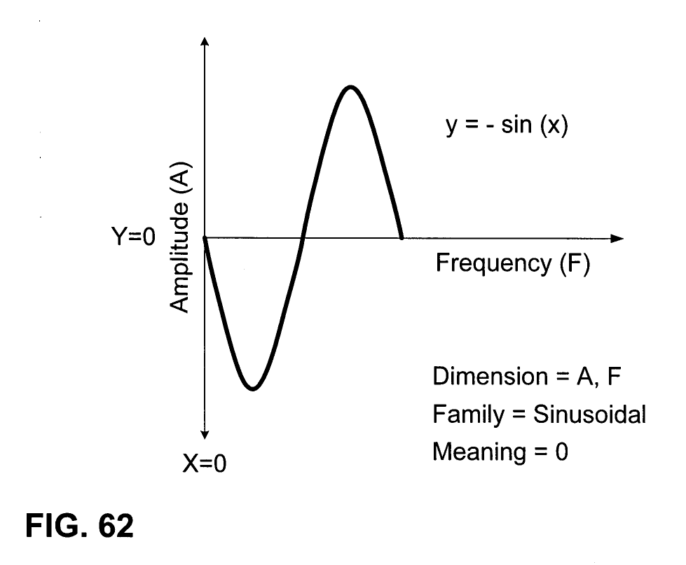

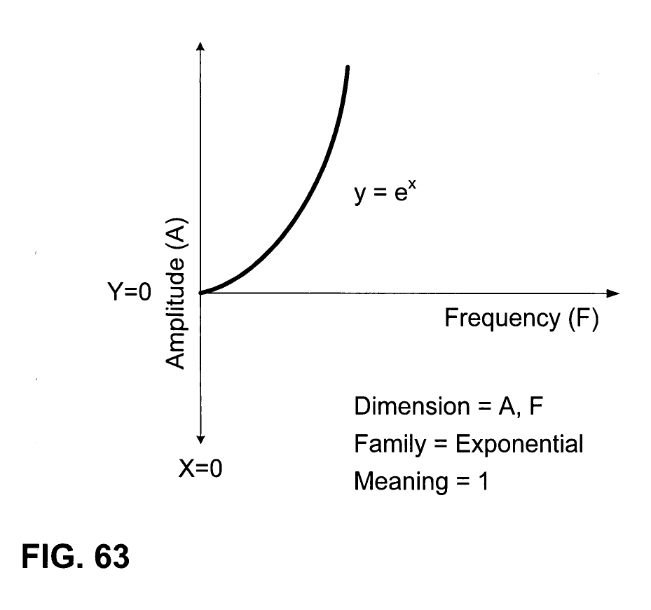

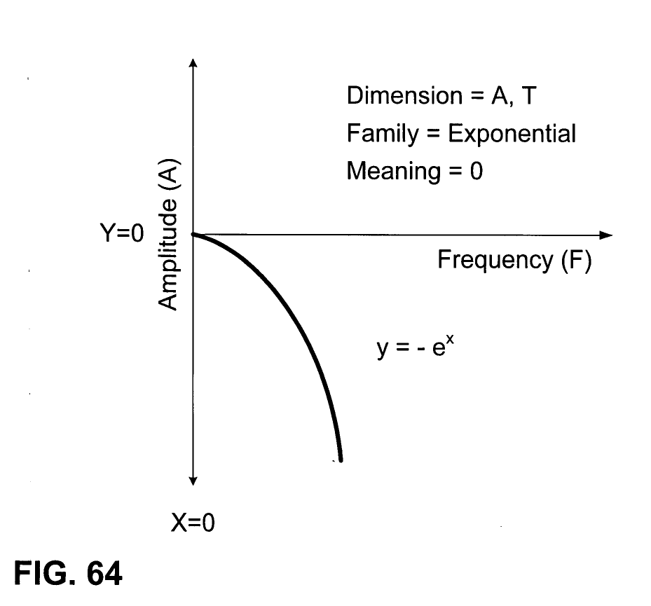

FIGS. 55 through 64 depict two-dimensional chirp waveforms mapped in amplitude versus frequency space for meanings “one” and “zero” for five different families of chirps. FIGS. 55 and 56 are formed from linear line segments. FIGS. 57 and 58 are formed from mononomial line segments. FIGS. 59 and 60 are formed from polynomial line segments. FIGS. 61 and 62 are formed from sinusoidal line segments. FIGS. 63 and 64 are formed from exponential line segments. FIGS. 55, 57, 59, 61 and 63 have meanings of “one.” FIGS. 56, 58, 60, 62 and 64 have meanings of “zero.”

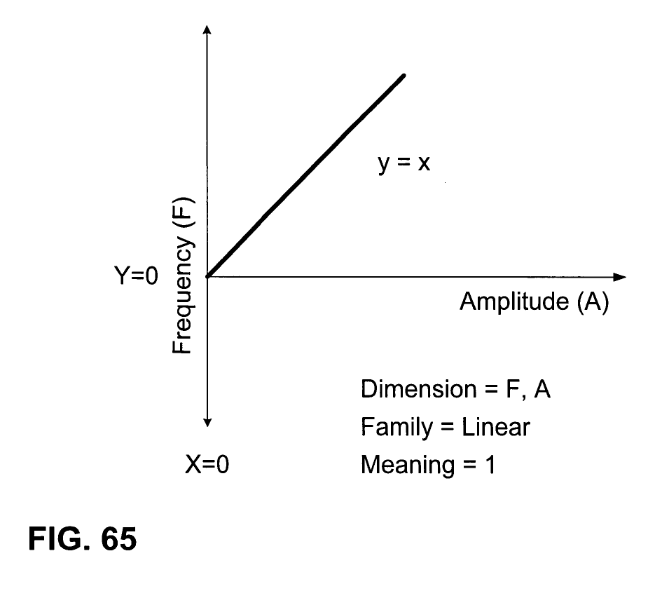

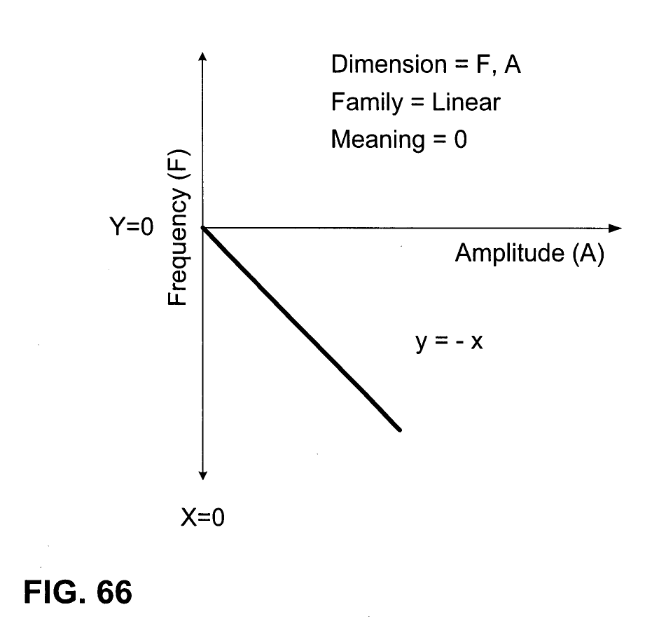

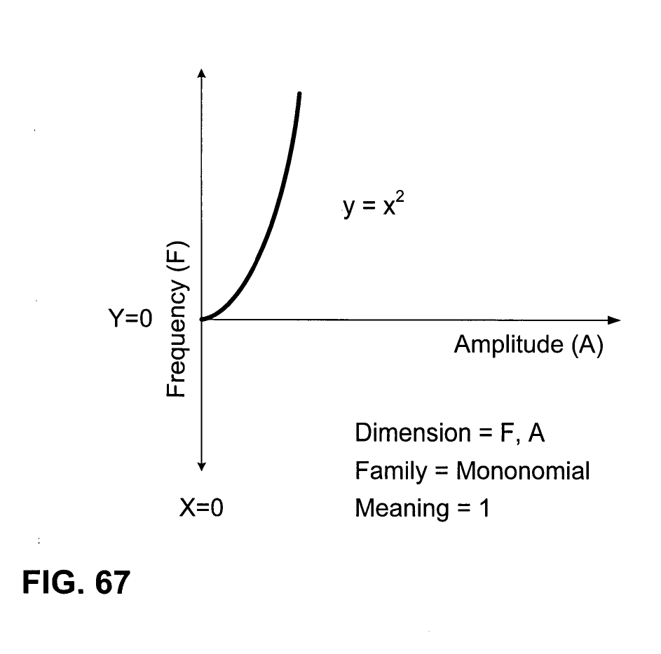

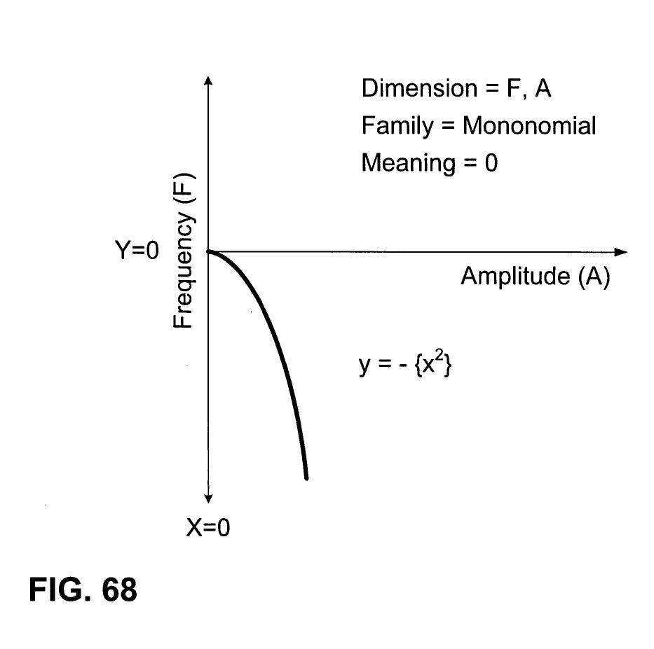

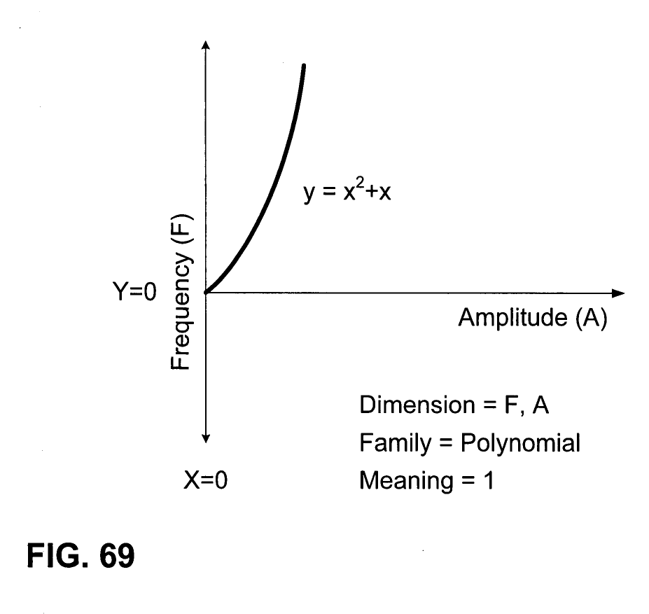

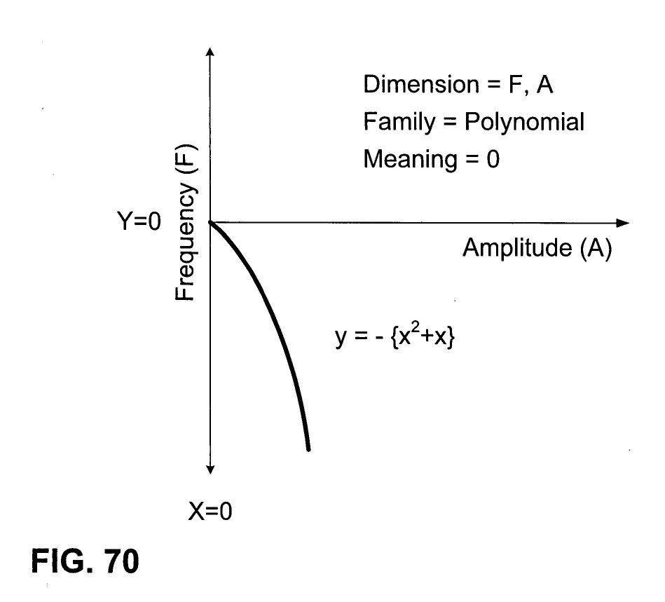

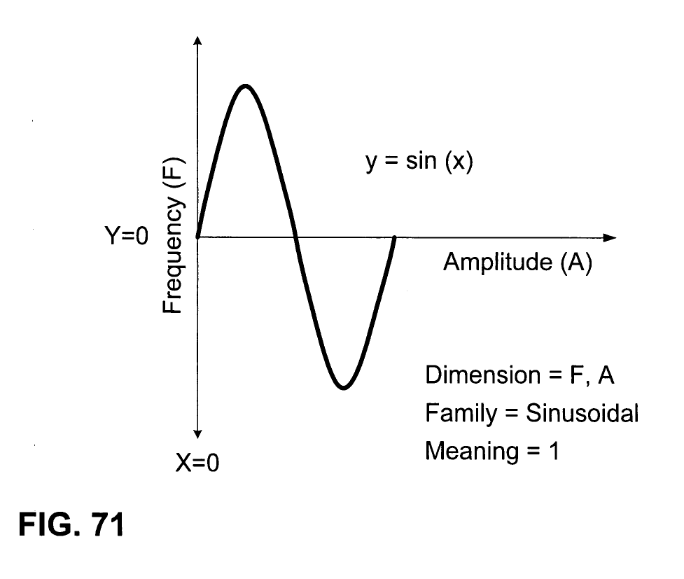

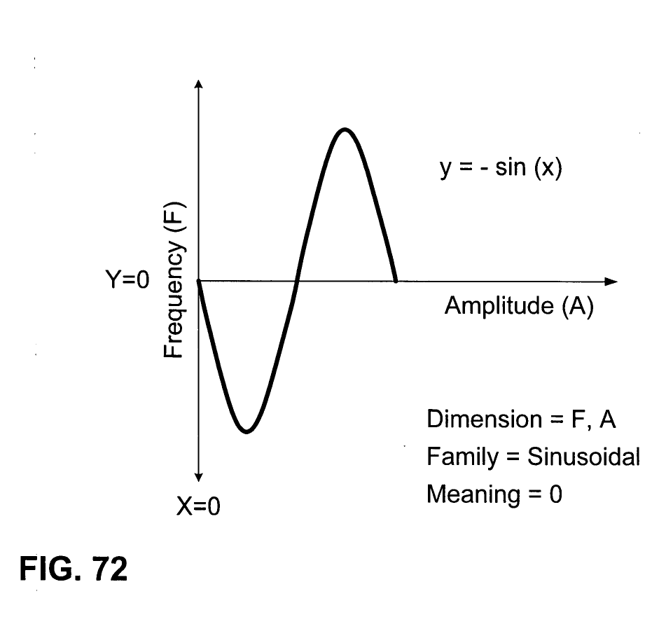

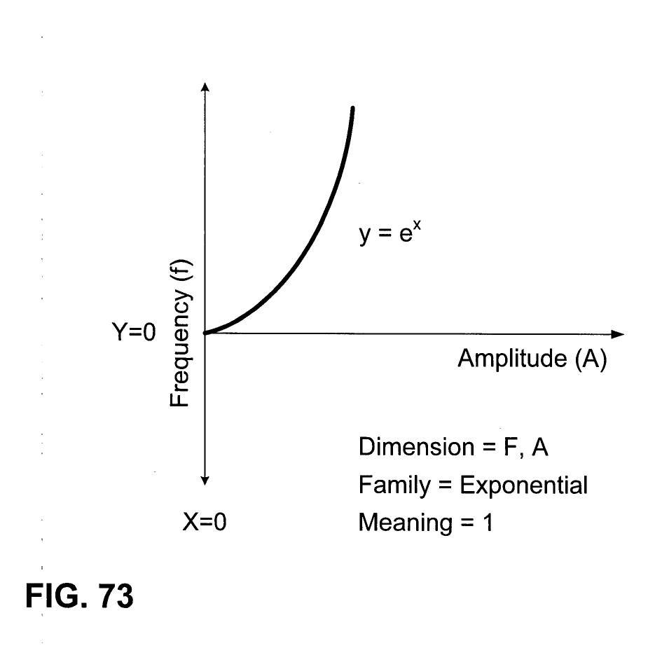

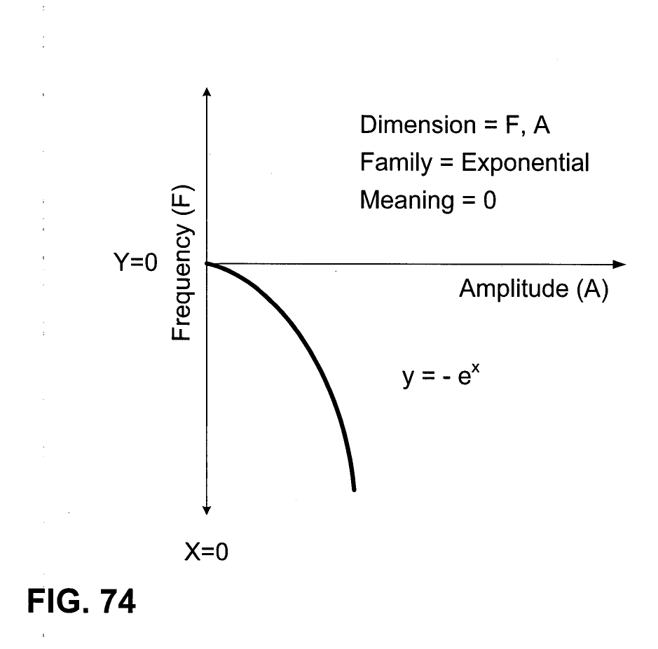

FIGS. 65 through 74 depict two-dimensional chirp waveforms mapped in frequency versus amplitude space for meanings “one” and “zero” for five different families of chirps. FIGS. 65 and 66 are formed from linear line segments. FIGS. 67 and 68 are formed from mononomial line segments. FIGS. 69 and 70 are formed from polynomial line segments. FIGS. 71 and 72 are formed from sinusoidal line segments. FIGS. 73 and 74 are formed from exponential line segments. FIGS. 65, 67, 69, 71 and 73 have meanings of “one.” FIGS. 66, 68, 70, 72 and 74 have meanings of “zero.”

III. Three Dimensional Chirp Waveforms

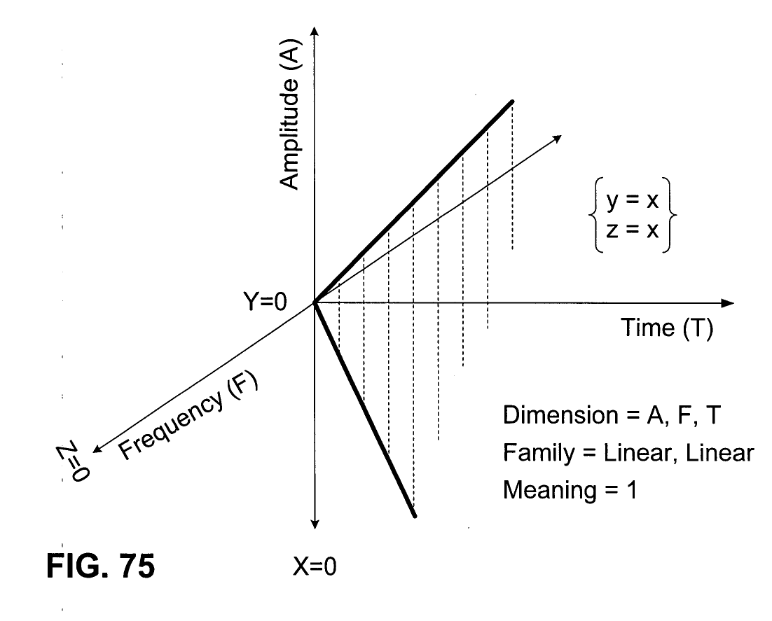

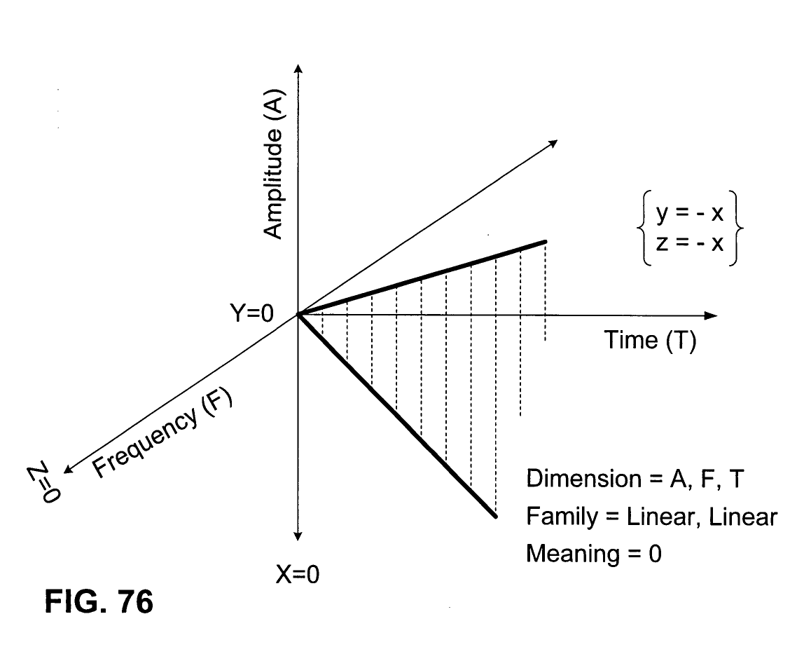

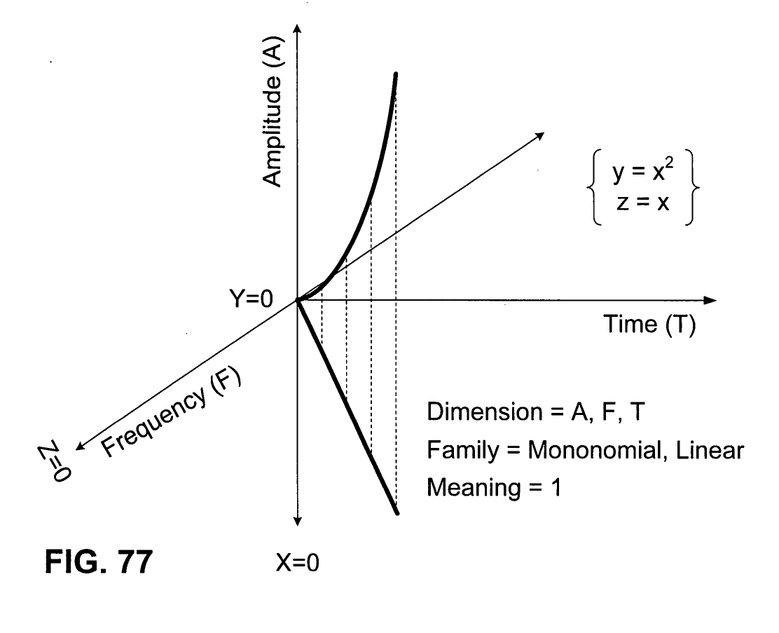

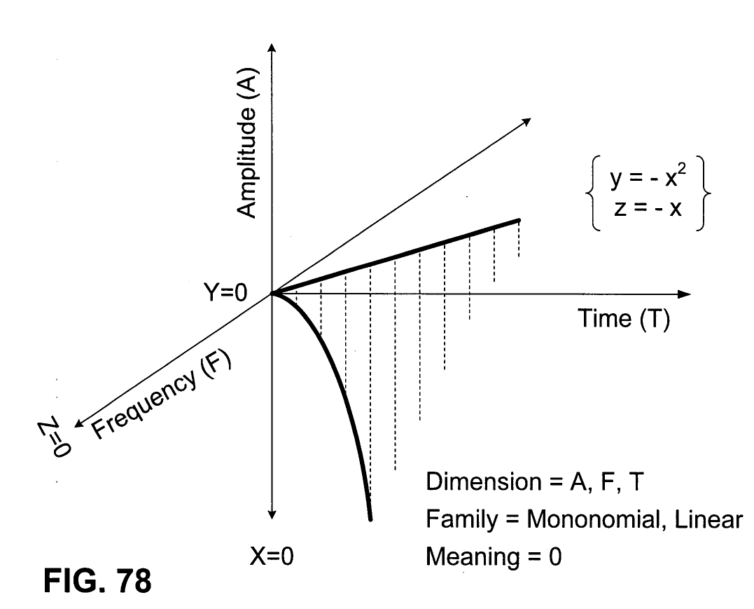

FIGS. 75 through 124 exhibit three dimensional chirp waveforms, which are mapped in amplitude, frequency and time space. FIG. 75 utilizes linear line segments and has a meaning of “one.” FIG. 76 utilizes linear line segments and has a meaning of “zero.” FIG. 77 utilizes linear and mononomial line segments and has a meaning of “one.” FIG. 78 utilizes linear and mononomial line segments and has a meaning of “zero.”

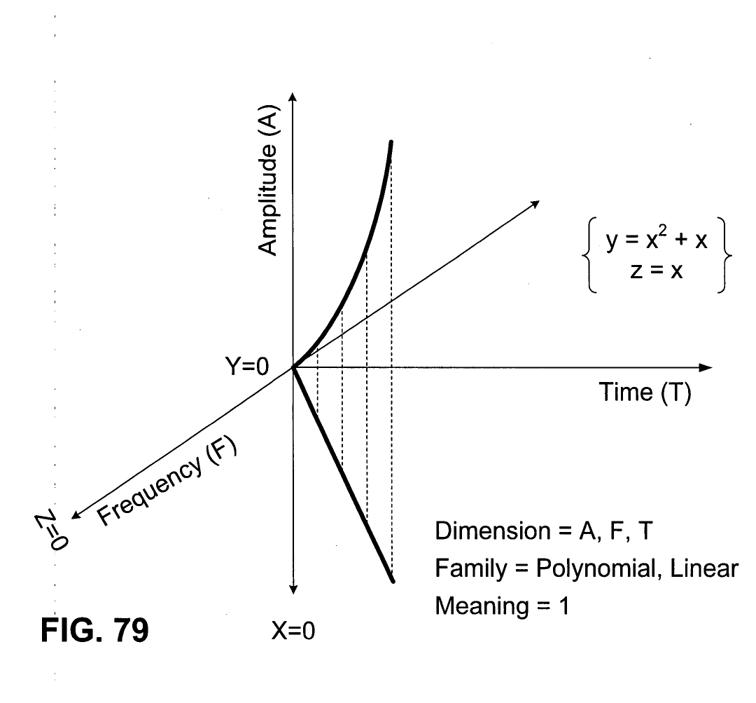

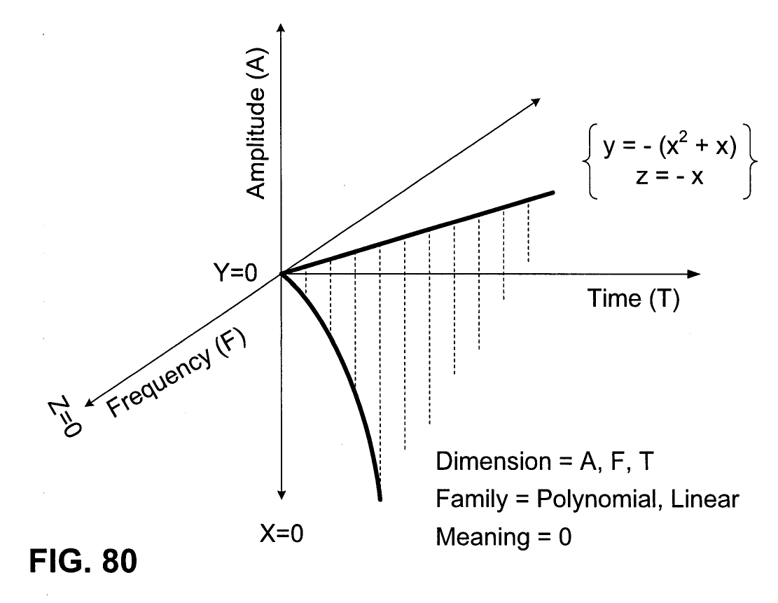

FIGS. 79 and 80 utilize polynomial and linear line segments. FIG. 79 shows a waveform that has a meaning of “one,” while FIG. 80 shows a waveform that has a meaning of “zero.”

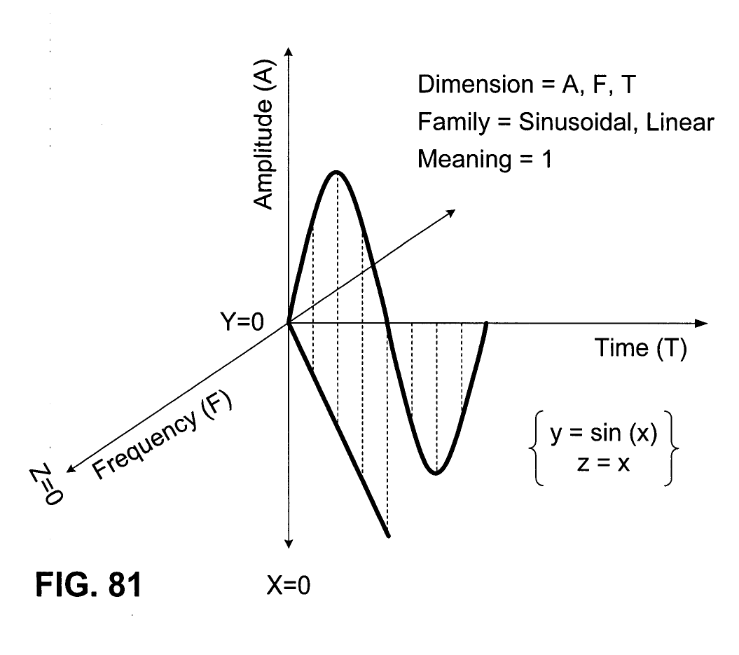

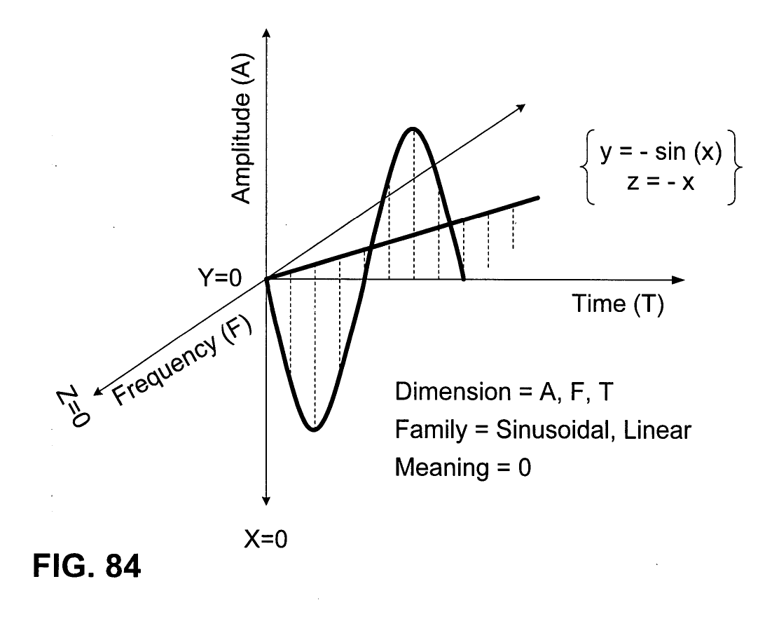

FIGS. 81 and 82 utilize sinusoidal and linear line segments. FIG. 81 shows a waveform that has a meaning of “one,” while FIG. 82 shows a waveform that has a meaning of “zero.”

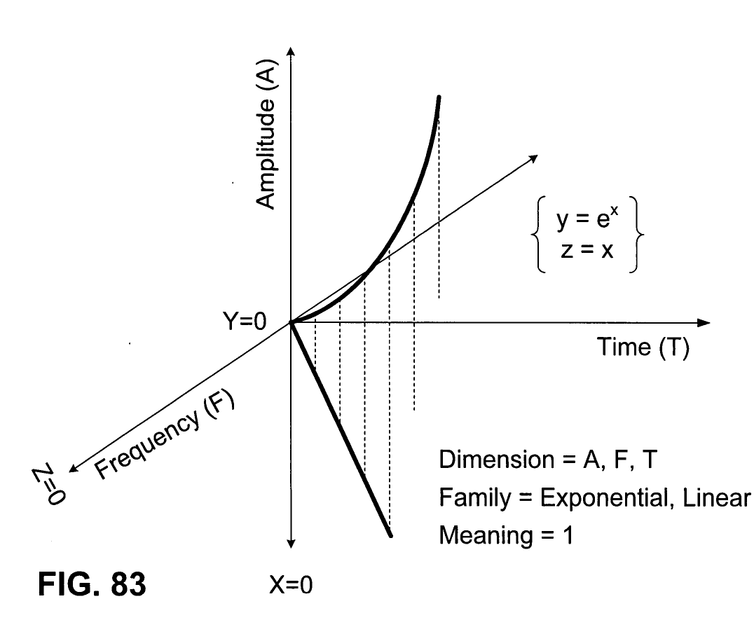

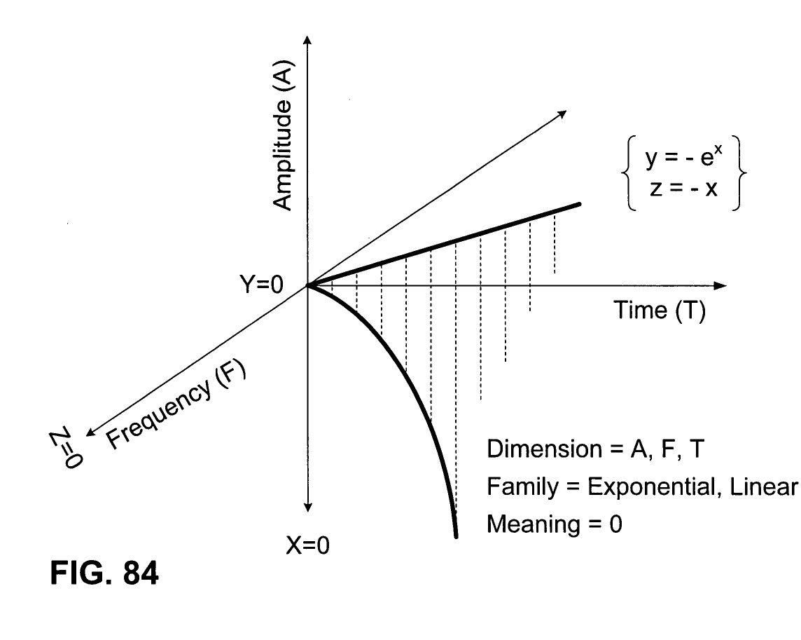

FIGS. 83 and 84 utilize exponential and linear line segments. FIG. 83 shows a waveform that has a meaning of “one,” while FIG. 84 shows a waveform that has a meaning of “zero.”

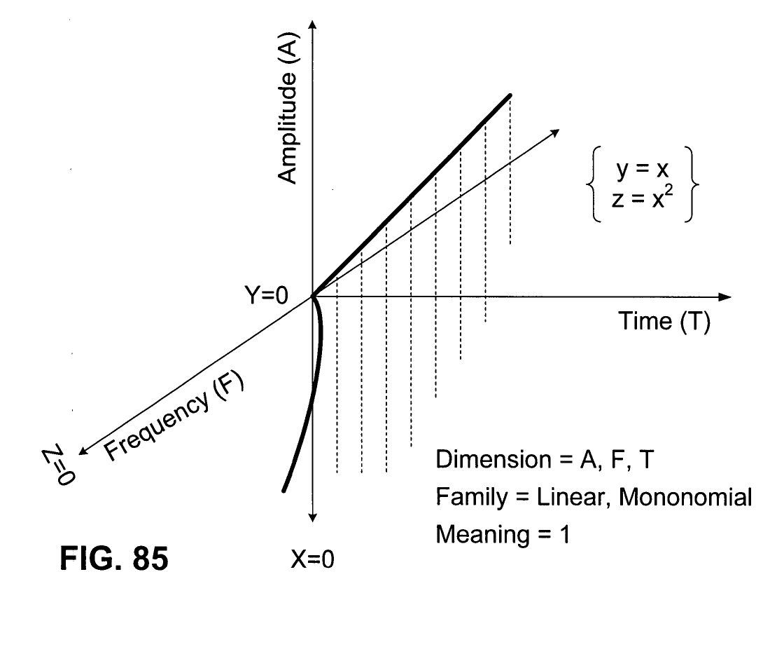

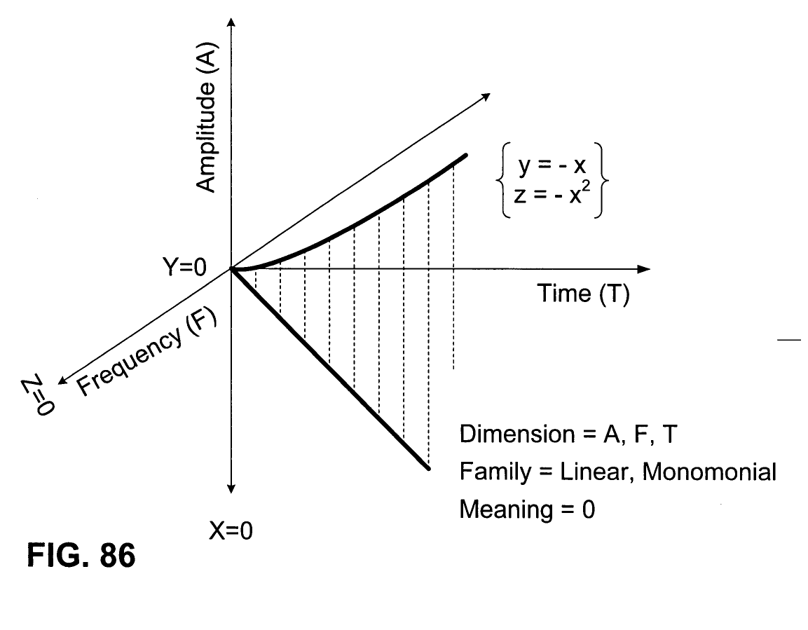

FIGS. 85 and 86 utilize linear and mononomial line segments. FIG. 85 shows a waveform that has a meaning of “one,” while FIG. 86 shows a waveform that has a meaning of “zero.”

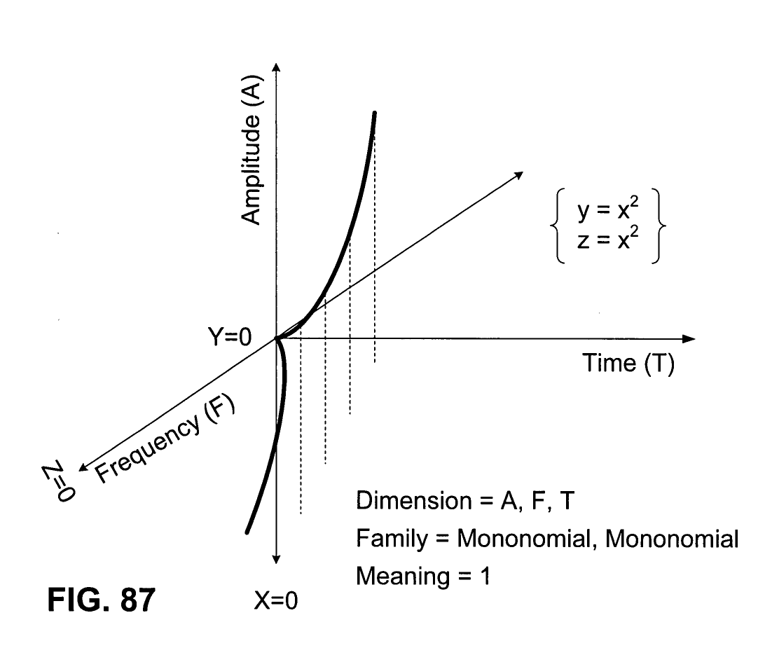

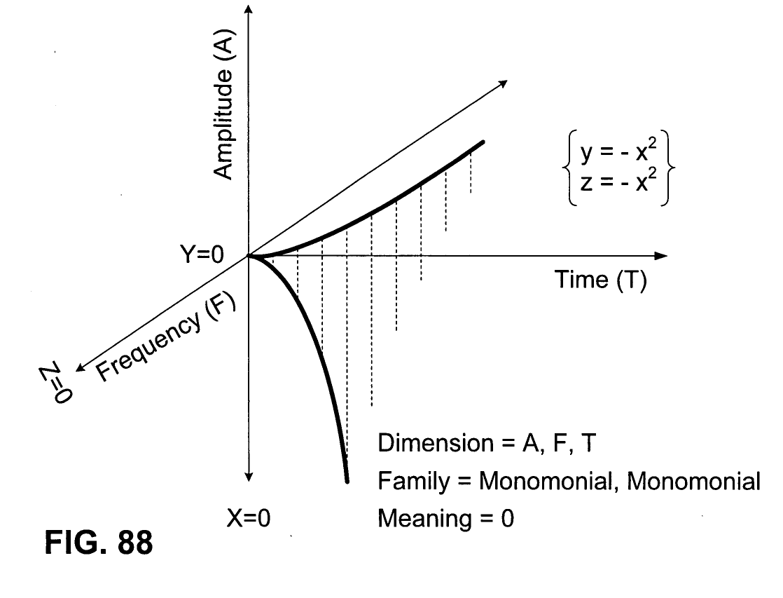

FIGS. 87 and 88 utilize mononomial and mononomial line segments. FIG. 87 shows a waveform that has a meaning of “one,” while FIG. 88 shows a waveform that has a meaning of “zero.”

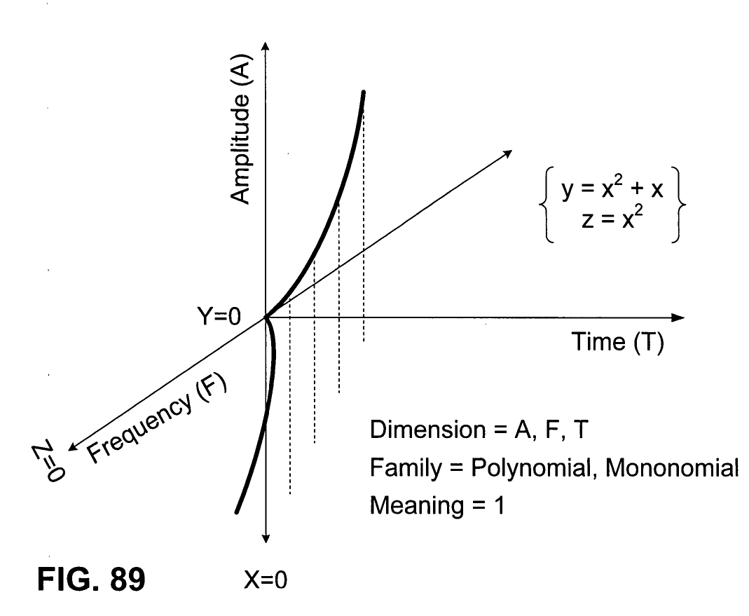

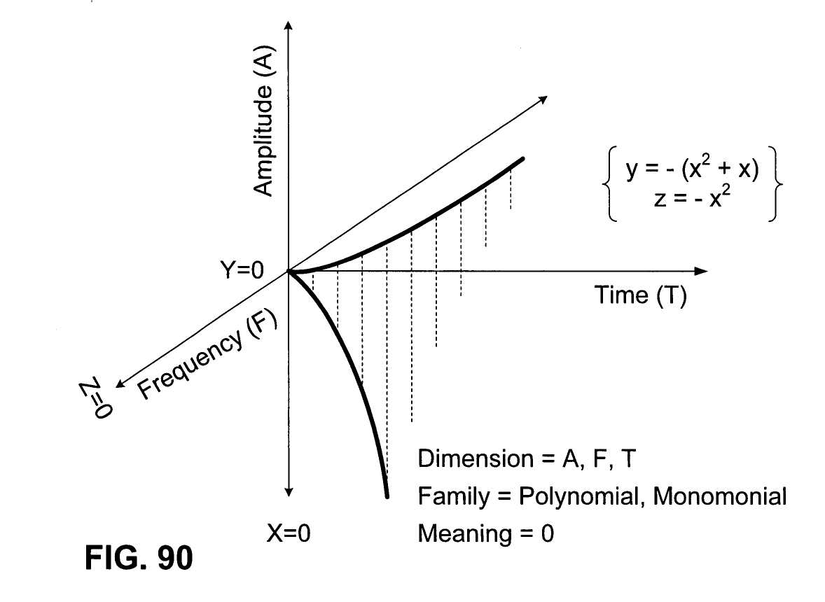

FIGS. 89 and 90 utilize polynomial and mononomial line segments. FIG. 89 shows a waveform that has a meaning of “one,” while FIG. 90 shows a waveform that has a meaning of “zero.”

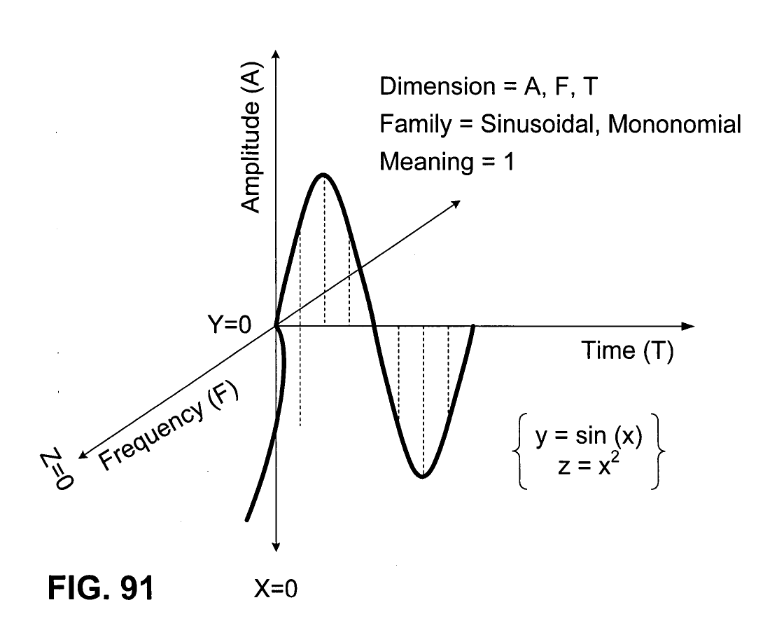

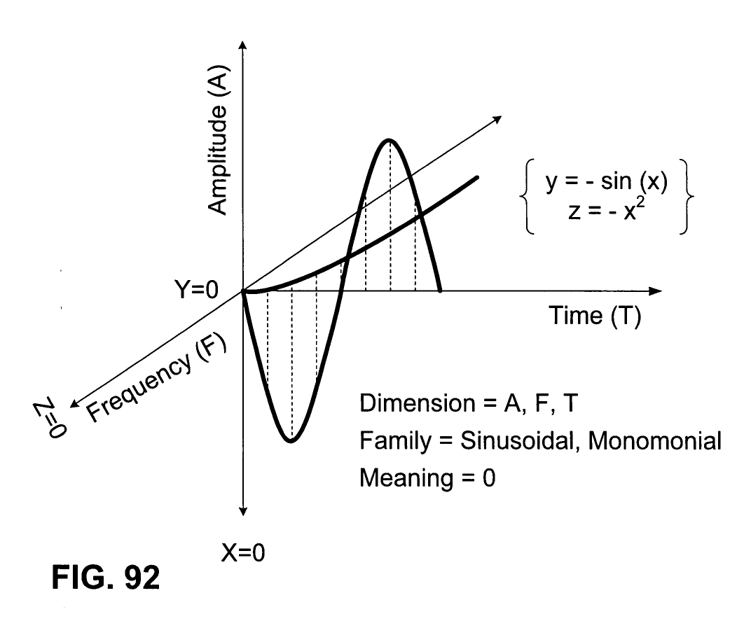

FIGS. 91 and 92 utilize sinusoidal and mononomial line segments. FIG. 91 shows a waveform that has a meaning of “one,” while FIG. 92 shows a waveform that has a meaning of “zero.”

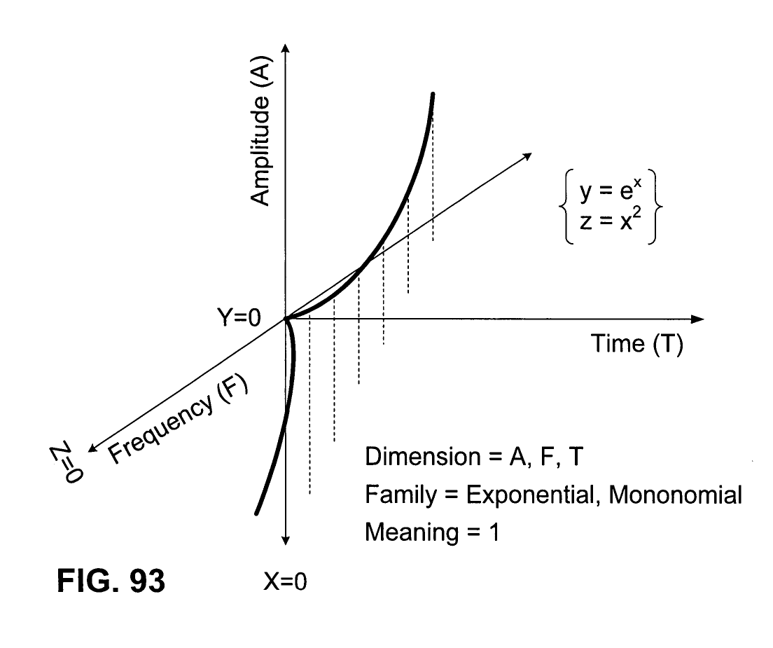

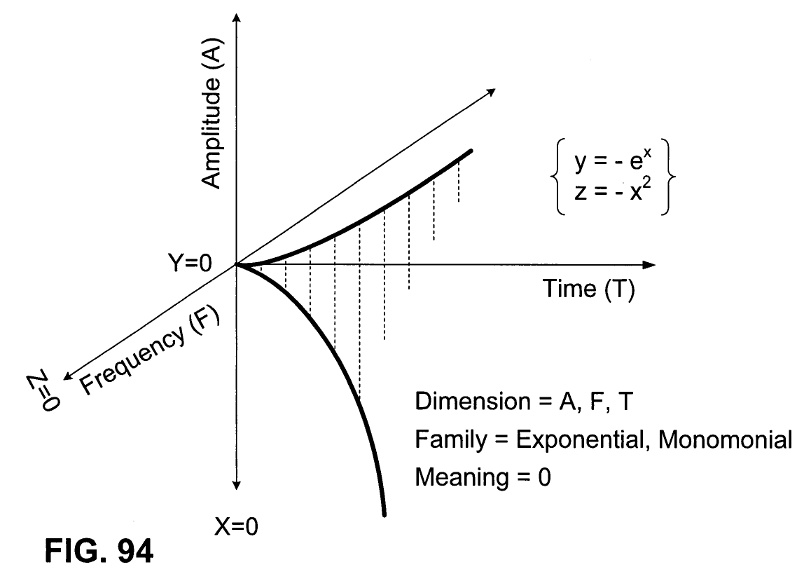

FIGS. 93 and 94 utilize exponential and mononomial line segments. FIG. 93 shows a waveform that has a meaning of “one,” while FIG. 94 shows a waveform that has a meaning of “zero.”

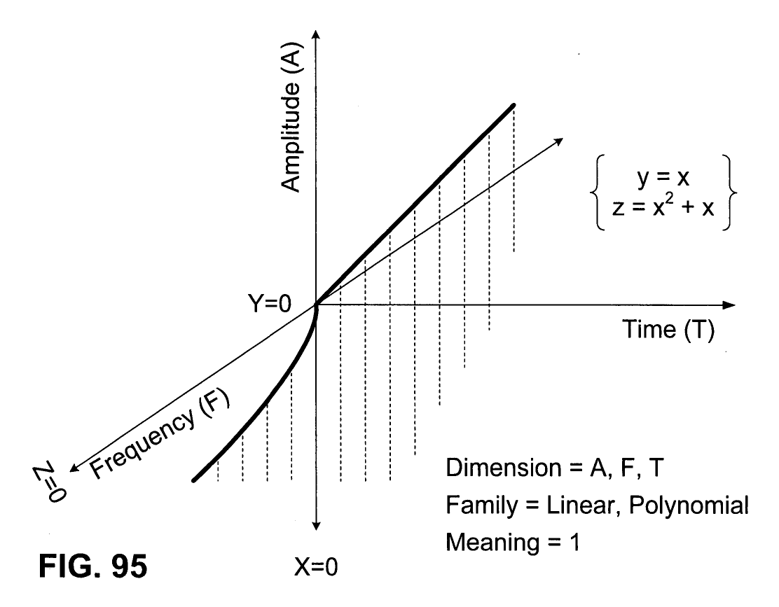

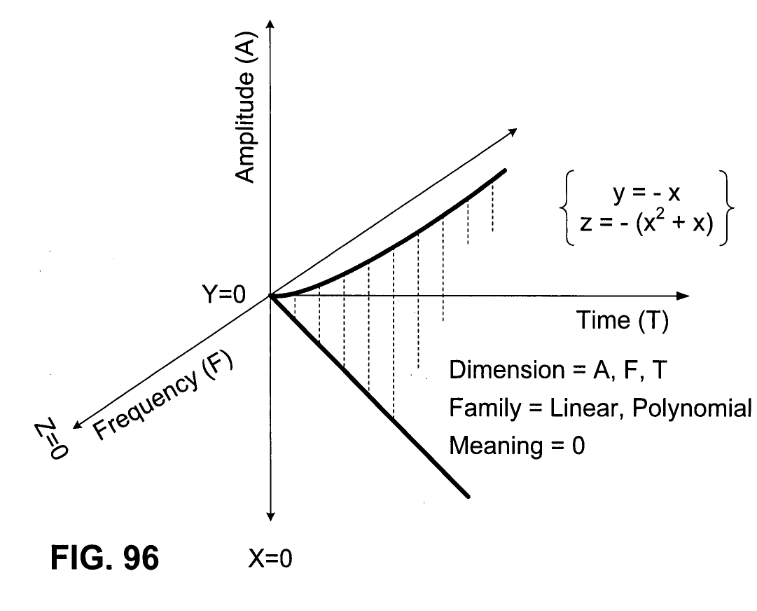

FIGS. 95 and 96 utilize linear and polynomial line segments. FIG. 95 shows a waveform that has a meaning of “one,” while FIG. 96 shows a waveform that has a meaning of “zero.”

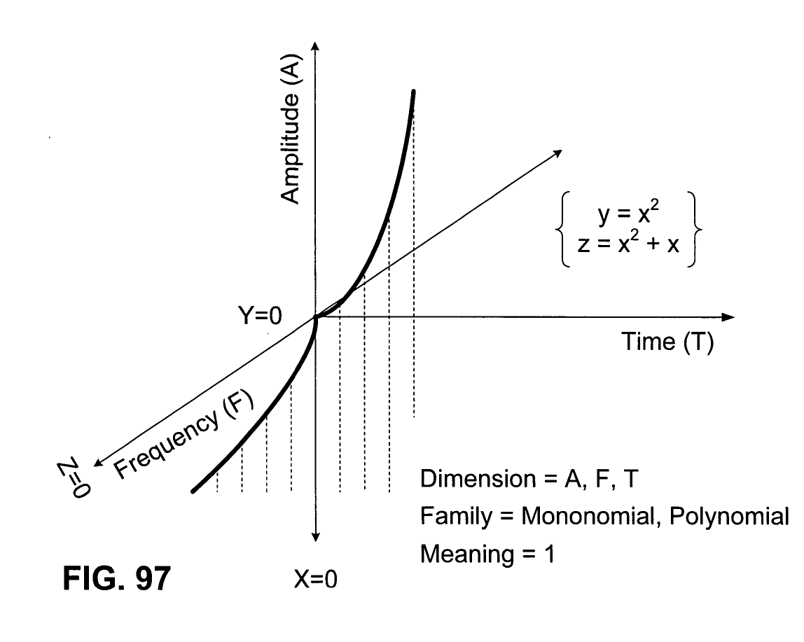

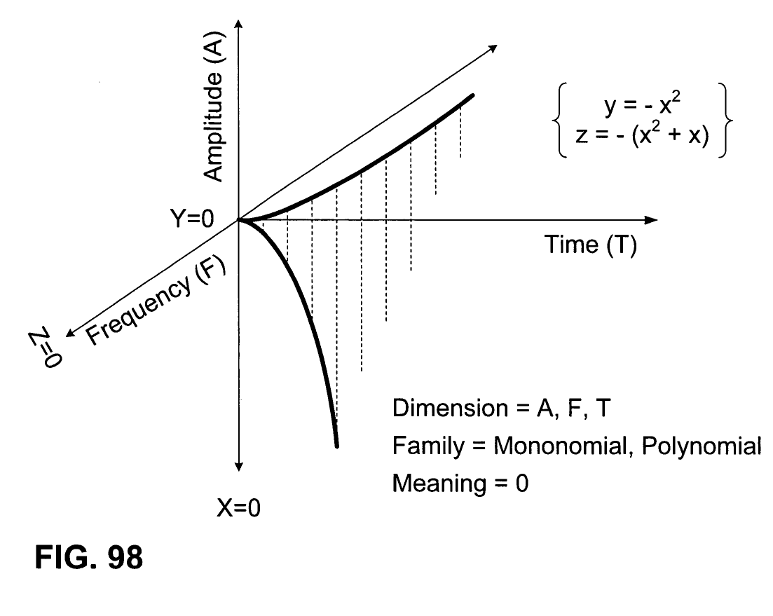

FIGS. 97 and 98 utilize mononomial and polynomial line segments. FIG. 97 shows a waveform that has a meaning of “one,” while FIG. 98 shows a waveform that has a meaning of “zero.”

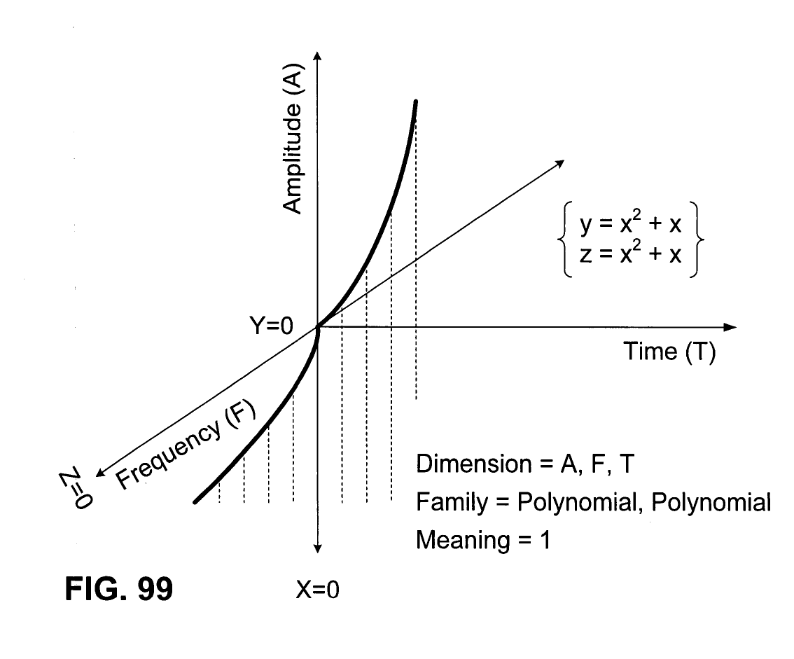

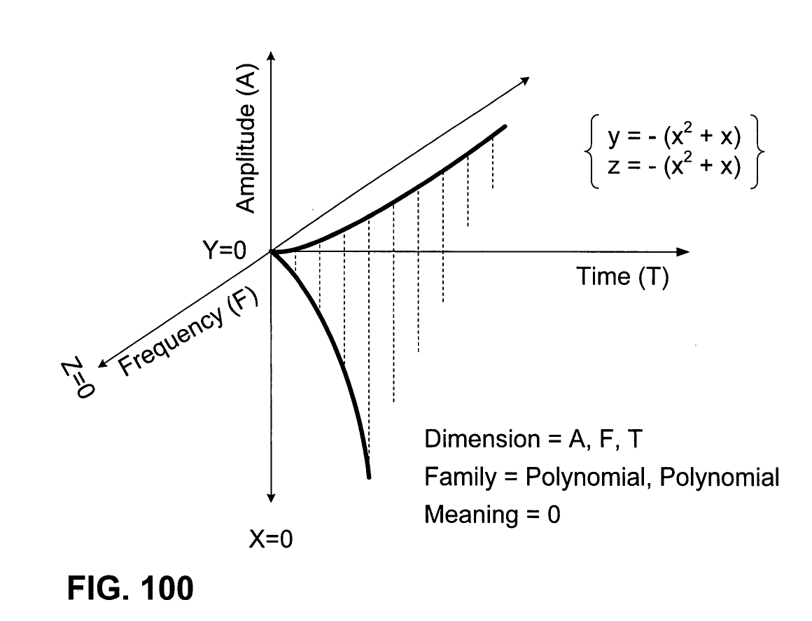

FIGS. 99 and 100 utilize polynomial and polynomial line segments. FIG. 97 shows a waveform that has a meaning of “one,” while FIG. 98 shows a waveform that has a meaning of “zero.”

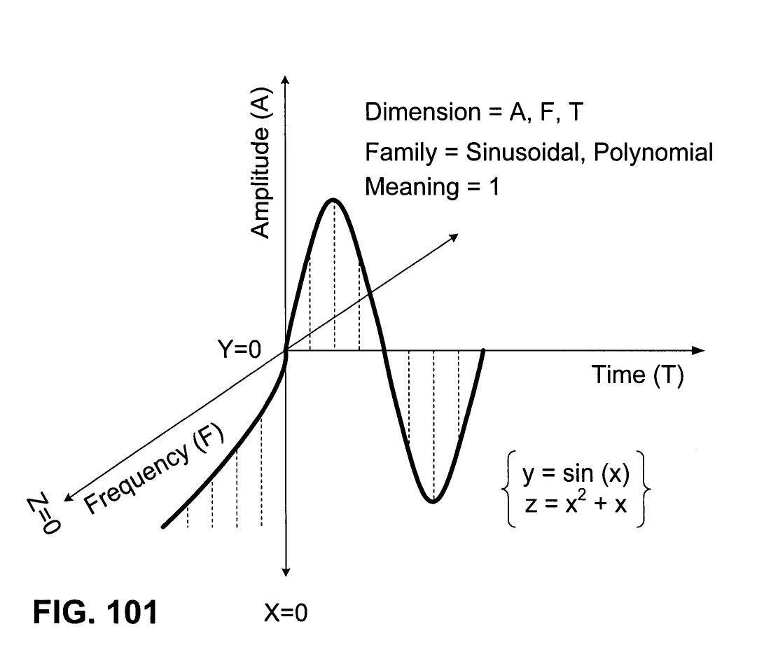

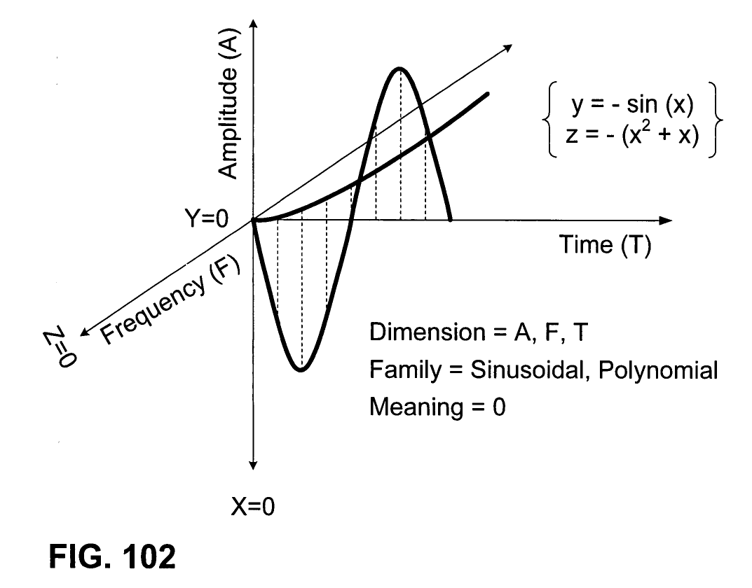

FIGS. 101 and 102 utilize sinusoidal and polynomial line segments. FIG. 101 shows a waveform that has a meaning of “one,” while FIG. 102 shows a waveform that has a meaning of “zero.”

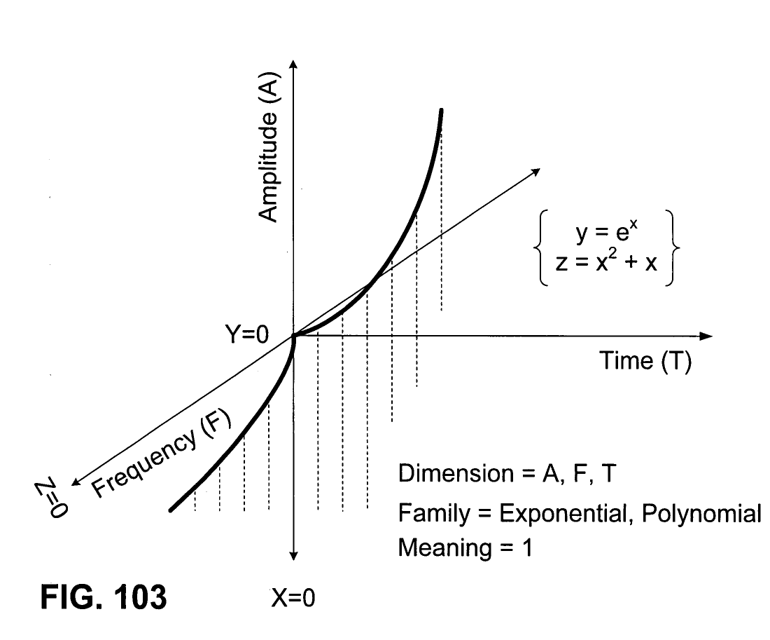

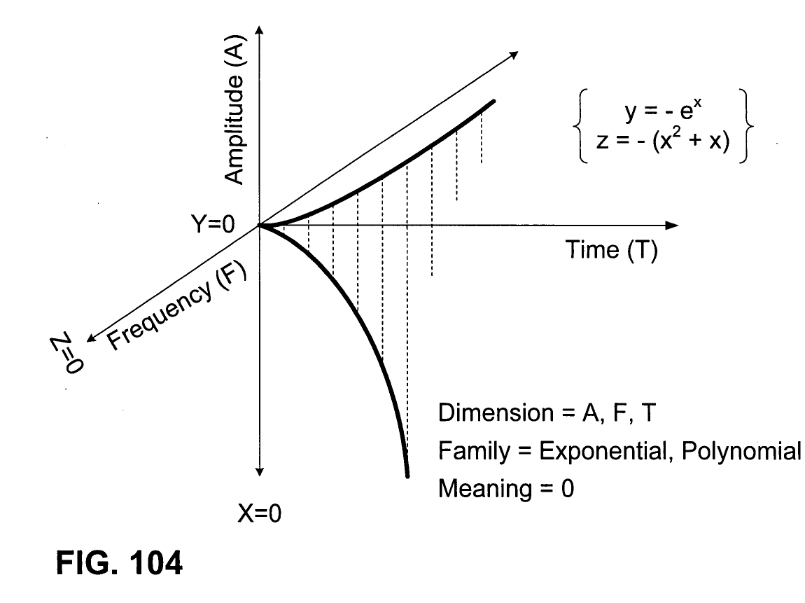

FIGS. 103 and 104 utilize exponential and polynomial line segments. FIG. 103 shows a waveform that has a meaning of “one,” while FIG. 104 shows a waveform that has a meaning of “zero.”

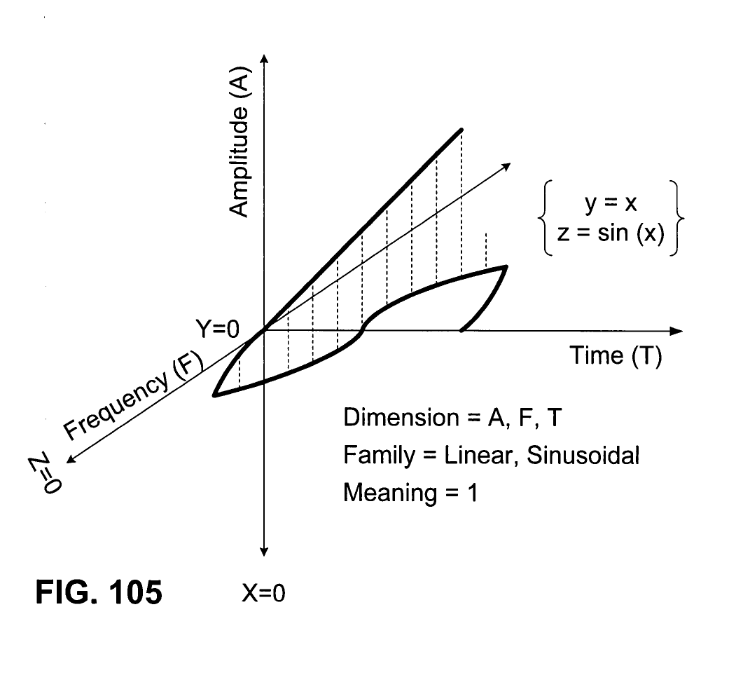

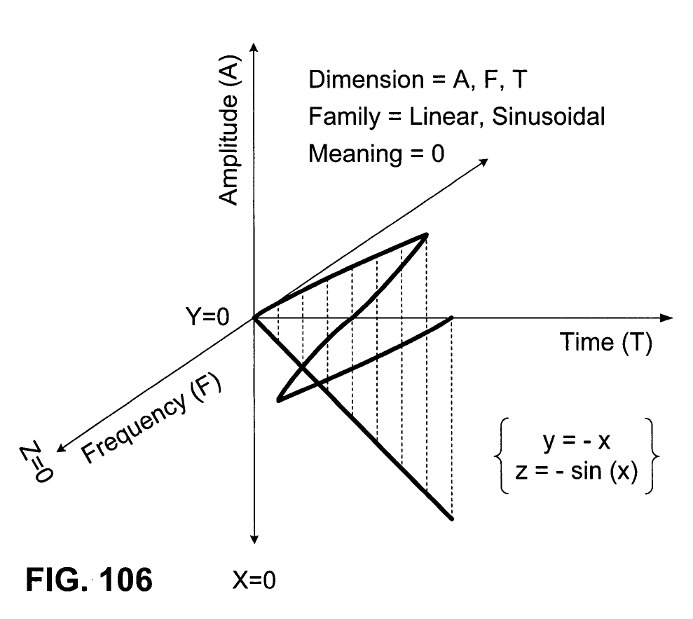

FIGS. 105 and 106 utilize linear and sinusoidal line segments. FIG. 105 shows a waveform that has a meaning of “one,” while FIG. 106 shows a waveform that has a meaning of “zero.”

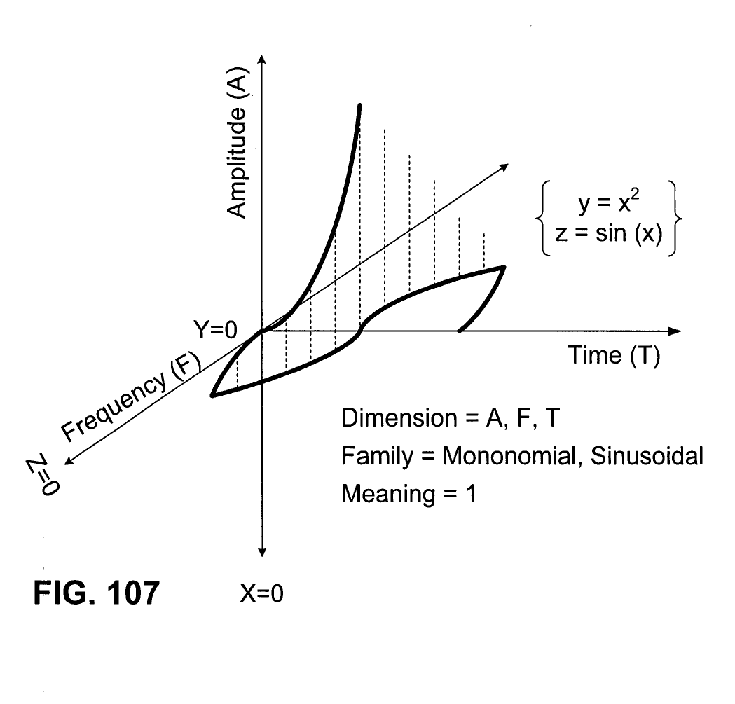

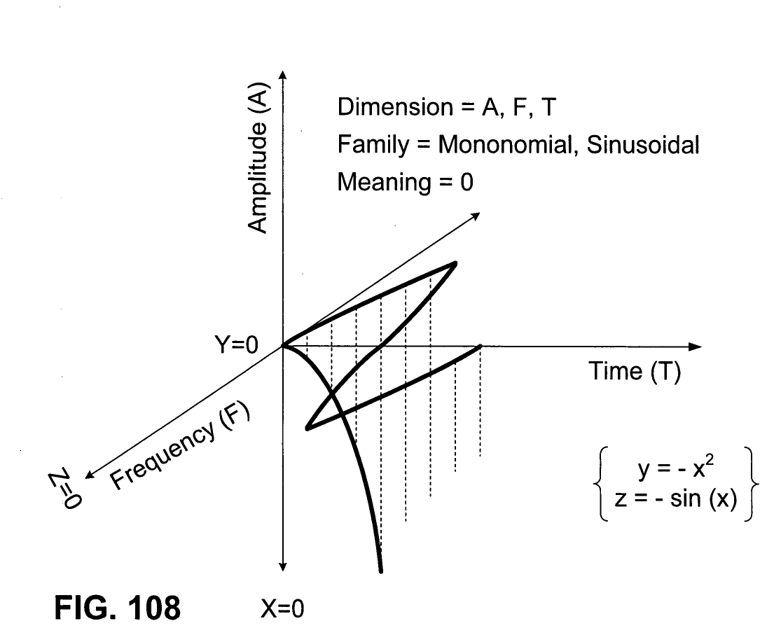

FIGS. 107 and 108 utilize mononomial and sinusoidal line segments. FIG. 107 shows a waveform that has a meaning of “one,” while FIG. 108 shows a waveform that has a meaning of “zero.”

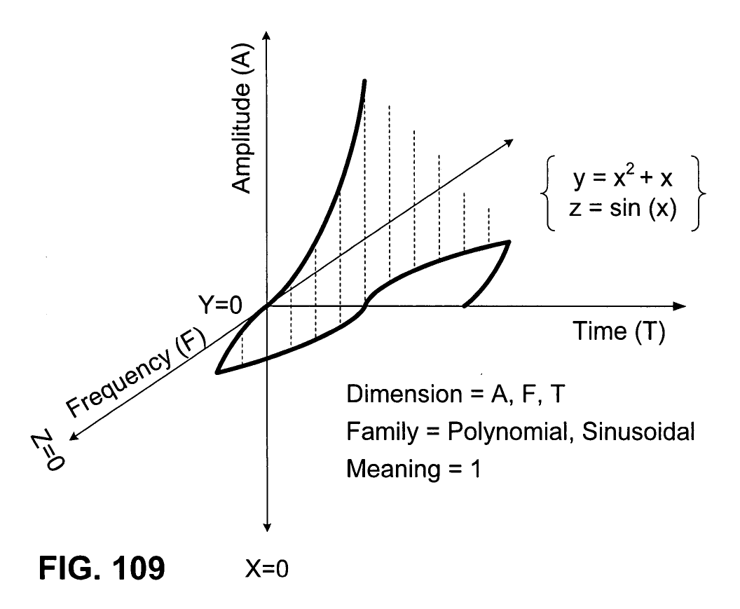

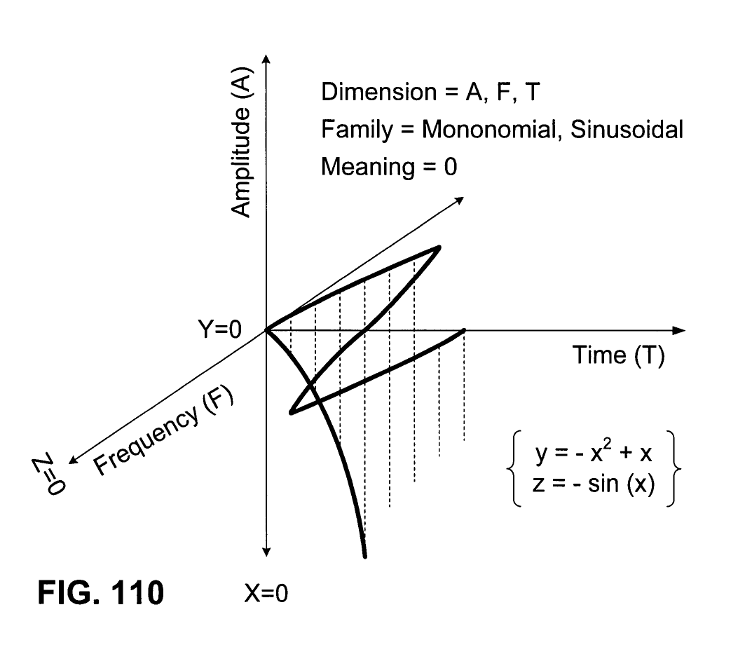

FIGS. 109 and 110 utilize polynomial and sinusoidal line segments. FIG. 109 shows a waveform that has a meaning of “one,” while FIG. 110 shows a waveform that has a meaning of “zero.”

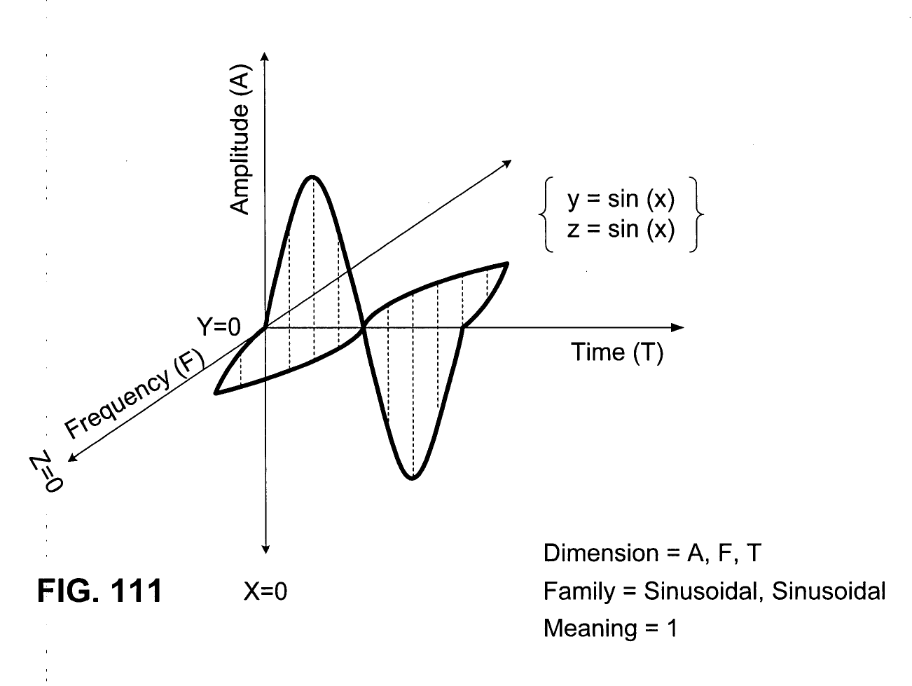

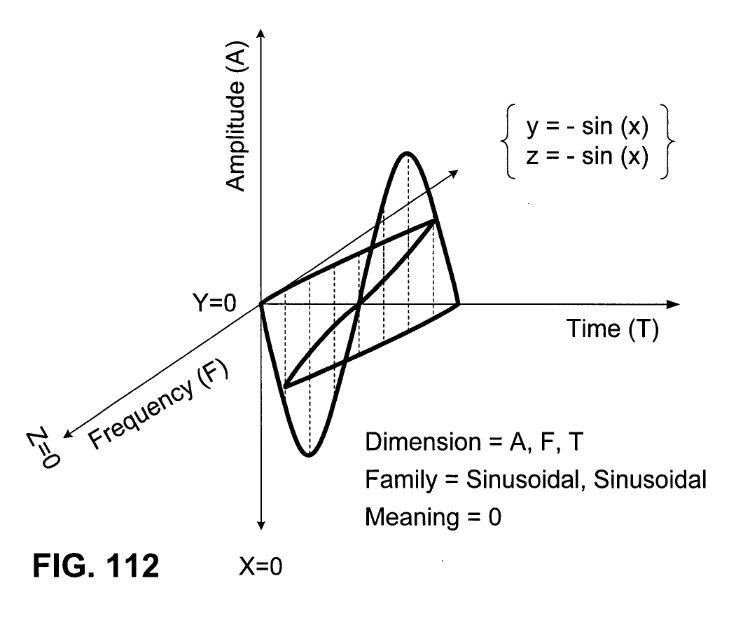

FIGS. 111 and 112 utilize sinusoidal and sinusoidal line segments. FIG. 111 shows a waveform that has a meaning of “one,” while FIG. 112 shows a waveform that has a meaning of “zero.”

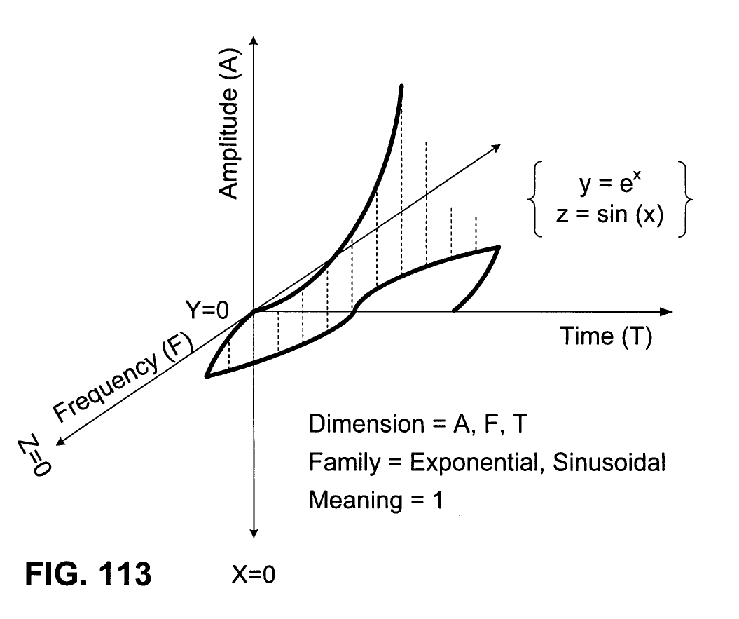

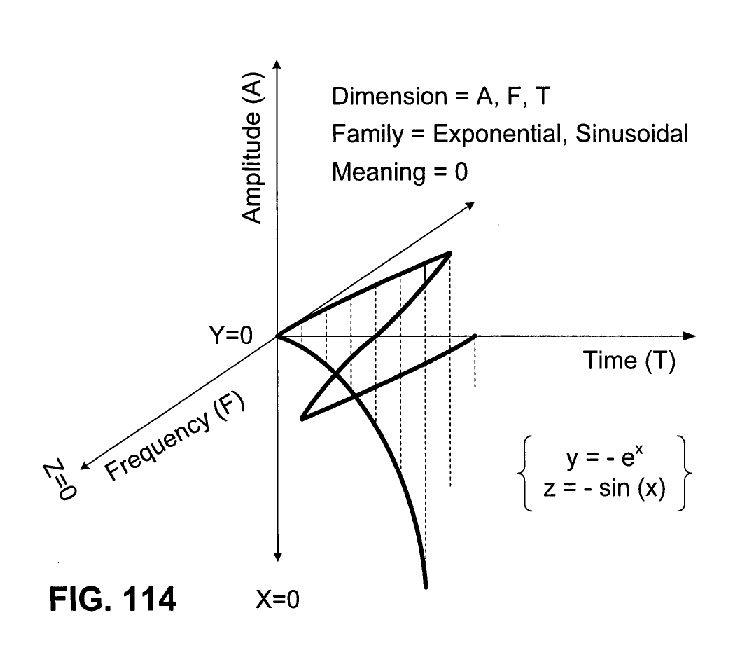

FIGS. 113 and 114 utilize exponential and sinusoidal line segments. FIG. 113 shows a waveform that has a meaning of “one,” while FIG. 114 shows a waveform that has a meaning of “zero.”

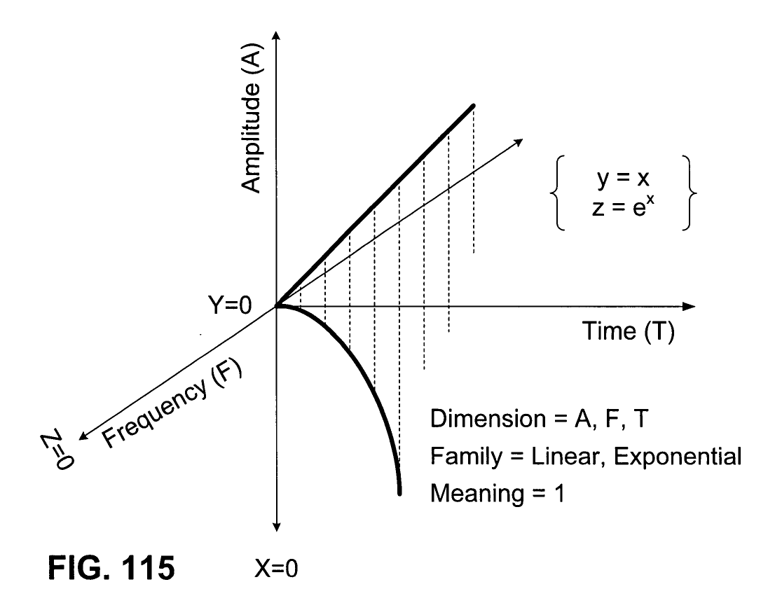

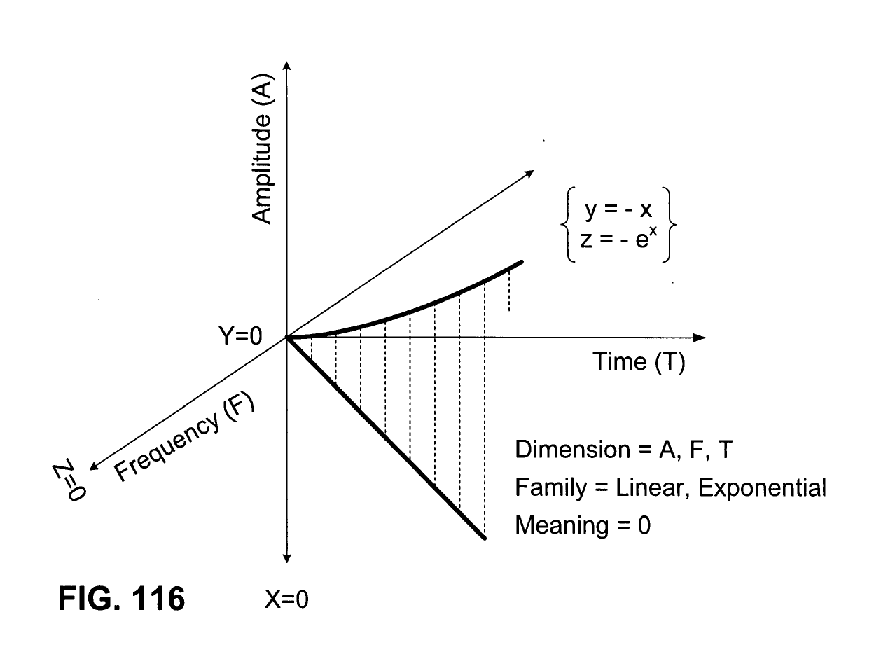

FIGS. 115 and 116 utilize linear and exponential line segments. FIG. 115 shows a waveform that has a meaning of “one,” while FIG. 116 shows a waveform that has a meaning of “zero.”

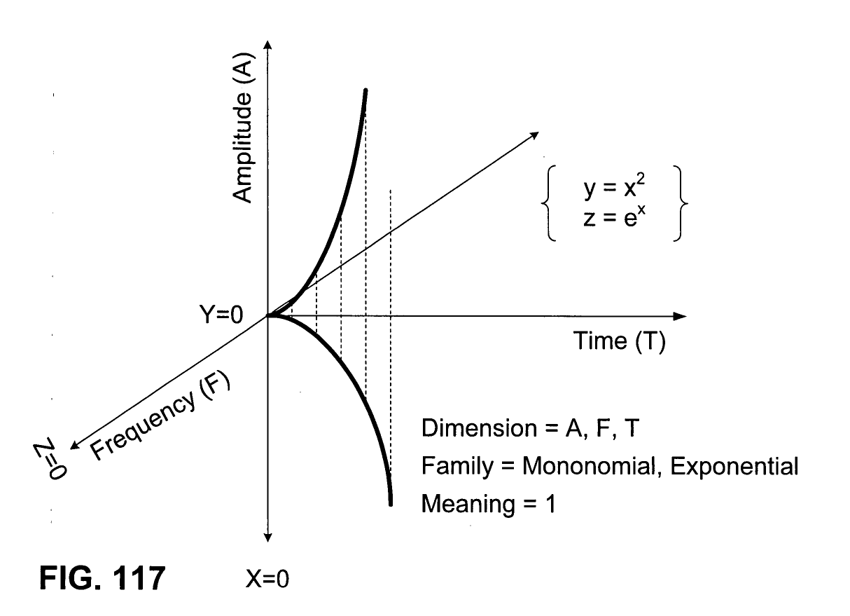

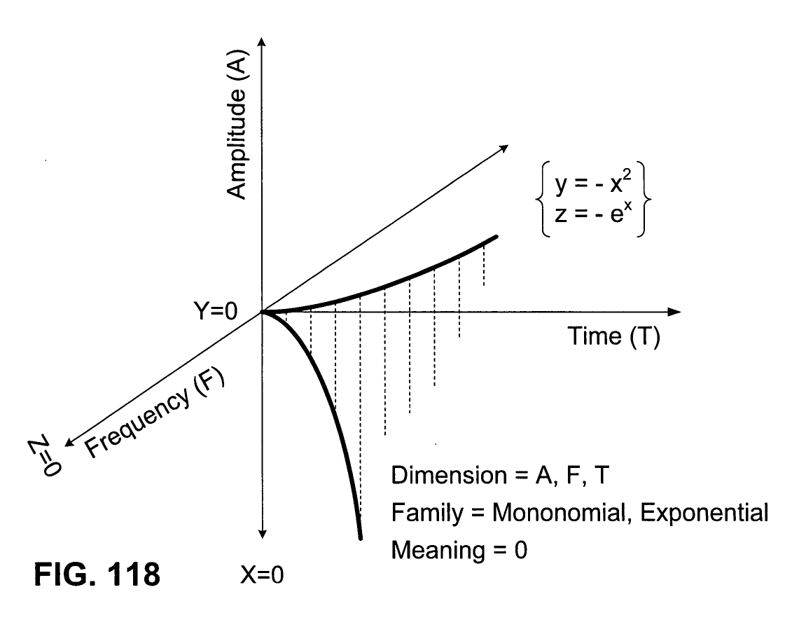

FIGS. 117 and 118 utilize mononomial and exponential line segments. FIG. 117 shows a waveform that has a meaning of “one,” while FIG. 118 shows a waveform that has a meaning of “zero.”

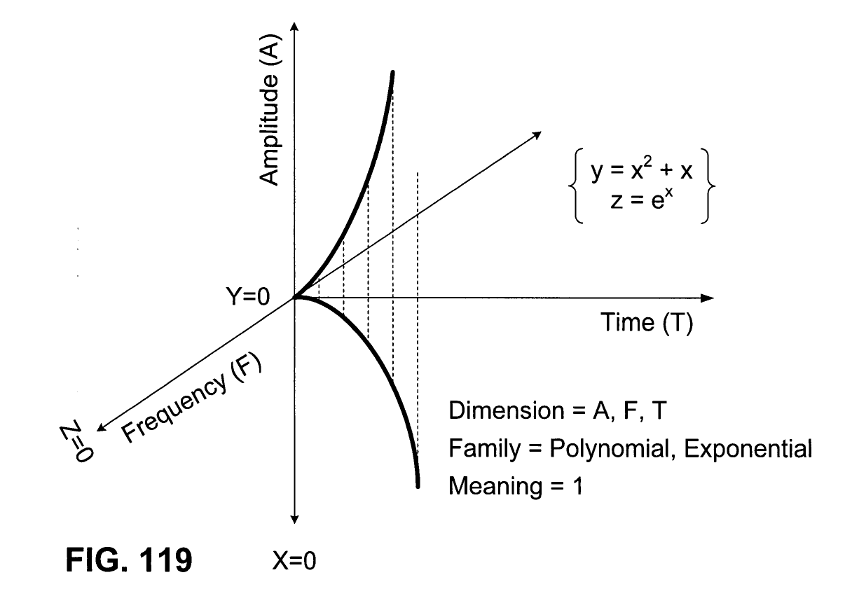

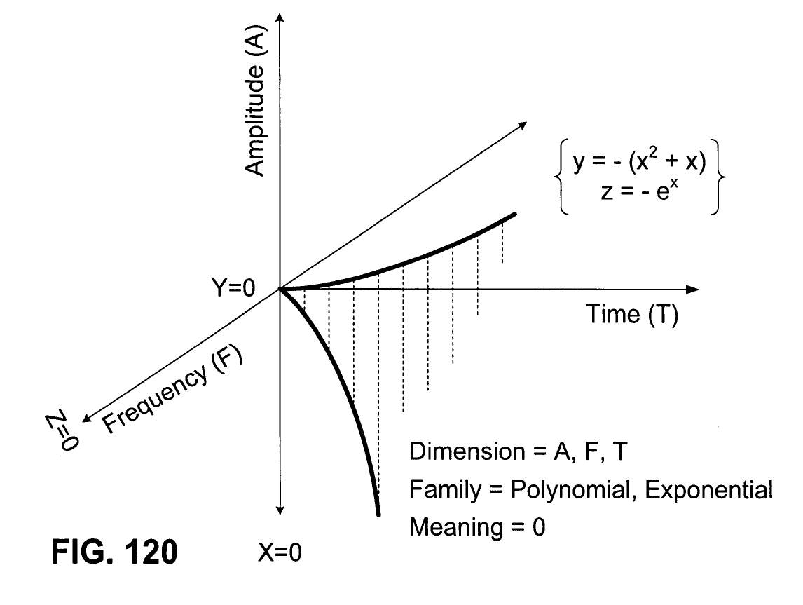

FIGS. 119 and 120 utilize polynomial and exponential line segments. FIG. 119 shows a waveform that has a meaning of “one,” while FIG. 120 shows a waveform that has a meaning of “zero.”

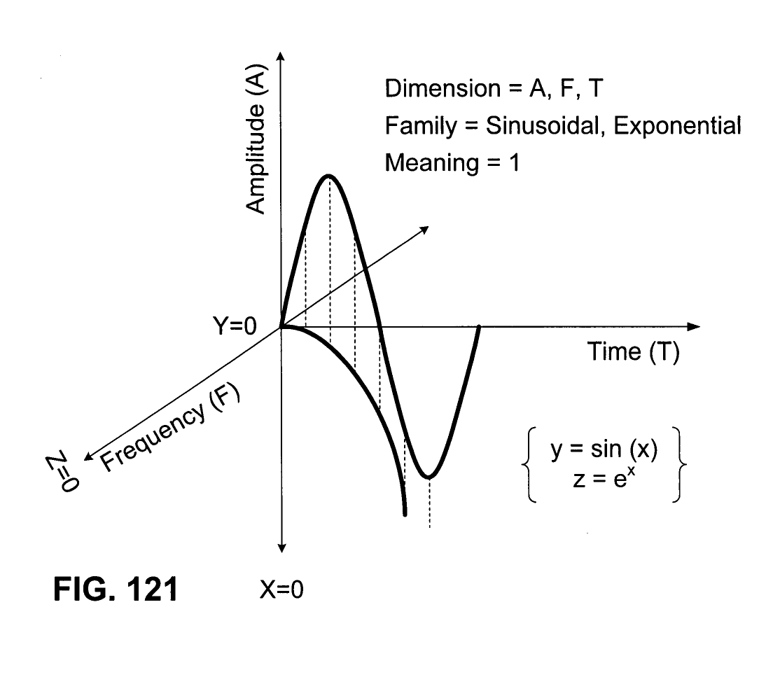

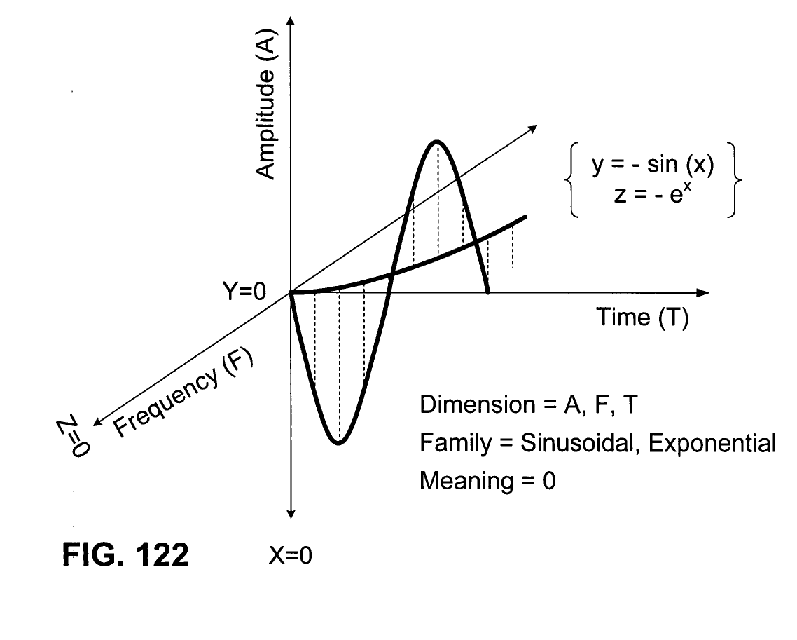

FIGS. 121 and 122 utilize sinusoidal and exponential line segments. FIG. 121 shows a waveform that has a meaning of “one,” while FIG. 122 shows a waveform that has a meaning of “zero.”

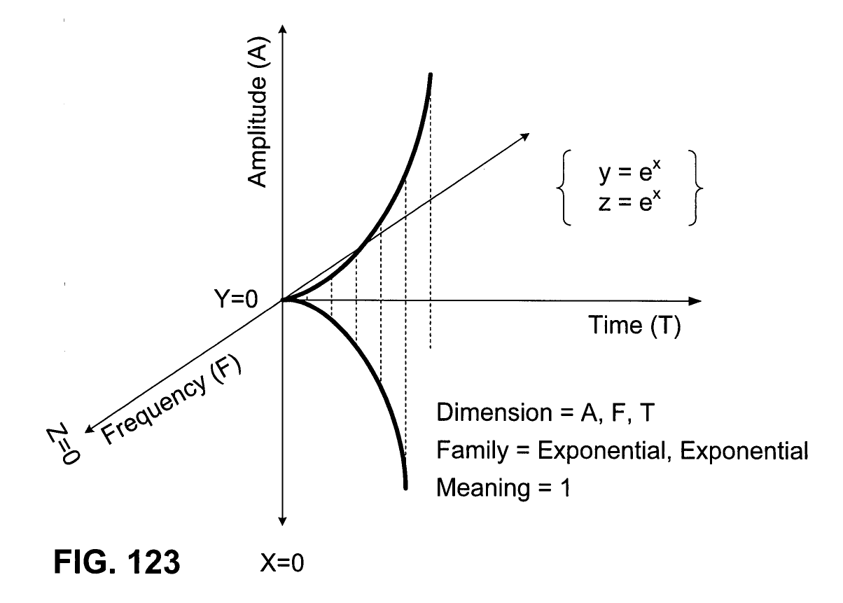

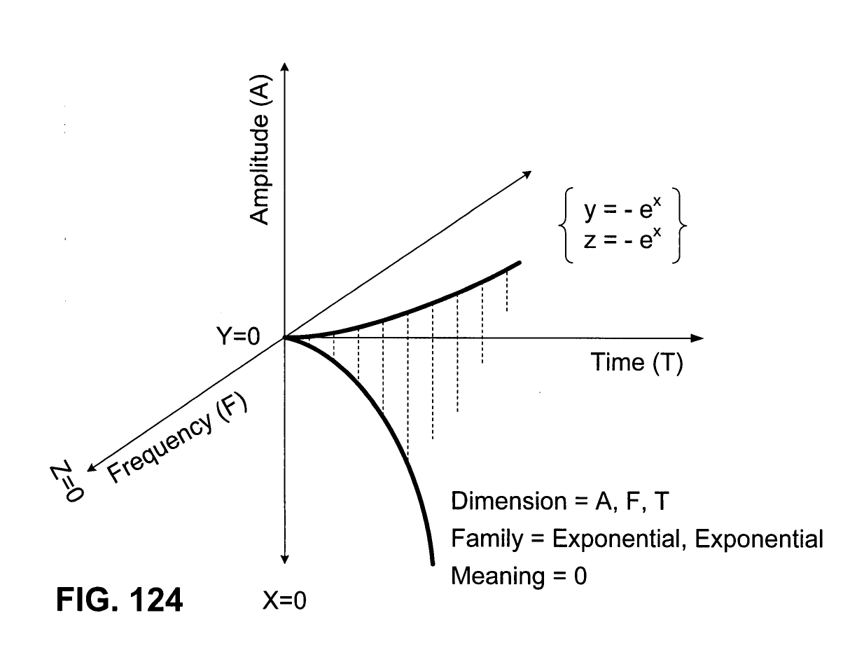

FIGS. 123 and 124 utilize exponential and exponential line segments. FIG. 123 shows a waveform that has a meaning of “one,” while FIG. 124 shows a waveform that has a meaning of “zero.”

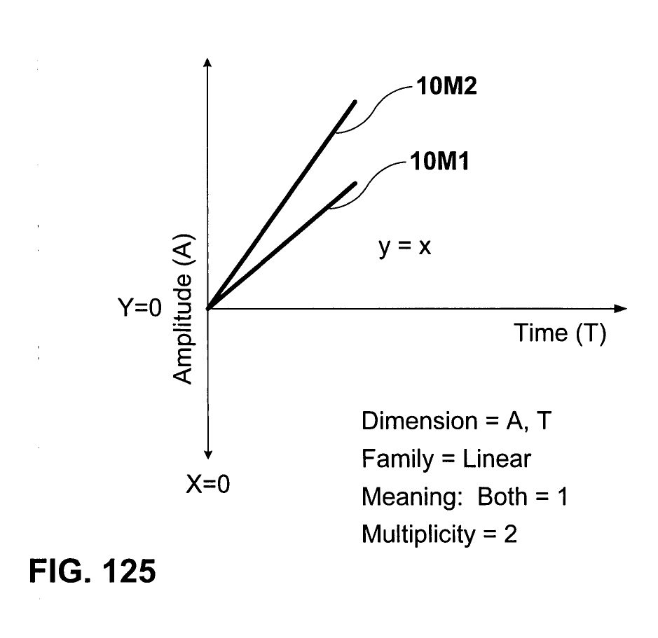

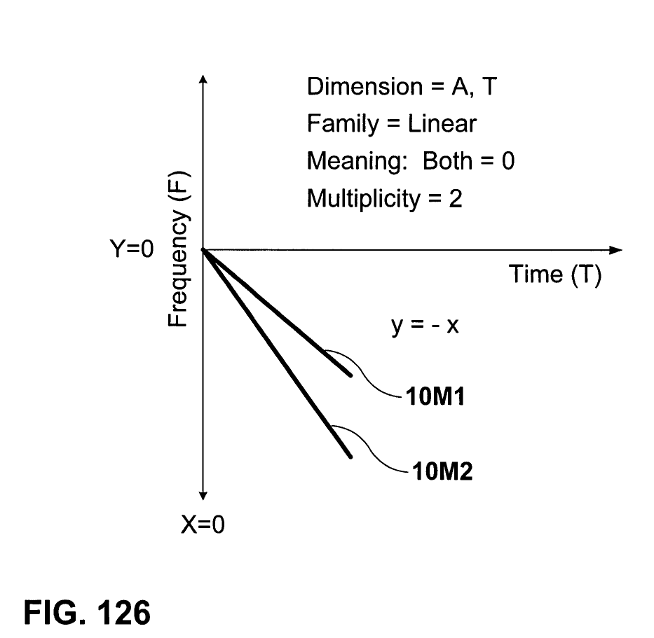

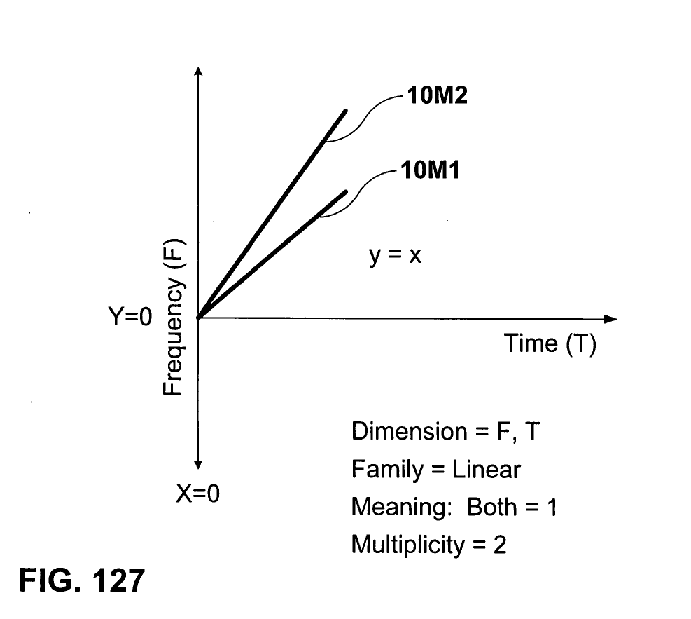

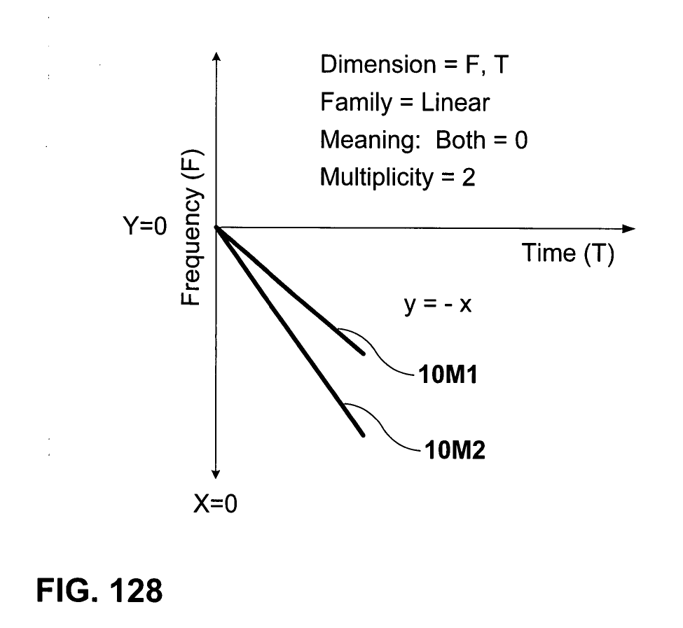

FIGS. 125 and 126 show multiple line segments 10M1 and 10M2 mapped in amplitude versus time space. Both line segments originate at or generally near the origin. The invention may utilize a plurality of multiple simultaneous line segments which are propagated over the same time interval. FIG. 125 shows two waveforms that both have a meaning of “one,” while FIG. 126 shows two waveforms that both have a meaning of “zero.”

FIGS. 127 and 128 show multiple line segments mapped 10M1 and 10M2 in frequency versus time space. FIG. 127 shows two waveforms that both have a meaning of “one,” while FIG. 128 shows two waveforms that both have a meaning of “zero.”

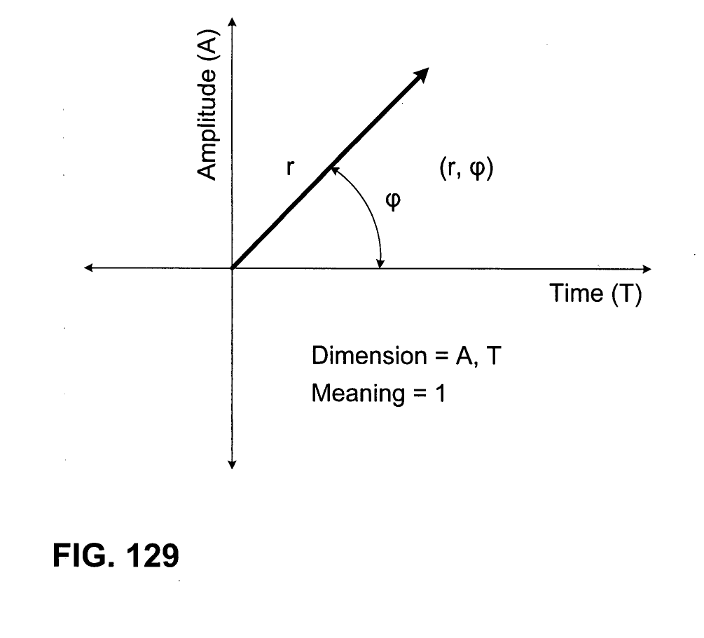

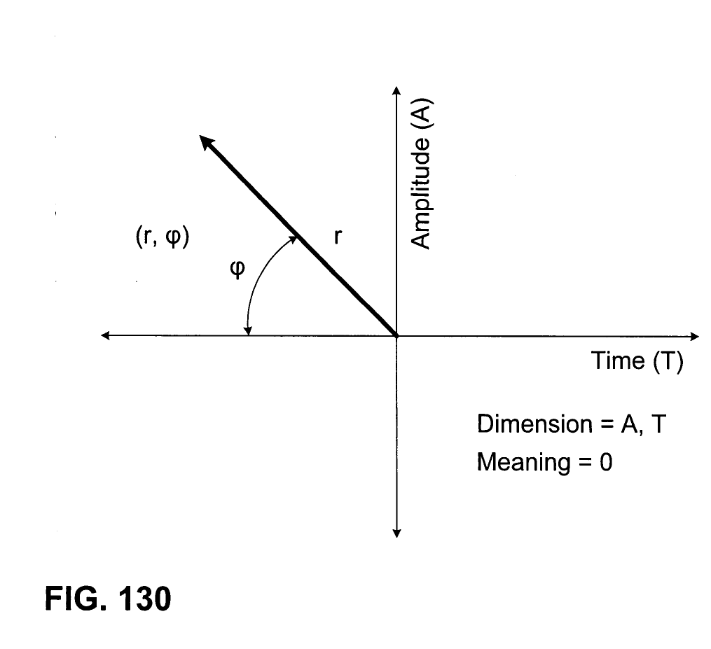

FIGS. 129 and 130 show “stacked” line segments 10S1 and 10S2 mapped in amplitude versus time space. The stacked line segments are generally propagated during the same time interval, but do not all originate at the origin. The invention may utilize a plurality of stacked line segments that are propagated during generally the same time interval. FIG. 129 shows two waveforms that both have a meaning of “one,” while FIG. 130 shows two waveforms that both have a meaning of “zero.”

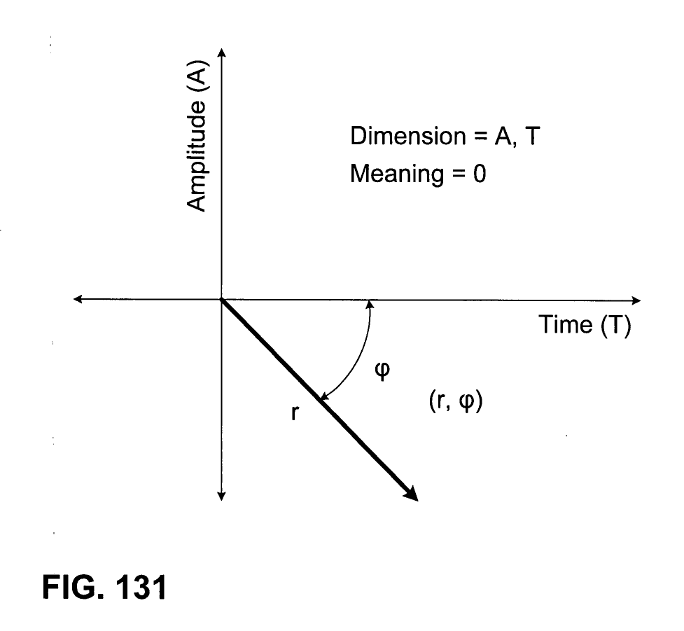

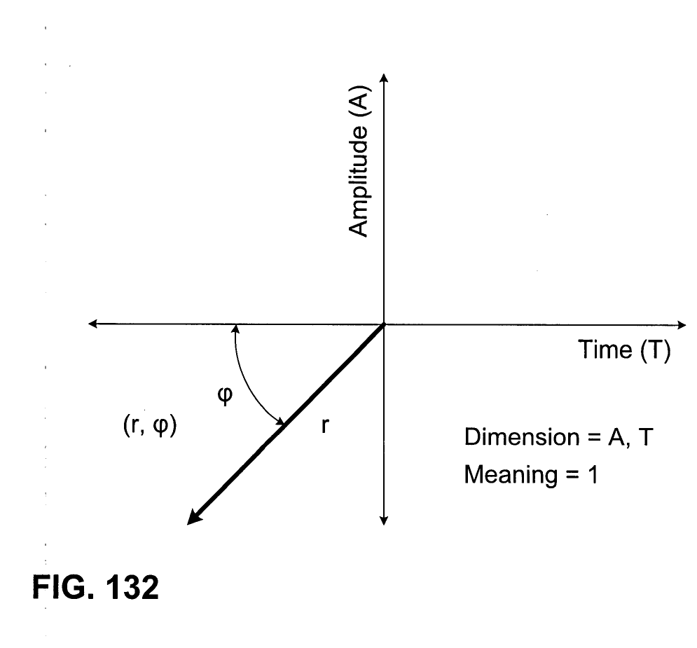

FIGS. 131 and 132 show stacked line segments 10S1 and 10S2 mapped in frequency versus time space. FIG. 131 shows two waveforms that both have a meaning of “one,” while FIG. 132 shows two waveforms that both have a meaning of “zero.”

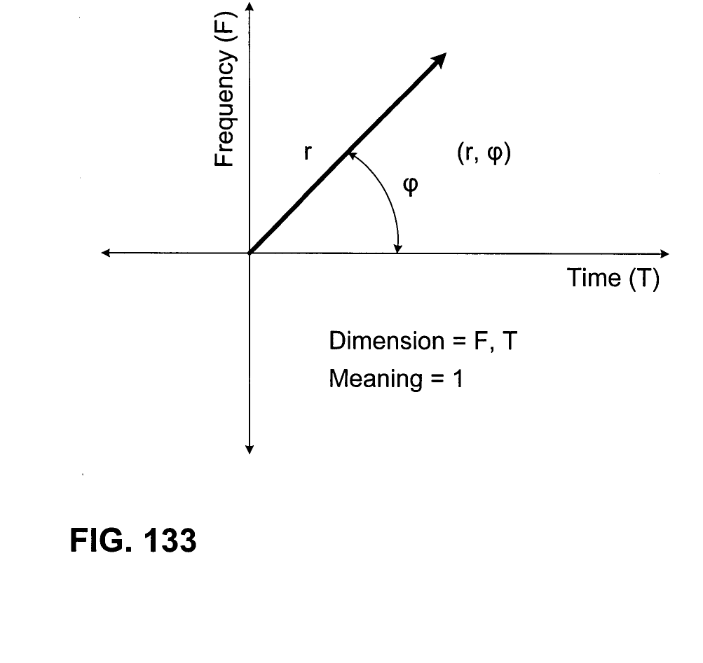

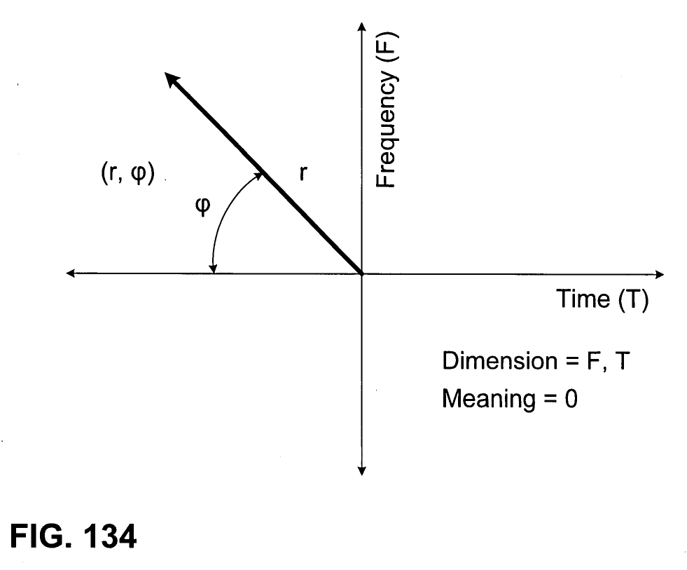

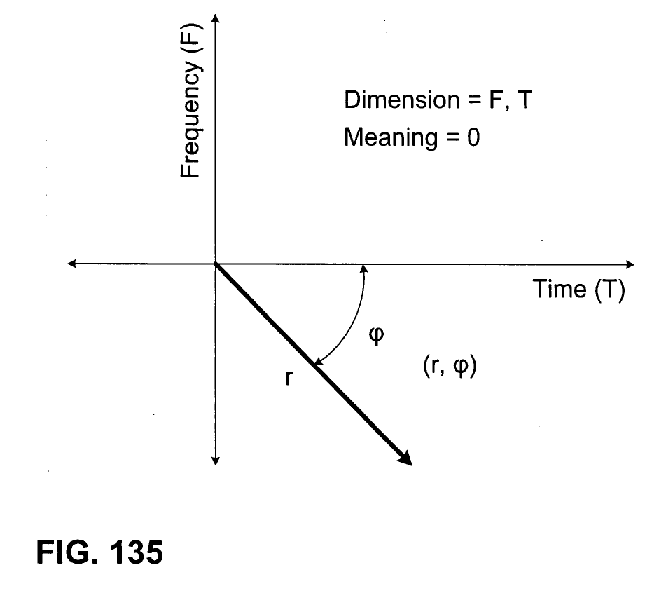

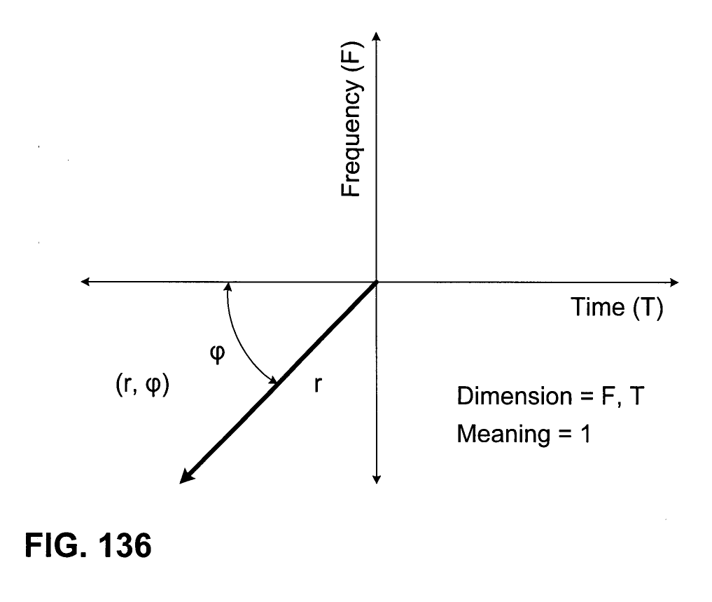

FIGS. 133 through 136 show a chirp waveform vector mapped in polar coordinate space (r,φ). FIGS. 133 and 136 show a chirp waveform vector having the meaning of “one,” while FIGS. 134 and 135 show vectors having the meaning of “zero.”

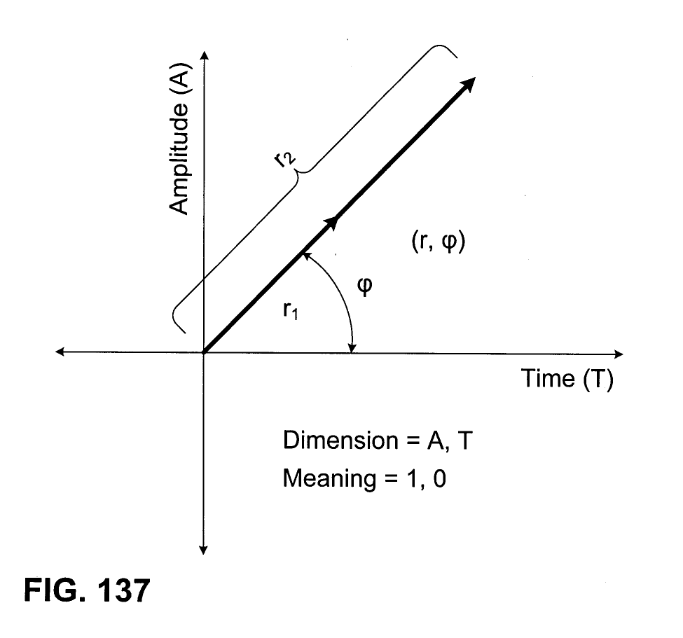

FIG. 137 shows two chirp waveform vectors mapped in polar coordinate space (r,φ) having the same φ but with r₁ having the meaning of “one” and r₂ having the meaning of “zero.”

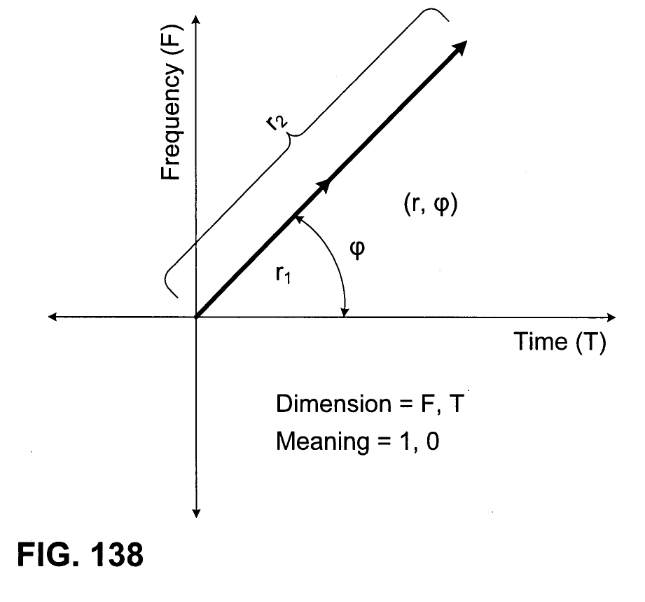

FIG. 138 shows two chirp waveform vectors mapped in polar coordinate space (r,φ) having the same r but with φ₁ having the meaning of “one” and φ₂ having the meaning of “zero.”

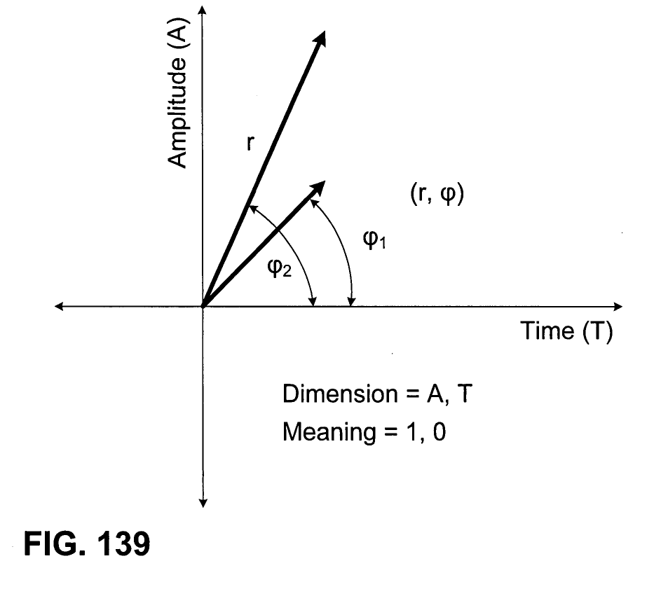

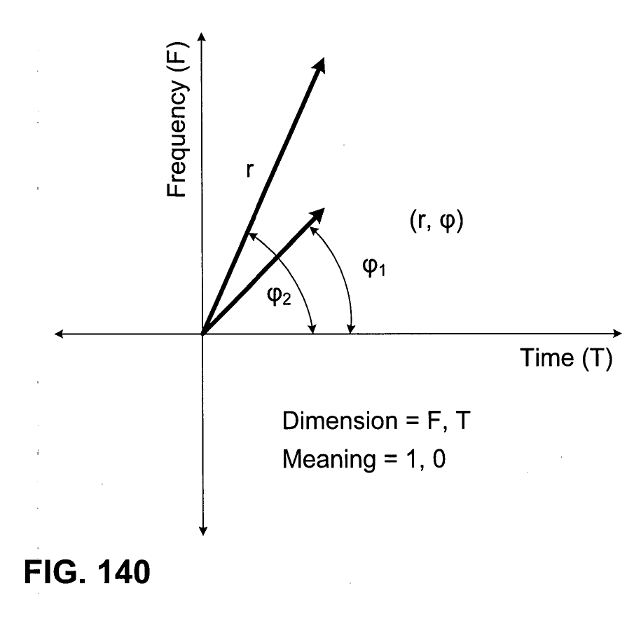

FIGS. 139 and 140 exhibit three dimensional chirp waveforms, which are mapped in spherical polar coordinates. FIG. 139 shows a waveform having a meaning of “one,” and FIG. 140 shows a waveform having a meaning of “zero.”

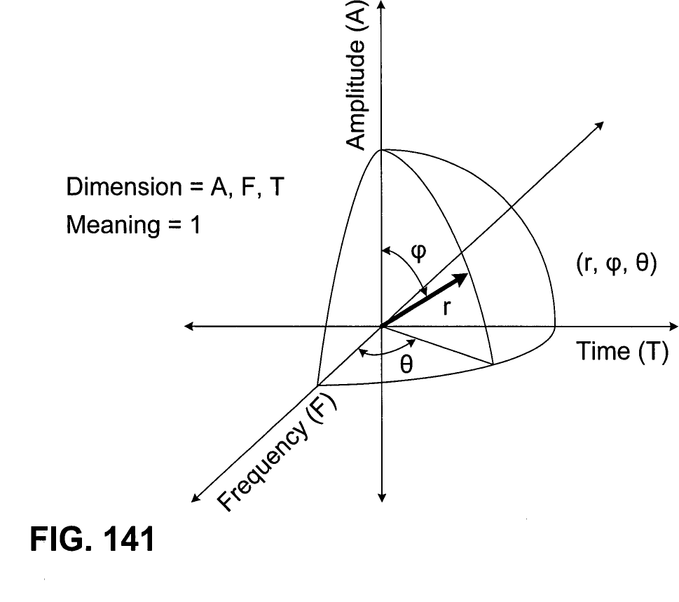

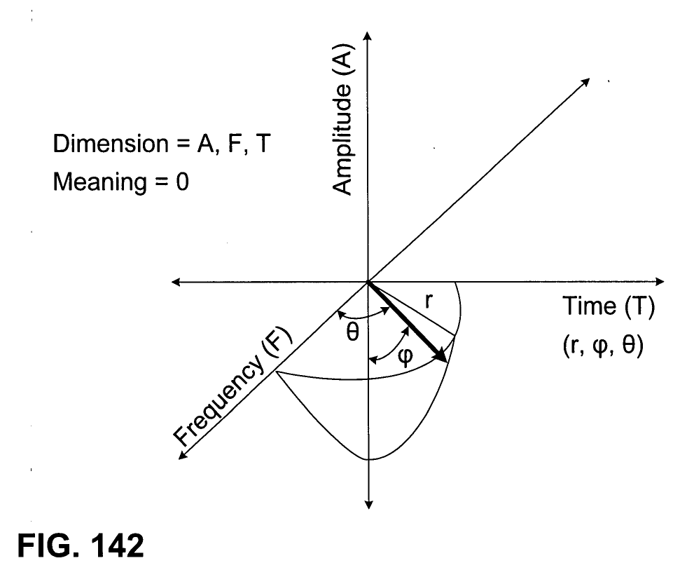

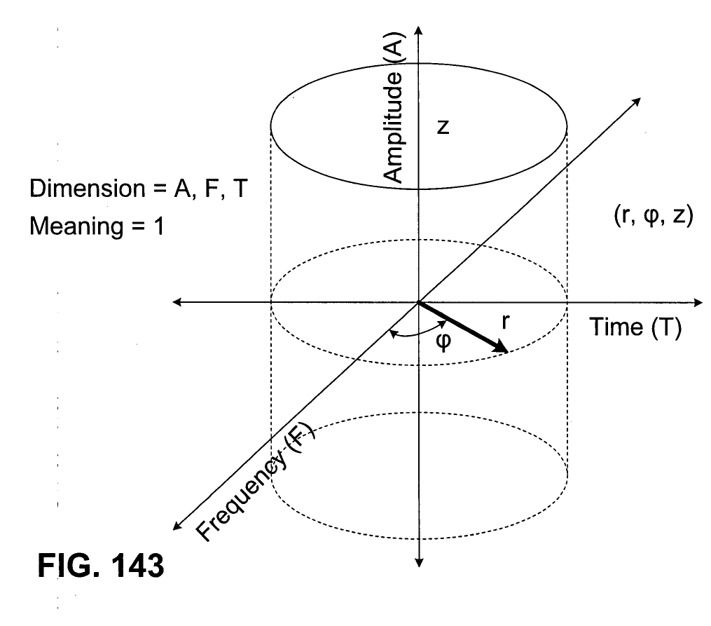

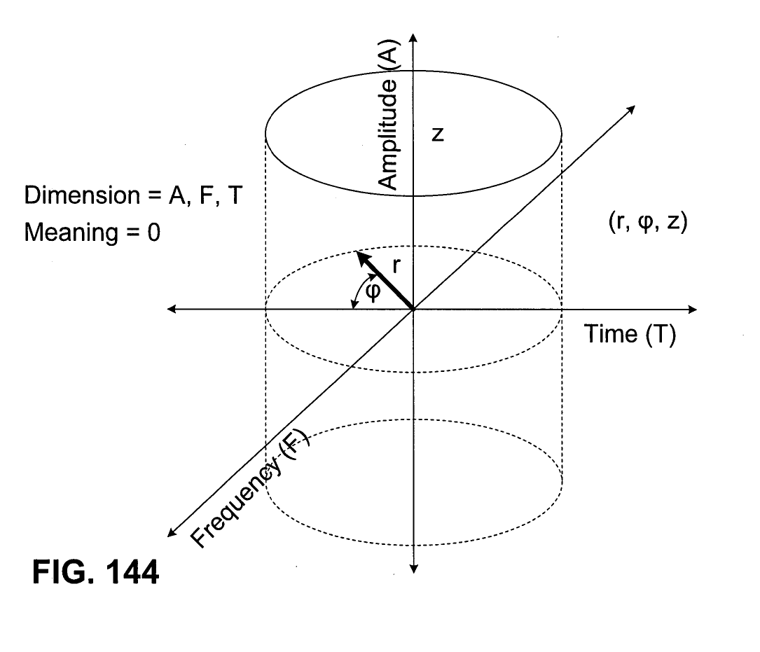

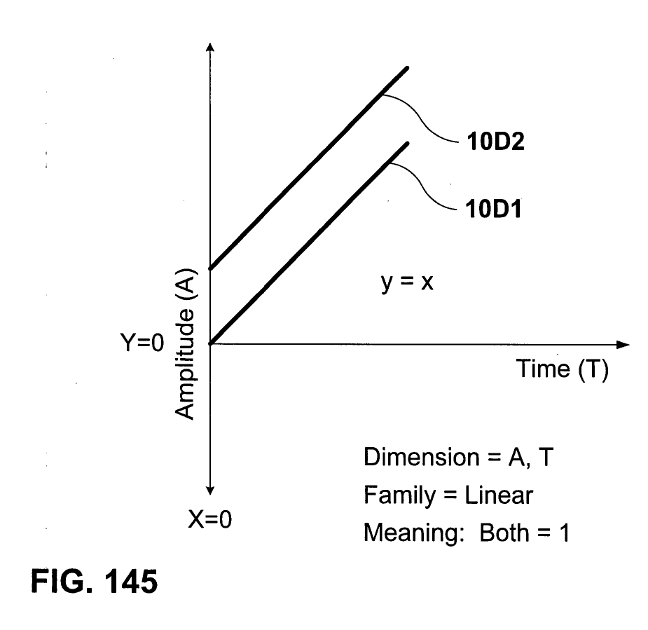

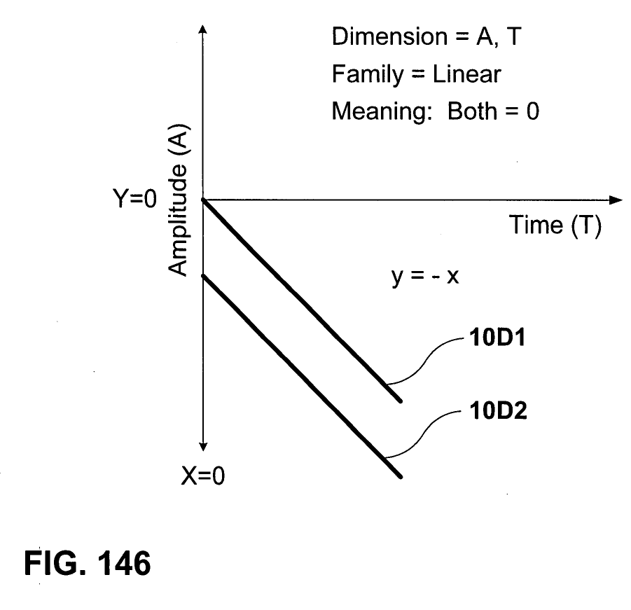

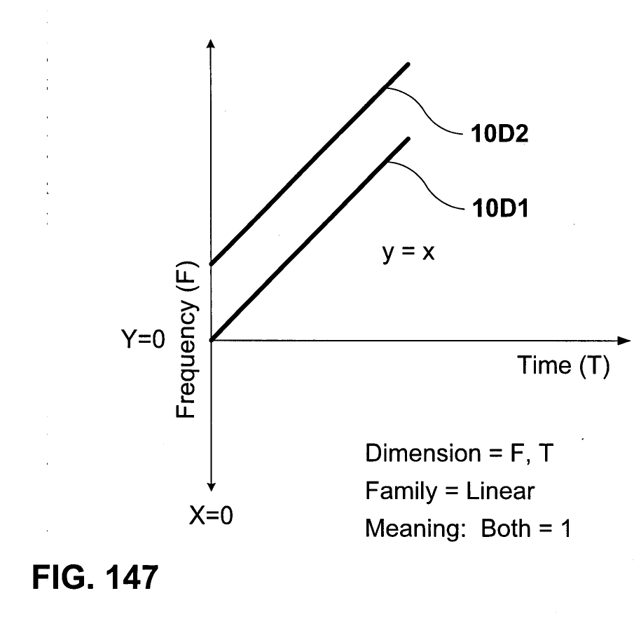

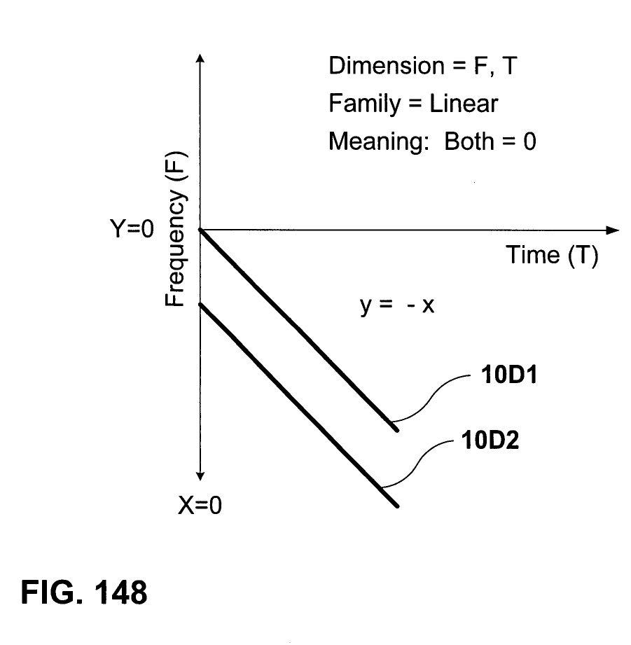

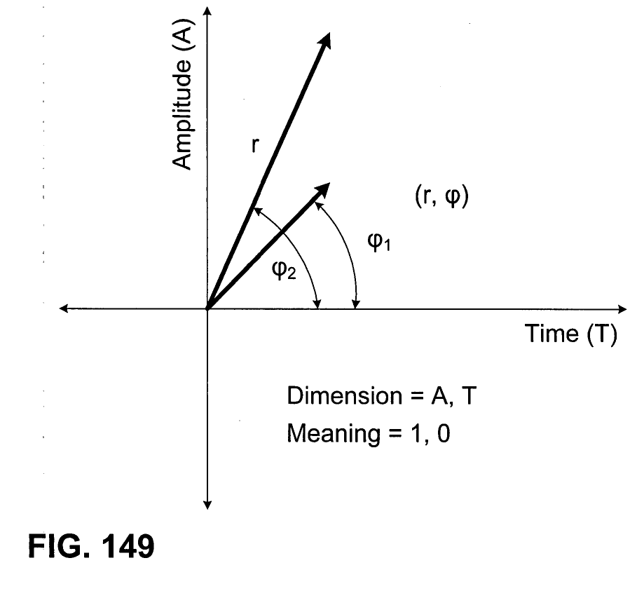

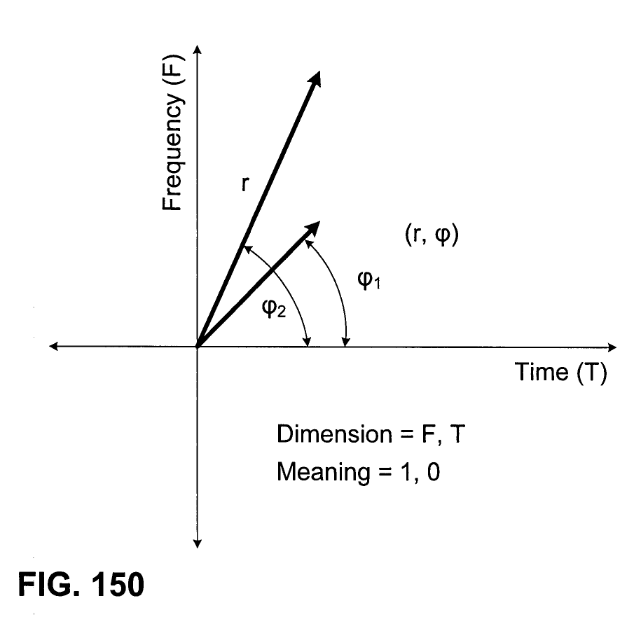

FIGS. 141 and 142 exhibit three dimensional chirp waveforms, which are mapped in cylindrical polar coordinates. FIG. 141 shows a waveform having a meaning of “one,” and FIG. 142 shows a waveform having a meaning of “zero.”

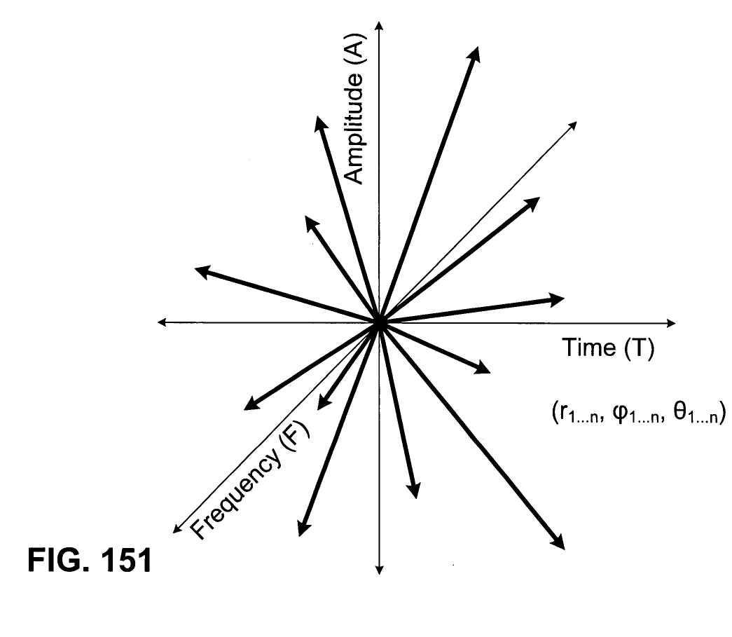

FIG. 151 exhibits multiple three dimensional chirp waveforms that are propagated over generally the same time interval, which are mapped in spherical polar coordinate space. The invention may utilize a wide variety of three or higher dimensional chirp waveforms.

### Conclusion

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives that have been disclosed above are intended to educate the reader about preferred embodiments of the invention, and are not intended to constrain the limits of the invention or the scope of Claims.

### LIST OF REFERENCE CHARACTERS

A Transmit or receive antenna
B Battery
C Carrier wave
D Music tones
DASH Dash in Morse Code
DOT Dot in Morse Code
E Amplifier
F Frequency
G Gap
H Car
I Singer
J Oscilloscope
K Telegraph key
L Demodulator
LO Local Oscillator
M Microphone
N Frequency modulated wave
O Operator
P Power supply
Q Amplitude modulated wave
R Modulator
S Static
T Period
U Modulation wave
UU Modulation envelope
V Quarter
W Wires
X Sound signal source
Y Prism
Z Speaker
AA Phase detector
AB Product detector
AC Terminal
AD Communications channel
AE Frequency band
AF Frequency offset
AG Base station
AH Coverage area
10 Chirp waveform
10 A Alternate waveform
10M1 Multiple line segment waveform
10M2 Multiple line segment waveform
10S1 Stacked line segment waveform
10S2 Stacked line segment waveform
12 Boundary
12S Start point
12E End point

What is claimed is:

1. A method comprising the steps of:
generating a waveform (10);
said waveform (10) having
a start point ((12S);
an end point (12E);
a maximum amplitude (yₘₐₓ);
a time duration (12E-12S); and
a slope (12E/12S);
said start point (12S) and said end point (12E) being connected by a generally continuous line segment;
transmitting said waveform (10);
receiving said waveform (10); and
detecting a meaning represented by said waveform (10);
said meaning being evaluated as a digital “one” if the amplitude of said waveform (10) at said end point (12E) is greater than the amplitude of said waveform (10) at said start point (12S).

2. A method as recited in claim 1, in which said waveform (10) is mapped in two dimensions.

3. A method as recited in claim 1, in which said waveform (10) is mapped in more than two dimensions.

4. A method as recited in claim 1, in which said two dimensions include amplitude and time.

5. A method as recited in claim 1, in which a vertical axis is used to measure amplitude.

6. A method as recited in claim 1, in which a horizontal axis is used to measure time.

7. A method as recited in claim 1, in which said start point (12S) of said waveform (10) is located at an origin of a pair of axes.

8. A method as recited in claim 1, in which said start point (12S) of said waveform (10) is located at a point which is not at origin of a pair of axes.

9. A method as recited in claim 1, in which said maximum value of said end point (12E) equals the quantity Aₘₐₓ.

10. A method as recited in claim 1, in which said segment is defined by a function; said function is linear.

11. A method as recited in claim 1, in which said segment is defined by a function; said function includes a mononomial expression.

12. A method as recited in claim 1, in which said segment is defined by a function; said function includes a polynomial expression.

13. A method as recited in claim 1, in which said segment is defined by a function; said function includes an exponential expression.

14. A method comprising the steps of:
generating a waveform (10);
said waveform (10) having
a start point ((12S);
an end point (12E);
a maximum amplitude;
a time duration (12E-12S); and
a slope (12E/12S);
said start point (12S) and said end point (12E) being connected by a generally continuous line segment;
transmitting said waveform (10);
receiving said waveform (10); and
detecting a meaning represented by said waveform (10);
said meaning being evaluated as a digital “zero” if the amplitude of said waveform (10) at said end point (12E) is less than the amplitude of said waveform (10) at said start point (12S).

15. A method as recited in claim 14, in which said waveform (10) is mapped in two dimensions.

16. A method as recited in claim 14, in which said waveform (10) is mapped in more than two dimensions.

17. A method as recited in claim 14, in which said two dimensions include amplitude and time.

18. A method as recited in claim 14, in which a vertical axis is used to measure amplitude.

19. A method as recited in claim 14, in which a horizontal axis is used to measure time.

20. A method as recited in claim 14, in which said start point (12S) of said waveform (10) is located at an origin of a pair of axes.

21. A method as recited in claim 14, in which said start point (12S) of said waveform (10) is located at a point which is not at origin of a pair of axes.

22. A method as recited in claim 14, in which said maximum value of said end point (12E) equals the quantity Aₘₐₓ.

23. A method as recited in claim 14, in which said segment is defined by a function; said function is linear.

24. A method as recited in claim 14, in which said segment is defined by a function; said function includes a mononomial expression.

25. A method as recited in claim 14, in which said segment is defined by a function; said function includes a polynomial expression.

26. A method as recited in claim 14, in which said segment is defined by a function; said function includes an exponential expression.

27. A method comprising the steps of:
generating a waveform (10);
said waveform (10) having
a start point (12S);
an end point (12E);
a maximum amplitude;
a time duration (12E-12S); and
a slope (12E/12S);
said start point (12S) and said end point (12E) being connected by a generally continuous line segment;
transmitting said waveform (10);
receiving said waveform (10); and
detecting a meaning represented by said waveform (10);
said meaning being evaluated as a digital “one” if the slope (12E/12S) at any point on said waveform (10) is positive.

28. A method as recited in claim 27, in which said waveform (10) is mapped in two dimensions.

29. A method as recited in claim 27, in which said waveform (10) is mapped in more than two dimensions.

30. A method as recited in claim 27, in which said two dimensions include amplitude and time.

31. A method as recited in claim 27, in which a vertical axis is used to measure amplitude.

32. A method as recited in claim 27, in which a horizontal axis is used to measure time.

33. A method as recited in claim 27, in which said start point (12S) of said waveform (10) is located at an origin of a pair of axes.

34. A method as recited in claim 27, in which said start point (12S) of said waveform (10) is located at a point which is not at origin of a pair of axes.

35. A method as recited in claim 27, in which said maximum value of said end point (12E) equals the quantity Aₘₐₓ.

36. A method as recited in claim 27, in which said segment is defined by a function; said function is linear.

37. A method as recited in claim 27, in which said segment is defined by a function; said function includes a mononomial expression.

38. A method as recited in claim 27, in which said segment is defined by a function; said function includes a polynomial expression.

39. A method as recited in claim 27, in which said segment is defined by a function; said function includes an exponential expression.

40. A method comprising the steps of:
generating a waveform (10);
said waveform (10) having
a start point ((12S);
an end point (12E);
a maximum amplitude;
a time duration (12E-12S); and
a slope (12E/12S);
said start point (12S) and said end point (12E) being connected by a generally continuous line segment;
transmitting said waveform (10);
receiving said waveform (10); and
detecting a meaning represented by said waveform (10);
said meaning being evaluated as a digital “zero” if the slope (12E/12S) at any point on said waveform (10) is negative.

41. A method as recited in claim 40, in which said waveform (10) is mapped in two dimensions.

42. A method as recited in claim 40, in which said waveform (10) is mapped in more than two dimensions.

43. A method as recited in claim 40, in which said two dimensions include amplitude and time.

44. A method as recited in claim 40, in which a vertical axis is used to measure amplitude.

45. A method as recited in claim 40, in which a horizontal axis is used to measure time.

46. A method as recited in claim 40, in which said start point (12S) of said waveform (10) is located at an origin of a pair of axes.

47. A method as recited in claim 40, in which said start point (12S) of said waveform (10) is located at a point which is not at origin of a pair of axes.

48. A method as recited in claim 40, in which said maximum value of said end point (12E) equals the quantity Aₘₐₓ.

49. A method as recited in claim 40, in which said segment is defined by a function; said function is linear.

50. A method as recited in claim 40, in which said segment is defined by a function; said function includes a mononomial expression.

51. A method as recited in claim 40, in which said segment is defined by a function; said function includes a polynomial expression.

52. A method as recited in claim 40, in which said segment is defined by a function; said function includes an exponential expression.

53. A method comprising the steps of:
generating a three dimensional waveform (10);
said three dimensional waveform (10) having a first and a second start point (12S);
a first and a second end point (12E);
a first and a second maximum amplitude;
a first and a second time duration (12E-12S); and
a first and a second slope (12E/12S);
said first start point (12S) and said end point (12E) being connected by a generally continuous line segment;
said second start point (12S) and said end point (12E) being connected by a generally continuous line segment;
transmitting said waveform (10);
receiving said waveform (10); and
detecting a meaning represented by said waveform (10);
said meaning being evaluated as a digital “one” if both of said first and said second slope (12E/12S)s at any point on said waveform (10) are both positive.

54. A method comprising the steps of:
generating a three dimensional waveform (10);
said three dimensional waveform (10) having
a first and a second start point (12S);
a first and a second end point (12E);
a first and a second maximum amplitude;
a first and a second time duration (12E-12S); and
a first and a second slope (12E/12S);
said first start point (12S) and said end point (12E) being connected by a generally continuous line segment;
said second start point (12S) and said end point (12E) being connected by a generally continuous line segment;
transmitting said waveform (10);
receiving said waveform (10); and
detecting a meaning represented by said waveform (10);
said meaning being evaluated as a digital “zero” if both of said first and said second slope (12E/12S)s at any point on said waveform (10) are both negative.
